(19) United States
(12) Patent Application Publication
(10) Pub. No.: US 2025/0353740 A1
(43) Pub. Date: Nov. 20, 2025

(54) METHODS AND PROCESSES FOR THE USE OF CALCIUM- AND MAGNESIUM-BEARING OXIDES, HYDROXIDES, AND SILICATES; CALCIUM- AND MAGNESIUM-BEARING AQUEOUS STREAMS TO CAPTURE, CONVERT, AND STORE CARBON DIOXIDE AND PRODUCE HYDROGEN

(71) Applicant: Cornell University, Ithaca, NY (US)

(72) Inventor: Greeshma GADIKOTA, Ithaca, NY (US)

(73) Assignee: Cornell University, Ithaca, NY (US)

(21) Appl. No.: 19/259,318

(22) Filed: Jul. 3, 2025

Related U.S. Application Data
(63) Continuation of application No. 17/758,257, filed on Jun. 30, 2022.
(60) Provisional application No. 62/956,853, filed on Jan. 3, 2020.

(51) Int. Cl. C01B 3/20; B01J 21/04; B01J 23/755; B01J 31/20; C01B 3/06; C01F 5/24; C01F 11/18

(52) U.S. Cl. CPC C01B 3/20; B01J 21/04; B01J 23/755; B01J 31/20; C01B 3/068; C01F 5/24; C01F 11/183; B01J 2231/76; B01J 2531/821; B01J 2531/842

(57) ABSTRACT

The present disclosure relates to methods for producing hydrogen and calcium- or magnesium-bearing carbonates by capturing, converting, and storing carbon dioxide. The methods may include providing one or more calcium- or magnesium-bearing compounds; providing one or more water-soluble oxygenates; providing a plurality of catalysts; and reacting one or more calcium- or magnesium-bearing compounds and one or more water-soluble oxygenates with plurality of catalysts under conditions to produce hydrogen and calcium- or magnesium-bearing carbonates. The methods may include providing one or more calcium- or magnesium-bearing silicates; providing carbon monoxide; providing water vapor; and reacting one or more calcium- or magnesium-bearing silicates, carbon monoxide, and water vapor. The methods may include providing one or more calcium- or magnesium-bearing compounds; providing one or more water-soluble oxygenates; providing a catalyst; and reacting one or more calcium- or magnesium-bearing compounds and one or more water-soluble oxygenates with said catalyst.

### CROSS REFERENCE TO RELATED APPLICATIONS

This application is a continuation application of U.S. application Ser. No. 17/758,257, filed Jun. 30, 2022, which is a national stage filing under section 371 of International Application No. PCT/US2021/012039, filed on Jan. 4, 2021, and published as WO 2021/0138653 on Jul. 8, 2021, which claims the benefit of U.S. Provisional Patent Application Ser. No. 62/956,853, filed Jan. 3, 2020. The entire contents of each of the prior applications are hereby incorporated herein by reference.

### FEDERALLY SPONSORED RESEARCH

This invention was made with government support under DE-SC0020263 awarded by the Department of Energy. The government has certain rights in the invention.

### FIELD

The present disclosure relates to methods and processes for producing hydrogen and calcium- or magnesium-bearing carbonates by capturing, converting, and storing carbon dioxide.

### BACKGROUND

Advancements in adaptive chemical pathways for H₂ production from carbonaceous sources—The water gas shift reaction (interchangeably referred to herein as “WGSR” and “WGS reaction”) is a highly versatile pathway for converting carbonaceous fuels that range from coal and natural gas to biomass and non-recyclable plastics. Smith et al., “A Review of the Water Gas Shift Reaction Kinetics,” International Journal of Chemical Reactactor Engineering 8:1 (2010); Rhodes et al., “Water-Gas Shift Reaction: Finding the Mechanistic Boundary,” Catalysis Today 23:43-58 (1995); and Pal et al., “Performance of Water Gas Shift Reaction Catalysts: A Review,” Renewable and Sustainable Energy Reviews 93:549-565 (2018). These feedstocks are gasified in a controlled oxygen or steam environment to produce CO, H₂, and CO₂. In the conventional WGSR, CO is reformed in steam over a solid metal catalyst to produce CO₂ and H₂: CO+H₂O═CO₂+H₂ (ΔH=−41.2 kJ/mol). Rhodes et al., “Water-Gas Shift Reaction: Finding the Mechanistic Boundary,” Catalysis Today 23:43-58 (1995). To overcome the challenges of slow kinetics but high conversions at low temperatures due to the exothermicity of these reactions, two catalytic systems are operated between 310-450° C. and 200-250° C. to achieve high conversion. Rhodes et al., “Water-Gas Shift Reaction: Finding the Mechanistic Boundary,” Catalysis Today 23:43-58 (1995) and Levalley et al., “The Progress in Water Gas Shift and Steam Reforming Hydrogen Production Technologies—A Review,” International Journal of Hydrogen Energy 39: 16983-17000 (2014). The pressures correspond to 10-20 atm. Bukur et al., “Role of Water-Gas-Shift Reaction in Fischer-Tropsch Synthesis on Iron Catalysts: A Review,” Catalysis Today 275:66-75 (2016). As an alternative to the gas-solid reaction, a single aqueous alkaline catalytic environment was proposed to aid the conversion of CO and steam to CO₂ and H₂. Elliott et al., “Aqueous Catalyst Systems for the Water-Gas Shift Reaction. 2. Mechanism of Basic Catalysis,” Industrial & Engineering Chemistry Product Research and Development 22:431-435 (1983) and Elliott et al., “Aqueous Catalyst Systems for the Water-Gas Shift Reaction. 1. Comparative Catalyst Studies,” Industrial & Engineering Chemistry Product Research and Development 22:426-431 (1983). The high pressure, excess water environments drive the WGSR to completion. An aqueous looping system where (i) carbonate ion reacts to form hydroxide ions and carbon dioxide, (ii) hydroxide ions react with CO to produce formate, (iii) formate decomposes to carbonate and formaldehyde, with (iv) formaldehyde decomposes to yield H₂ was extensively studied. The rate limiting step is the decomposition of formate. Elliott et al., “Aqueous Catalyst Systems for the Water-Gas Shift Reaction. 2. Mechanism of Basic Catalysis,” Industrial & Engineering Chemistry Product Research and Development 22:431-435 (1983). The decomposition of potassium formate in water to produce H₂ using catalysts such as 5-10% palladium (Pd) on activated carbon was proposed. Onsager et al., “Hydrogen Production From Water and CO via Alkali Metal Formate Salts,” International Journal of Hydrogen Energy 21:883-885 (1996). While the proposed aqueous routes involved the looping of carbonate ions in the aqueous phase, these efforts were not directed towards driving the equilibrium forward through the reactive separation of CO₂ to produce carbonates.

To limit the number of stages in the conventional gas-solid WGSR and facilitate the removal of CO₂, sorption-enhanced water gas shift (“SEWGS”) was proposed. In SEWGS, an alkaline sorbent is used to capture CO₂. Stevens et al., “Sorption-Enhanced Water Gas Shift Reaction by Sodium-promoted Calcium Oxides,” Fuel 89:1280-1286 (2010); Beaver et al., “Selection of CO₂ Chemisorbent for Fuel-Cell Grade H₂ Production by Sorption-Enhanced Water Gas Shift Reaction,” Internatial Journal of Hydrogen Energy 34:2972-2978 (2009); Xiu et al., “Sorption-Enhanced Reaction Process With Reactive Regeneration,” Chemical Engineering Science 57:3893-3908 (2002); Wei et al., “Hydrogen Production in Steam Gasification of Biomass with CaO as a CO₂ Absorbent,” Energy and Fuels 22:1997-2004 (2008); Dasgupta et al., “Robust, High Reactivity and Enhanced Capacity Carbon Dioxide Removal Agents for Hydrogen Production Applications,” International Journal of Hydrogen Energy 33:303-311 (2008); Ding et al., “Adsorption-Enhanced Steam-Methane Reforming,” Chemical Engineering Science 55:3929-3940 (2000); Guoxin et al., “Hydrogen Rich Fuel Gas Production by Gasification of Wet Biomass Using a CO₂ Sorbent,” Biomass and Bioenergy 33:899-906 (2009); Han et al., “Simultaneous Shift Reaction and Carbon Dioxide Separation for the Direct Production of Hydrogen,” Chemical Engineering Science 49: 5875-5883 (1994); Harrison, D., “Sorption-Enhanced Hydrogen Production: A Review,” Industrail Engineering Chemistry Research 47:6486-6501 (2008); Lee et al., “Reversible Chemisorbents for Carbon Dioxide and Their Potential Applications,” Industrail Engineering Chemistry Research 47:8048-8062 (2008); Lopez et al., “Hydrogen Production Using Sorption-Enhanced Reaction,” Industrail Engineering Chemistry Research 40:5102-5109 (2002); and Van Selow et al., “Carbon Capture by Sorption-Enhanced Water-Gas Shift Reaction Process Using Hydrotalcite-Based Material,” Industrail Engineering Chemistry Research 48: 4184-4193 (2009). Steam-activated CaO sorbents which yielded Ca(OH)₂ were found to be highly effective in capturing CO₂ and producing high purity CaCO₃ in the temperature range of 300° C.-600° C. Stevens et al., “Sorption-Enhanced Water Gas Shift Reaction by Sodium-promoted Calcium Oxides,” Fuel 89:1280-1286 (2010). Similarly, the use of Mg(OH)₂ was proposed as a sorbent. Fricker et al., “Effect of H₂O on Mg(OH)₂ Carbonation Pathways for Combined CO₂ Capture and Storage,” Chemical Engineering Science 100:332-341 (2013). However, the kinetics of direct gas-solid route of reacting CO₂ with Mg(OH)₂ to produce MgCO₃ were mass transfer limited. Fricker et al, “Effect of H₂O on Mg(OH)₂ Carbonation Pathways for Combined CO₂ Capture and Storage,” Chemical Engineering Science 100:332-341 (2013). In response to these challenges, slurry carbonation of Mg(OH)₂ was proposed. Gadikota et al., “Enhanced Water-Gas-Shift Reaction and In-Situ Carbon Fixation in the Presence of Mg(OH)₂ Slurry in a High Pressure Aqueous System,” In The 12th International Conference on Gas-Liquid and Gas-Liquid-Solid Reactor Engineering GLS 12 (2015). Despite the promising potential of the slurry carbonation route, several fundamental questions regarding the rate-limiting steps using the slurry reaction approach remain. The source of hydroxide or oxide is another consideration. For example, Ca-oxides and hydroxides are conventionally derived from a carbonate source. However, in the interest of closing the carbon cycle, it is atomistically efficient to use alkaline earth metal silicates as the precursors. Further, accelerated carbon mineralization of Ca- and Mg-bearing silicate minerals at temperatures in the range of 150° C.-250° C. suggests that these reactions can be successfully coupled with low temperature WGSR. Gerdemann et al., “Ex Situ Aqueous Mineral Carbonation,” Environmental Science and Technology 41:2587-2593 (2007); Gadikota et al., “Chemical and Morphological Changes During Olivine Carbonation for CO₂ Storage in the Presence of NaCl and NaHCO₃,” Physical Chemistry Chemical Physics 16:4679-4693 (2014); Chizmeshya et al., “A Novel Approach to Mineral Carbonation: Enhancing Carbonation While Avoiding Mineral Pretreatment Process Cost: Final Report 924162,” Department of Education (2007); and Munz et al., “A Continuous Process for Manufacture of Magnesite and Silica From Olivine, CO₂ and H₂O,” Energy Procedia 1:4891-4898 (2009).

Geo-mimicry of carbon mineralization for CO₂ storage—Carbon mineralization is one of the permanent and thermodynamically downhill routes for converting and storing CO₂ as Ca- or Mg-carbonates. The weathering of magnesium silicate rocks in Oman to produce magnesium carbonates is a representative example. Kelemen et al., “Rates and Mechanisms of Mineral Carbonation in Peridotite: Natural Processes and Recipes for Enhanced, In Situ CO₂ Capture and Storage,” Annual Review Earth and Planetary Science 39:545-576 (2011); Matter et al., “Permanent Storage of Carbon Dioxide in Geological Reservoirs by Mineral Carbonation,” Nature Geoscience 2:837-841 (2009); and Kelemen et al., “In Situ Carbonation of Peridotite for CO₂ Storage,” Proceedings of the National Academy of Sciences of the United States of America 105:17295-17300 (2008). Several efforts were directed towards mimicking and potentially accelerating these reaction pathways. Gerdemann et al., “Ex Situ Aqueous Mineral Carbonation,” Environmental Science and Technology 41:2587-2593 (2007); Gadikota et al., “Chemical and Morphological Changes During Olivine Carbonation for CO₂ Storage in the Presence of NaCl and NaHCO₃,” Physical Chemistry Chemical Physics 16:4679-4693 (2014); Béarat et al., “Carbon Sequestration via Aqueous Olivine Mineral Carbonation: Role of Passivating Layer Formation,” Environmental Science and Technology 40:4802-4808 (2006); O'Connor et al., “Final report: Aqueous Mineral Carbonation,” Department of Education/ARC-TR-04-002 (2004); and Gadikota et al., “Experimental Design and Data Analysis for Accurate Estimation of Reaction Kinetics and Conversion for Carbon Mineralization,” Industrial Engineering Chemistry Research 53:6664-6676 (2014). These studies suggested that the time-scales of the natural conversion of Mg-silicate to Mg-carbonate, which are to order of several years can be accelerated to the order of a few hours (FIG. 2). In these experiments, the particle sizes suspended in the aqueous fluids is in the range of 5 μm-100 μm. As shown in FIG. 2, more than 60% of forsterite is converted to magnesite at time scales as low as 3 hours, reaction temperatures in the range of 150-200° C., aqueous fluids composed of NaHCO₃ with concentrations greater than 0.5 M, and CO₂ partial pressures in the range of 89 atm-164 atm. Gadikota et al., “Chemical and Morphological Changes During Olivine Carbonation for CO₂ Storage in the Presence of NaCl and NaHCO₃,” Physical Chemistry Chemical Physics 16:4679-4693 (2014). FIG. 2 shows the effect of reaction temperature on the extent of Mg₂SiO₄ converted to MgCO₃ (magnesite). In comparison, complete conversion of wollastonite (CaSiO₃) to calcium carbonate (CaCO₃) was achieved at 100° C., pCO₂=40 atm in a 15 wt % slurry of particles in three hours. Gerdemann et al., “Ex Situ Aqueous Mineral Carbonation,” Environmental Science and Technology 41:2587-2593 (2007).

Feasibility of achieving directed synthesis of H₂ and Ca- or Mg-carbonates—Several factors aid the directed synthesis of H₂ and Ca- and Mg-carbonates starting from Ca- and Mg-silicates as the precursors. The first factor is the enhanced carbon mineralization of forsterite (as shown in FIG. 2 (Gerdemann et al., “Ex Situ Aqueous Mineral Carbonation,” Environmental Science and Technology 41:2587-2593 (2007); Gadikota et al., “Chemical and Morphological Changes During Olivine Carbonation for CO₂ Storage in the Presence of NaCl and NaHCO₃,” Physical Chemistry Chemical Physics 16:4679-4693 (2014); and O'Connor et al., “Final report: Aqueous Mineral Carbonation,” Department of Education/ARC-TR-04-002 (2004))) and wollastonite as noted by Gerdemann and co-workers (Gerdemann et al., “Ex Situ Aqueous Mineral Carbonation,” Environmental Science and Technology 41:2587-2593 (2007)) at temperatures above 90° C. This enhancement arises from the higher kinetics of mineral dissolution (Hanchen et al., “Dissolution Kinetics of Fosteritic Olivine at 90-150° C. Including Effects of the Presence of CO2,” Geochimica et Cosmochimica Acta 70:4403-4416 (2006) and Oelkers et al., “Olivine Dissolution Rates: A Critical Review,” Chemical Geology 500:1-19 (2018)) and reduced solubility of Ca- and Mg-carbonates (Bénézeth et al., “Experimental Determination of the Solubility Product of Magnesite at 50 to 200° C.,” Chemical Geology 286:21-31 (2011) and Weyl, P. K. “The Change in Solubility of Calcium Carbonate With Temperature and Carbon Dioxide Content,” Geochimica et Cosmochimica Acta 17:214-225 (1959)) with temperature. These accelerated carbon mineralization studies suggest that the relatively high conversions of Ca- and Mg-silicates to their respective carbonates can occur at conditions that correspond to low temperature WGSR. The thermal stability of magnesite and calcite at these conditions is another consideration. Magnesite and calcite are generally thermally stable at temperatures up to 350° C. (Gadikota et al., “Chemical and Morphological Changes During Olivine Carbonation for CO₂ Storage in the Presence of NaCl and NaHCO₃,” Physical Chemistry Chemical Physics 16:4679-4693 (2014)) and 600° C. (Rodriguez-Navarro et al., “Thermal Decomposition of Calcite: Mechanisms of Formation and Textural Evolution of CaO Nanocrystals,” American Mineralogist 94:578-593 (2009)), well above the temperature range of 200° C.-250° C. for the low temperature WGSR.

Another approach to evaluate if a given set of reaction pathways are thermodynamically favored is if the overall enthalpy of the coupled pathways is negative. Combining the WGSR with the conversion of magnesium silicate (Mg₂SiO₄) to magnesite (MgCO₃) or calcium silicate (CaSiO₃) to calcite (CaCO₃) yield an overall negative enthalpy (as shown in the adjacent reactions). However, when gas-liquid-solid reactions are coupled, the ability to predict potential changes in the yields in a given temperature range is limited by significant uncertainties in speciation in multiphase environments. These limitations call for the need to utilize multi-modal characterization approaches to elucidate the reaction mechanisms during the directed synthesis of H₂ and Ca- and Mg-carbonates.

TABLE 1
Reaction pathways

2CO + 2H₂O = 2CO₂ + 2H₂ (ΔH = −82.4 kJ/mol) (1)
Mg₂SiO₄ + 2H₂O = 2Mg(OH)₂ + SiO₂ (ΔH = −99.7 kJ/mol) (2)
2Mg(OH)₂ = 2MgO + 2H₂O (ΔH = 162.4 kJ/mol) (3)
2MgO + 2CO₂ = 2MgCO₃ (ΔH = −235.6 kJ/mol) (4)
Mg₂SiO₄ + 2CO + 2H₂O = 2MgCO₃ + SiO₂ + 2H₂ (ΔH = −255.3
kJ/mol) (5)
CO + H₂O = CO₂ + H₂ (ΔH = −41.2 kJ/mol) (1)
CaSiO₃ + H₂O = Ca(OH)₂ + SiO₂ (ΔH = −24.3 kJ/mol) (2)
Ca(OH)₂ = CaO + H₂O (ΔH = 108.4 kJ/mol) (3)
CaO + CO₂ = CaCO₃ (ΔH = −178.4 kJ/mol) (4)
CaSiO₃ + CO + H₂O = CaCO₃ + SiO₂ + H₂ (ΔH = −135.5 kJ/mol) (5)

Advancements in in-operando multi-modal measurement techniques—One of the challenges in developing structure-reactivity relationships in multiphase environments is the uncertainty in reaction mechanisms arising from coupling several reactions. Ab-initio predictions are challenged by the relevance of force fields in these extreme environments. Geochemical modeling approaches such as PhreeqC (Parkhurst, David L. and Appelo, C. A. J. “User's guide to PHREEQC (Version 2),” Water Resources Investigations Report 99-4259; (1999)) and Geochemists WorkBench (Bethke, C. and Yeakel, S. “Geochemist's Workbench: Release 8.0 Reaction Modeling Guide” RockWare Incorporated (2009)) have been conventionally used to predict speciation at thermodynamic equilibrium. However, transient kinetic events and the influence of mass transfer limitations in far-from-equilibrium environments on multi-phase chemical transformations are challenging to predict. These challenges can now be resolved by harnessing in-operando characterization approaches. Recent advancements in non-invasive cross-scale synchrotron characterization techniques now allow for the establishment of the chemical and morphological basis for observed reactivities in multiphase environments. Specific examples include Ultra Small Angle/Small Angle/Wide Angle X-Ray Scattering (“USAXS/SAXS/WAXS”) measurements which allow for relating the changes in the nano- and meso-scale morphological features (“USAXS/SAXS”) to the structural changes in materials (“WAXS”) from the Angstrom to micrometer scales within a span of 3-5 minutes (FIG. 3). Ilavsky et al., “Development of Combined Microstructure and Structure Characterization Facility for In Situ and Operando Studies at the Advanced Photon Source,” Journal of Applied Crystallography 51:867-882 (2018); Ilavsky et al., “Irena: Tool Suite for Modeling and Analysis of Small-Angle Scattering,” Journal of Applied Crystallography 42:347-353 (2009); Ilavsky, Jan “Nika: Software for Two-Dimensional Data Reduction,” Journal of Applied Crystallography 45:324-328 (2012); Gadikota et al., “In Situ Angstrom-to-Micrometer Characterization of the Structural and Microstructural Changes in Kaolinite on Heating Using Ultrasmall-Angle, Small-Angle, and Wide-Angle X-ray Scattering (USAXS/SAXS/WAXS),” Industrial Engineering Chemistry Research 56 (2017); Liu, M. and Gadikota, G., “Probing the Influence of Thermally Induced Structural Changes on the Microstructural Evolution in Shale using Multiscale X-ray Scattering Measurements,” Energy and Fuels 32:8193-8201 (2018); Gadikota et al., “Towards Understanding the Microstructural and Structural Changes in Natural Hierarchical Materials for Energy Recovery: In-Operando Multi-Scale X-ray Scattering Characterization of Na- and Ca-montmorillonite on Heating to 1150° C.,” Fuel 196:195-209 (2017); and Gadikota, G., “Connecting the Morphological and Crystal Structural Changes During the Conversion of Lithium Hydroxide Monohydrate to Lithium Carbonate Using Multi-Scale X-ray Scattering Measurements,” Minerals 7 (2017).

In-operando Grazing Incidence—Wide Angle and Small Angle X-Ray Scattering (“GI-WAXS/SAXS”) measurements allow for the determination of the influence of solid interfaces on the structure and morphology of precipitated carbonates. Changes in the local atomic structure during carbon mineralization can be effectively captured using Total Scattering measurements. Mass-transfer limitations arising from the precipitation of secondary phases or the extensive growth of carbonates can be captured using in-operando X-Ray Tomography measurements, complemented by USAXS/SAXS, Scanning and Transmission Electron Microscopy, BET pore size analyses, and Laser Diffraction based Particle Size Analyses. FIG. 4 is a schematic representation of a cross-scale characterization approach for determining structural and microstructural features in materials arising from reaction-driven fluid-solid interactions. Changes in the concentrations in the gas phase are determined using micro-gas chromatography measurements. Metal compositions in the aqueous phase are determined from Inductively Coupled Plasma—Atomic Emission Spectroscopy (“ICP-AES”). Nuclear Magnetic Resonance (“NMR”) and Ion Chromatography (“IC”) measurements provide detailed insights into the organic species in the aqueous phase. This multi-modal characterization approach allows for deconstruction of the mechanisms that potentially limit reactivity and reconstruct accelerated reaction pathways for the directed synthesis of H₂ and Ca- and Mg-carbonates.

Establishing a scientific basis for tuning the reaction conditions to achieve targeted yields has been limited by inadequate strategies for multi-modal probing of solid and fluid phases in multi-phase reaction environments. In the absence of multi-modal measurements, fluid or solid compositions are often predicted from thermodynamic modeling. However, in far from equilibrium environments, critical scientific insights into the reaction pathways remain locked in transient kinetics. Developing structure-reactivity relationships in multi-phase systems is complicated by competing reaction pathways and the formation of mass transfer limiting conditions.

Currently, global warming is becoming a most urgent problem to the society than any other periods in the history, which is mainly caused by the greenhouse gases, especially, carbon dioxide (CO₂). It is shown that CO₂ concentration has reached up to 407 ppm in 2018 compared with 280 ppm in pre-industrial periods (Snæbjörnsdóttir et al., “Carbon Dioxide Storage Through Mineral Carbonation,” Nat. Rev. Earth Environ. 1:90-102 (2020)). This huge increase in concentration is mainly attributed to the rapid industrial development and increasing human activities, which are supported by large fossil fuel combustion. Following this growth rate, by 2050, CO₂ concentration is supposed to break 500 ppm, which sounds horrible to humans. Thus, effective methods are needed to develop to solve this emergent issue.

Carbon Dioxide Capture and Storage (CCS) is considered as one such strategy that can mitigate CO₂ problem, and it has been studied a lot in the past few years (S. A. Rackley, “Overview of Carbon Capture and Storage,” Carbon Capture and Storage, pp. 19-28 (2010) and Singh et al., “Overview of Carbon Capture Technology: Microalgal Biorefinery Concept and State-of-the-Art,” Front. Mar. Sci. 6:1-9 (2019)). CCS, namely, refers to such technologies that can capture emitted CO₂ gas from some specific places and then store it elsewhere to decrease the overall CO₂ emission to the atmosphere, during which, transportation may play an important role as well (Sanna et al., “A Review of Mineral Carbonation Technologies to Sequester CO₂,” Chem. Soc. Rev. 43(23):8049-8080 (2014)). Among the available methods, mineral carbonation is considered as a promising approach to sequester CO₂ and have influence on decarbonizing the industrial projects (Snæbjörnsdóttir et al., “Carbon Dioxide Storage Through Mineral Carbonation,” Nat. Rev. Earth Environ. 1:90-102 (2020); Sanna et al., “A Review of Mineral Carbonation Technologies to Sequester CO₂,” Chem. Soc. Rev. 43(23):8049-8080 (2014); an Wang et al., “The Technology of CO₂ Sequestration by Mineral Carbonation: Current Status and Future Prospects,” Can. Metall. Q., 57(1):46-58 (2018)).

Mineral carbonation, which is also named as carbon mineralization, is defined as a kind of technique that utilizes metal oxides/silicates bearing compounds to capture CO₂ gas and transforms them into stable carbonate products (Sanna et al., “A Review of Mineral Carbonation Technologies to Sequester CO₂,” Chem. Soc. Rev. 43(23):8049-8080 (2014) and P. Ii, “10 Mineral carbonation,” (2010)). In fact, it is considered as an accelerated form of a natural occurring process of the weathering of rocks and was first proposed by Seifritz in 1990 (W. Seifritz, “CO₂ Disposal by Means of Silicates,” Nature 345(6275):486 (1990)), and then the first detailed study was performed by Lackner et al. (Lackner et al., “Carbon Dioxide Disposal in Carbonate Minerals,” Energy 20(11):1153-1170 (1995)). One of the main advantages of mineral carbonation compared with other capture methods is that this process is an exothermic downhill reaction process, indicating the formed products are thermodynamically stable and can be stored for a rather long period without further concern (Power et al., “Carbon Mineralization: From Natural Analogues to Engineered Systems,” Rev. Mineral. Geochemistry 77(1):305-360 (2013)). In addition, this carbonation process can be modified and easily controlled (Power et al., “Carbon Mineralization: From Natural Analogues to Engineered Systems,” Rev. Mineral. Geochemistry 77(1):305-360 (2013)), which makes it much simpler to further investigate. Commonly, the main components applied in mineral carbonation process are calcium/magnesium-bearing silicates due to their abundant resource in nature such as peridotites and basalts compared with other compounds (Snæbjörnsdóttir et al., “Carbon Dioxide Storage Through Mineral Carbonation,” Nat. Rev. Earth Environ. 1:90-102 (2020) and Sanna et al., “A Review of Mineral Carbonation Technologies to Sequester CO₂,” Chem. Soc. Rev. 43(23):8049-8080 (2014)). Their carbonation processes are also exothermic (Kojima et al., “Absorption and Fixation of Carbon Dioxide by Rock Weathering,” Energy Convers. Manag. 38(Suppl.):5461-S466 (1997)) and the carbonation reactions occur as the following equations (Sanna et al., “A Review of Mineral Carbonation Technologies to Sequester CO₂,” Chem. Soc. Rev. 43(23):8049-8080 (2014)):

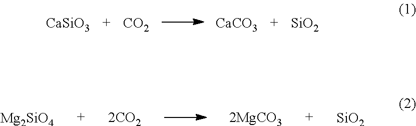

However, rather slow kinetics are observed during these natural processes at ambient temperature and pressure although they are thermodynamically favorable (R. N. Cgs-, “Scoping Study on CO₂ Mineralization Technologies,” pp. 1-88 (2011)). Consequently, current efforts have been made into improving the reaction rate in order to sequester CO₂ gas in a much larger scale.

Over the past few years, several materials have been studied in carbonation processes including metal oxides (Li et al., “Effect of Temperature on the Carbonation Reaction of CaO with CO₂,” Energy and Fuels 26(4):2473-2482 (2012); Fagerlund et al., “Kinetics Studies on Wet and Dry Gas-Solid Carbonation of MgO and Mg(OH)₂ for CO₂ Sequestration,” RSC Adv. 2(27):10380-10393 (2012); Morales-Flórez et al., “Hydration and Carbonation Reactions of Calcium Oxide by Weathering: Kinetics and Changes in the Nanostructure,” Chem. Eng. J. 265:194-200 (2015); Mess et al., “Product Layer Diffusion During the Reaction of Calcium Oxide With Carbon Dioxide,” Energy and Fuels 13(5):999-1005 (1999); and Li et al., “Effect of Steam on CaO Regeneration, Carbonation and Hydration Reactions for CO₂ Capture,” Fuel Process. Technol. 151:101-106 (2016)), hydroxide minerals (Fagerlund et al., “Kinetics Studies on Wet and Dry Gas-Solid Carbonation of MgO and Mg(OH)₂ for CO₂ Sequestration,” RSC Adv. 2(27):10380-10393 (2012); Camerini et al., “The Carbonation Kinetics of Calcium Hydroxide Nanoparticles: A Boundary Nucleation and Growth Description,” J. Colloid Interface Sci. 547:370-381 (2019); Harrison et al., “Accelerated Carbonation of Brucite in Mine Tailings for Carbon Sequestration,” Environ. Sci. Technol. 47(1):126-134 (2013); Liu et al., “Phase Evolution and Textural Changes During the Direct Conversion and Storage of CO₂ to Produce Calcium Carbonate From Calcium Hydroxide,” Geosci. 8(12) (2018); and Vance et al., “Direct Carbonation of Ca(OH)₂ Using Liquid and Supercritical CO₂: Implications for Carbon-Neutral Cementation,” Ind. Eng. Chem. Res. 54(36):8908-8918 (2015)), silicate minerals like wollastonite (Di Lorenzo et al., “The Carbonation of Wollastonite: A Model Reaction to Test Natural and Biomimetic Catalysts for Enhanced CO₂ Sequestration,” Minerals 8(5):209 (2018); Tai et al., “Factors Affecting Wollastonite Carbonation Under CO₂ Supercritical Conditions,” AIChE J. 52(1):292-299 (2006); Yan et al., “CO₂ Sequestration From Flue Gas By Direct Aqueous Mineral Carbonation of Wollastonite,” Sci. China Technol. Sci. 56(9):2219-2227 (2013); Di Lorenzo et al., “The Carbonation of Wollastonite: A Model Reaction to Test Natural and Biomimetic Catalysts for Enhanced CO₂ Sequestration,” Minerals 8(5) (2018); and Ding et al., “CO₂ Mineral Sequestration by Wollastonite Carbonation,” Phys. Chem. Miner. 41(7):489-496 (2014)) and olivine (Wang et al., “Kinetics and Mechanism of Mineral Carbonation of Olivine for CO₂ Sequestration,” Miner. Eng. 131:185-197 (2019); Gadikota et al., “Chemical and Morphological Changes During Olivine Carbonation for CO₂ Storage in the Presence of NaCl and NaHCO₃,” Phys. Chem. Chem. Phys. 16(10):4679-4693 (2014); and Li et al., “Direct Aqueous Carbonation on Olivine at a CO₂ Partial Pressure of 6.5 MPa,” Energy 173:902-910 (2019)). Among these materials, calcium-based materials like calcium hydroxide and calcium silicate are favored due to their higher reactivity than magnesium-based minerals, as illustrated in previous studies (Huijgen et al., “Mechanisms of Aqueous Wollastonite Carbonation as a Possible CO₂ Sequestration Process,” Chem. Eng. Sci. 61(13):4242-4251 (2006) and Lackner et al., “Progress on Binding CO₂ in Mineral Substrates,” Energy Convers. Manag., 38:S259-S264 (1997)). In addition, examining the effect of calcium-based materials in capturing CO₂ gas is helpful in large-scale applications due to the abundance of Ca-based materials in industrial waste like fly ash and steel slags, which stands for another important portion in sequestering CO₂. Consequently, calcium hydroxide and calcium silicate were chosen as researched materials in this example.

Generally, mineral carbonation can be separated into two categories: direct route and indirect route (Saran et al., “Climate Change: Mitigation Strategy by Various CO₂ Sequestration Methods,” Int. J. Adv. Res. Sci. Eng. 6(2):299-308 (2017)). The latter form possesses a much higher carbonation extent and faster reaction rate due to the separate reaction steps. However, it is not studied here because the external acid addition (Teir et al., “Dissolution of Steelmaking Slags in Acetic Acid for Precipitated Calcium Carbonate Production,” Energy 32(4):528-539 (2007)) is much likely to extract other heavy metal ions other than Ca, resulting in a non-pure calcium carbonate precipitation and environmental hazards (Sanna et al., “A Review of Mineral Carbonation Technologies to Sequester CO₂,” Chem. Soc. Rev. 43(23):8049-8080 (2014) and Sipilä et al., “Carbon Dioxide Sequestration by Mineral Carbonation Literature review update 2005-2007,” Rep. VT, p. 52 (2008)). This will further increase the overall cost in waste disposal or environmental cleaning. On the contrast, direct route is much simpler and easier to build and conduct. In direct route, gas-solid reaction and aqueous reaction are two sub-categories (Saran et al., “Global NEST Printed in Greece. All rights reserved,” Glob. NEST J. 20(3):497-503 (2018)). Not surprisingly, it was found that water addition in the aqueous reaction process can largely affect the reaction process (Fagerlund et al., “Kinetics Studies on Wet and Dry Gas-Solid Carbonation of MgO and Mg(OH)₂ for CO₂ Sequestration,” RSC Adv. 2(27):10380-10393 (2012) and Fricker et al., “Effect of H₂O on Mg(OH)₂ Carbonation Pathways for Combined CO₂ Capture and Storage,” Chem. Eng. Sci. 100:332-341 (2013)), because it changes the mechanism of the mineral carbonation from direct gas-solid route into direct aqueous gas-solid (gas-liquid-solid) route. It is commonly accepted that direct aqueous gas-solid route consists of three reaction steps: (1) CO₂ dissolution step; (2) Ca²⁺ leaching step; (3) carbonate precipitation step (P. Ii, “10 Mineral carbonation,” (2010)). Even additives have been applied in aqueous reaction route to enhance carbonation efficiency (O'Connor et al., “Aqueous Mineral Carbonation,” Doe Arc-Tr-04-002, pp. 1-99 (2005)). The fact that CO₂ gas and calcium ions are more easily adsorbed and leached out in the liquid solution further improves the carbonate precipitation process. Thus, this gas-liquid-solid system was selected as the proper mineral carbonation route in the studied experiments.

Above all, in order to further utilize mineral carbonation in several industrial process such as water-gas-shift reaction, it is rather important to understand the mechanism of mineral carbonation process. As previously reported, factors such as particle sizes (Tai et al., “Factors Affecting Wollastonite Carbonation Under CO₂ Supercritical Conditions,” AIChE J. 52(1):292-299 (2006); Santos et al., “Process Intensification Routes for Mineral Carbonation*,” Greenh. Gases Sci. Technol. 1(4):287-293 (2011); and Min et al., “Wollastonite Carbonation in Water-Bearing Supercritical CO₂: Effects of Particle Size,” Environ. Sci. Technol. 51(21):13044-13053 (2017)), temperature (Li et al., “Effect of Temperature on the Carbonation Reaction of CaO with CO₂,” Energy and Fuels 26(4):2473-2482 (2012); Abe et al., “Dissolution Rates of Alkaline Rocks by Carbonic Acid: Influence of Solid/Liquid Ratio, Temperature, and CO₂ Pressure,” Chem. Eng. Res. Des. 91(5):933-941 (2013); Baciocchi et al., “Comparison of Different Reaction Routes for Carbonation of APC Residues,” Energy Procedia 1(1):4851-4858 (2009)), pressure (Tai et al., “Factors Affecting Wollastonite Carbonation Under CO₂ Supercritical Conditions,” AIChE J. 52(1):292-299 (2006) and Gerdemann et al., “Carbon Dioxide Sequestration by Aqueous Mineral Carbonation of Magnesium Silicate Minerals,” Greenh. Gas Control Technol.—6th Int. Conf, pp. 677-682 (2003)), liquid to solid ratio (Abe et al., “Dissolution Rates of Alkaline Rocks by Carbonic Acid: Influence of Solid/Liquid Ratio, Temperature, and CO₂ Pressure,” Chem. Eng. Res. Des. 91(5):933-941 (2013)), and reaction time (Tai et al., “Factors Affecting Wollastonite Carbonation Under CO₂ Supercritical Conditions,” AIChE J. 52(1):292-299 (2006)) can have effect on final carbonation extent. Thus, certain parameters are needed to be controlled to exclude the external influence on carbonation process.

There remains a need for improved methods of producing hydrogen and calcium- or magnesium-bearing carbonates by capturing, converting, and storing carbon dioxide. The present disclosure is directed to overcoming these and other deficiencies in the art.

### SUMMARY

A first aspect relates to a method of producing hydrogen and calcium- or magnesium-bearing carbonates by capturing, converting, and storing carbon dioxide. The method includes providing one or more calcium- or magnesium-bearing compounds; providing one or more water-soluble oxygenates; providing a plurality of catalysts; and reacting said one or more calcium- or magnesium-bearing compounds and said one or more water-soluble oxygenates with said plurality of catalysts under conditions to produce hydrogen and calcium- or magnesium-bearing carbonates.

A second aspect relates to a method for producing hydrogen and calcium- or magnesium-bearing carbonates by capturing, converting, and storing carbon dioxide. The method includes providing one or more calcium- or magnesium-bearing silicates; providing carbon monoxide; providing water vapor; and reacting said one or more calcium- or magnesium-bearing silicates, said carbon monoxide, and said water vapor under conditions effective to produce hydrogen and calcium- or magnesium-bearing carbonates.

A third aspect relates to a method of producing hydrogen and calcium- or magnesium-bearing carbonates by capturing, converting, and storing carbon dioxide. The method includes providing one or more calcium- or magnesium-bearing compounds; providing one or more water-soluble oxygenates; providing a catalyst; and reacting said one or more calcium- or magnesium-bearing compounds and said one or more water-soluble oxygenates with said catalyst under conditions to produce hydrogen and calcium- or magnesium-bearing carbonates.

Given the scientific challenges described herein, the aim of the present disclosure is to create new understanding of fluid-solid interactions in reactive multi-phase environments by integrating in-operando cross-scale characterization methods including synchrotron X-ray scattering, spectroscopy, and tomography measurements with laboratory scale methods.

Harnessing coupled reaction pathways to simultaneously synthesize targeted molecules in the fluid and solid phases in a single system is critical for developing adaptive energy generating processes with in-built environmental controls. This approach is essential for sustainably meeting growing energy needs. In this context, the rational design of novel reaction pathways starting from earth-abundant Ca- or Mg-bearing silicates, and carbon monoxide and water vapor, the precursors of the water gas shift reaction, to produce H₂ and Ca- or Mg-bearing carbonates is essential. The proposed routes are highly promising but less studied approaches for producing a clean and flexible energy carrier such as H₂ while converting acid gases such as CO₂ to solid carbonates. While previous research efforts were focused on demonstrating the feasibility of a subset of reaction pathways involving the precursor and target molecules (Stevens et al., “Sorption-Enhanced Water Gas Shift Reaction by Sodium-promoted Calcium Oxides,” Fuel 89:1280-1286 (2010) and Gadikota et al., “Enhanced Water-Gas-Shift Reaction and In-Situ Carbon Fixation in the Presence of Mg(OH)₂ Slurry in a High Pressure Aqueous System,” In The 12th International Conference on Gas-Liquid and Gas-Liquid-Solid Reactor Engineering GLS 12 (2015), both of which are hereby incorporated by reference in their entirety), there has been a limited understanding of the molecular and morphological basis for the observed reactivity.

The rationale for exploring reaction pathways to simultaneously synthesize H₂ and Ca- and Mg-bearing carbonates emerges from the rising interest in producing H₂ as a replacement fuel source for hydrocarbons. Dresselhaus et al., “Basic Research Needs for the Hydrogen Economy—Report of the Basic Energy Sciences Workshop on Hydrogen Production, Storage, and Use” (2003) and Turner, J., “Sustainable Hydrogen Production Processes,” Science 305:972-974 (2004), both of which are hereby incorporated by reference in their entirety. Gasification followed by the water gas shift reaction (“WGSR”) is used for scalable H₂ production. Smith et al., “A Review of the Water Gas Shift Reaction Kinetics,” International Journal of Chemical Reactactor Engineering 8:1 (2010), which is hereby incorporated by reference in its entirety. Gasification involves reacting organic feedstocks including carbonaceous fuels or non-recyclable plastics in controlled oxygen or steam environments to produce CO, H₂, and CO₂. Pereira et al., “Sustainable Energy: A Review of Gasification Technologies,” Renewable and Sustainable Energy Reviews 16:4753-4762 (2012), which is hereby incorporated by reference in its entirety. CO produced during gasification is further reformed in steam to produce CO₂ and H₂ via the WGSR: CO+H₂O═CO₂+H₂ (ΔH=−41.2 kJ/mol). The exothermicity favors high conversions at low temperatures but kinetics is slow. Given this challenge, conventional modes of operation involve two catalytic systems, one operating between 310-450° C. and another between 200-250° C. to achieve high conversion. Rhodes et al., “Water-Gas Shift Reaction: Finding the Mechanistic Boundary,” Catalysis Today 23:43-58 (1995), which is hereby incorporated by reference in its entirety. The scientific challenge lies in exploring novel reaction pathways for directing the synthesis of H₂ from the WGS reaction and Ca- and Mg-carbonates via CO₂ capture and conversion in a single step. The formation of undesirable intermediates such as metal formate were reported when integrating alkaline hydroxide with the WGS reaction. Elliott et al., “Aqueous Catalyst Systems for the Water-Gas Shift Reaction. 2. Mechanism of Basic Catalysis,” Industrial & Engineering Chemistry Product Research and Development 22:431-435 (1983), which is hereby incorporated by reference in its entirety. Therefore, constructing a fundamental understanding of the kinetic routes in multi-phase environments calls for advanced multi-modal characterization of the fluidic and solid constituents in a given reaction environment.

The capture and conversion of CO₂ in the integrated process is inspired by the natural uptake and thermodynamically downhill conversion of CO₂ to Ca- or Mg-carbonate, starting from Ca- and Mg-bearing silicate and alumino-silicate minerals and rocks in aqueous environments. Lackner, K., “Carbonate Chemistry for Sequestering Fossil Carbon,” Annual Review of Energy and the Environment 27:193-232 (2002); Kelemen et al., “Rates and Mechanisms of Mineral Carbonation in Peridotite: Natural Processes and Recipes for Enhanced, In Situ CO₂ Capture and Storage,” Annual Review Earth and Planetary Science 39:545-576 (2011); Huijgen et al., “Mechanisms of Aqueous Wollastonite Carbonation as a Possible CO₂ Sequestration Process,” Chemical Engineering Science 61:4242-4251 (2006); Giammar et al., “Forsterite Dissolution and Magnesite Precipitation at Conditions Relevant for Deep Saline Aquifer Storage and Sequestration of Carbon Dioxide,” Chemical Geology 217:257-276 (2015); Gerdemann et al., “Ex Situ Aqueous Mineral Carbonation,” Environmental Science and Technology 41:2587-2593 (2007); Matter et al., “Permanent Storage of Carbon Dioxide in Geological Reservoirs by Mineral Carbonation,” Nature Geoscience 2:837-841 (2009); Kelemen et al., “In Situ Carbonation of Peridotite for CO₂ Storage,” Proceedings of the National Academy of Sciences of the United States of America 105:17295-17300 (2008); Gadikota et al., “Chemical and Morphological Changes During Olivine Carbonation for CO₂ Storage in the Presence of NaCl and NaHCO₃,” Physical Chemistry Chemical Physics 16:4679-4693 (2014); Gadikota et al., “Microstructural and Structural Characterization of Materials for CO₂ Storage Using Multi-Scale Scattering Methods In Materials and Processes for CO₂ Capture, Conversion, and Sequestration,” Wiley Books Ch. 7:296-318, eds. Lan, L.; Wong-Ng, K., Huang, K., Cook, L. P. (2018); Hanchen et al., “Precipitation in the Mg-Carbonate System—Effects of Temperature and CO2 Pressure,” Chemical Engineering Science 63:1012-1028 (2008); Schaef et al., “Mineralization of Basalts in the CO₂—H₂O—H₂S System,” International Journal of Greenhouse Gas Control 16:187-196 (2013); Matter et al., “Permanent Carbon Dioxide Storage into Basalt: The CarbFix Pilot Project, Iceland,” Energy Procedia 1:3641-3646 (2009); Min et al., “Wollastonite Carbonation in Water-Bearing Supercritical CO₂: Effects of Particle Size,” Environmental Science and Technology 51:13044-13053 (2017); Daval et al., “Mechanism of Wollastonite Carbonation Deduced from Micro-to Nanometer Length Scale Observations,” American Mineralogist 94:1707-1726 (2009), all of which are hereby incorporated by reference in their entirety. The reactivities of various Ca- and Mg-bearing silicate and alumino-silicate minerals and rocks with acid gases such as CO₂ were evaluated in laboratory-scale environments and shown in FIG. 1. These studies showed that Ca- and Mg-bearing silicate minerals are more reactive compared to Ca- and Mg-bearing alumino-silicate bearing rocks and minerals. Lower reactivity is usually attributed to lower dissolution rates and the formation of mass transfer limiting secondary phases. Hanchen et al., “Dissolution Kinetics of Fosteritic Olivine at 90-150° C. Including Effects of the Presence of CO2,” Geochimica et Cosmochimica Acta 70:4403-4416 (2006); Oelkers et al., “Olivine Dissolution Rates: A Critical Review,” Chemical Geology 500:1-19 (2018); Munz et al., “Mechanisms and Rates of Plagioclase Carbonation Reactions,” Geochimica et Cosmochimica Acta 77:27-51 (2012); Carroll et al., “Dependence of Labradorite Dissolution Kinetics on CO₂(aq), Al(aq), and Temperature,” Chemical Geology 217:213-225 (2005); Chen et al., “Dissolution of Forsteritic Olivine at 65° C. and 2<pH<5,” Chemical Geology 165:267-281 (2000); Wogelius et al., “Olivine Dissolution Kinetics at Near-Surface Conditions,” Chemical Geology 97:101-112 (1992); Awad et al., “Forsteritic Olivine: Effect of Crystallographic Direction on Dissolution Kinetics,” Geochimica et Cosmochimica Acta 64:1765-1772 (2000); Liu et al., “Mechanism for the Dissolution of Olivine Series Minerals in Acidic Solutions,” American Mineralogist 91:455-458 (2006); King et al., “Effect of Secondary Phase Formation on the Carbonation of Olivine,” Environmental Science & Technology 44:6503-6509 (2010); Daval et al., “Influence of Amorphous Silica Layer Formation on the Dissolution Rate of Olivine at 90° C. and Elevated pCO₂,” Chemical Geology 284:193-209 (2011); Saldi et al., “The Role of Fe and Redox Conditions in Olivine Carbonation Rates: An Experimental Study of the Rate Limiting Reactions at 90 and 150° C. in Open and Closed Systems,” Geochimica et Cosmochimica Acta 118:157-183 (2013); Daval et al., “The Effect of Silica Coatings on the Weathering Rates of Wollastonite (CaSiO₃) and Forsterite (Mg₂SiO₄): An 5 Apparent Paradox,” Water-rock Interaction. Taylor Fr. Group, London 713-716 (2010), all of which are hereby incorporated by reference in their entirety. However, there is a limited understanding of the chemical controls of aqueous fluids on the origin, growth, chemistry and morphology of reaction-inhibiting passivation fronts in Ca- or Mg-bearing silicate and alumino-silicate bearing minerals. The relatively higher reactivities of forsterite (Mg₂SiO₄) and wollastonite (CaSiO₃) render them suitable for CO₂ capture, conversion and storage to form Ca- or Mg-carbonate. Amorphous silica is co-produced with Ca- or Mg-carbonates during the carbon mineralization of Ca- and Mg-silicates. Gadikota et al., “Chemical and Morphological Changes During Olivine Carbonation for CO₂ Storage in the Presence of NaCl and NaHCO₃,” Physical Chemistry Chemical Physics 16:4679-4693 (2014); King et al., “Effect of Secondary Phase Formation on the Carbonation of Olivine,” Environmental Science & Technology 44:6503-6509 (2010); Daval et al., “Influence of Amorphous Silica Layer Formation on the Dissolution Rate of Olivine at 90° C. and Elevated pCO₂,” Chemical Geology 284:193-209 (2011); Daval et al., “The Effect of Silica Coatings on the Weathering Rates of Wollastonite (CaSiO₃) and Forsterite (Mg₂SiO₄): An Apparent Paradox,” Water-rock Interaction. Taylor Fr. Group, London 713-716 (2010); Sissmann et al., “The Deleterious Effect of Secondary Phases on Olivine Carbonation Yield: Insight from Time-Resolved Aqueous-Fluid Sampling and FIB-TEM Characterization,” Chemical Geology 357:186-202 (2013); Béarat et al., “Carbon Sequestration via Aqueous Olivine Mineral Carbonation: Role of Passivating Layer Formation,” Environmental Science and Technology 40:4802-4808 (2006); and Eikeland et al., “Optimized Carbonation of Magnesium Silicate Mineral for CO₂ Storage,” ACS Applied Materials & Interfaces 7:5258-5264 (2015). The chemical compositions of the aqueous fluid have a significant effect on the reactivity of Ca- and Mg-silicates. For example, aqueous fluid compositions of 1.0 M NaHCO₃ and 1.0 M NaCl yielded 85% and 15% conversions of forsterite to magnesite. Gadikota et al., “Chemical and Morphological Changes During Olivine Carbonation for CO₂ Storage in the Presence of NaCl and NaHCO₃,” Physical Chemistry Chemical Physics 16:4679-4693 (2014), which is hereby incorporated by reference in its entirety. These data suggested that silica controls on the accelerated conversion of CO₂ to Ca- and Mg-carbonates are dependent on the chemistry of the aqueous fluid. The hypothesis that the chemical compositions of the aqueous fluid influence the structure and morphology of amorphous silica has not been evaluated.

The directed syntheses of stable Ca- and Mg-carbonate phases such as calcite and magnesite are aided by similar seeding surfaces, which help circumvent slow nucleation steps. Giammar et al., “Forsterite Dissolution and Magnesite Precipitation at Conditions Relevant for Deep Saline Aquifer Storage and Sequestration of Carbon Dioxide,” Chemical Geology 217:257-276 (2015); Donnet et al., “Use of Seeds to Control Precipitation of Calcium Carbonate and Determination of Seed Nature,” Langmuir 21:100-108 (2005); Lin, Yi-Pin and Singer, Philip C. “Effects of Seed Material and Solution Composition on Calcite Precipitation,” Geochimica et Cosmochimica Acta 69:4495-4504 (2005); and Swanson et al., “Directed Precipitation of Hydrated and Anhydrous Magnesium Carbonates for Carbon Storage,” Physical Chemistry Chemical Physics 16:23440-23450 (2014), all of which are hereby incorporated by reference in their entirety. However, when silica and carbonate phases are co-present, the influence of these different surfaces on the nucleation and growth of stable carbonate phases has not been studied. Understanding these phenomena will allow for the development of targeted chemical interventions for the directed synthesis of stable carbonate phases. Other potential challenges in integrating the WGSR with carbon mineralization include the slow kinetics of the WGSR in the absence of a catalyst and the formation of undesired side products such as Ca- or Mg-formate. Smith et al., “A Review of the Water Gas Shift Reaction Kinetics,” International Journal of Chemical Reactactor Engineering 8:1 (2010); Elliott et al., “Aqueous Catalyst Systems for the Water-Gas Shift Reaction. 2. Mechanism of Basic Catalysis,” Industrial & Engineering Chemistry Product Research and Development 22:431-435 (1983); and Elliott et al., “Aqueous Catalyst Systems for the Water-Gas Shift Reaction. 1. Comparative Catalyst Studies,” Industrial & Engineering Chemistry Product Research and Developement 22:426-431 (1983), all of which are hereby incorporated by reference in their entirety. Addressing these scientific challenges is essential for developing a rational approach for integrating various reaction pathways for the directed synthesis of H₂ and Ca- and Mg-carbonates starting from earth-abundant silicate minerals.

Mechanistic Tuning of Chemical Transformations for Coupling the Geo-mimicry of Acid Gas Storage with Design Strategies to Produce Clean Energy Carriers in Multi-Phase Reaction Environments (“MATTER”) draws inspiration from naturally occurring geologic phenomena involving the capture, conversion and storage of anthropogenic CO₂ to produce Ca- or Mg-carbonates. This approach is used to develop novel reaction pathways for the directed synthesis of H₂ and Mg- or Ca-carbonates in multiphase reaction environments. The rational design of these coupled reactions is informed by ultrafast multi-modal characterization efforts to capture transient kinetics at far from equilibrium conditions. These research activities are intended address several priority research directions articulated in the reports on basic research. Belkacem et al., “Basic Research Needs for Innovation and Discovery of Transformative Experimental Tools” U.S. Department of Energy (2016) and De Yoreo et al., “Basic Research Needs for Synthesis Science” at Basic Research Needs for Synthesis Science for Energy Relevant Technology (May 2-4, 2016), both of which are hereby incorporated by reference in their entirety.

Scientific outcomes relevant to the advancement of basic energy sciences include the creation of multi-modal experimental methodology for probing chemical reactions and transformations in multiphase environments—Basic Research Needs in Innovation and Discovery of Transformative Experimental Tools (Belkacem et al., “Basic Research Needs for Innovation and Discovery of Transformative Experimental Tools” U.S. Department of Energy (2016), which is hereby incorporated by reference in its entirety); the development of an experimental methodology to simultaneously interrogate structure and microstructural transformations in solids and chemical compositions of fluids—Basic Research Needs in Innovation and Discovery of Transformative Experimental Tools (Belkacem et al., “Basic Research Needs for Innovation and Discovery of Transformative Experimental Tools” U.S. Department of Energy (2016), which is hereby incorporated by reference in its entirety); a design a strategy to make materials to isolate the effect of silica passivation, and measure far from equilibrium kinetics in multiphase environments—Basic Research Needs in Synthesis Science. Tirrell et al., “Basic Research Needs for Energy and Water” (2017), which is hereby incorporated by reference in its entirety. Other outcomes include an advancement of the understanding of geochemical characterization and processes in multiphase reactive environments—Controlling Subsurface Fractures and Fluid Flow: A Basic Research Agenda (De Yoreo et al., “Basic Research Needs for Synthesis Science” at Basic Research Needs for Synthesis Science for Energy Relevant Technology (May 2-4, 2016), which is hereby incorporated by reference in its entirety) and design specific fluid-solid interactions for the directed synthesis of products in fluidic and solid phases—Basic Research Needs in Energy and Water. Pyrak-Nolte et al., “Controlling Subsurface Fractures and Fluid Flow: A Basic Research Agenda” U.S. Department of Energy (2015), which is hereby incorporated by reference in its entirety.

Scientific outcomes relevant to the directed synthesis of H₂ and Ca- and Mg-carbonates include the development of a multi-modal experimental methodology to elucidate the rate-limiting steps and elucidation of the role of aqueous chemistry and solid surfaces on the directed synthesis of carbonates. Further, the present disclosure evaluates morphological controls (e.g., silica passivation, reduced porosity arising from carbonate crystallization) on the predicted conversions of H₂ and Ca- and Mg-carbonates and designs catalytic interventions to accelerate the synthesis of H₂ and Ca- and Mg-carbonates.

Transformational and Translational Impact of the Proposed Scientific Research Effort. MATTER will lead to the development of a cross-scale experimental strategy that establishes the chemo-morphological basis for observed reactivity in multiphase environments. The experimental strategy draws on the emerging need to couple feasibility assessments from thermodynamic predictions, synthesis, and characterization to accelerate scientific advancements for critical energy and environmental technologies. Tirrell et al., “Basic Research Needs for Energy and Water” (2017), which is hereby incorporated by reference in its entirety. This research approach is an alternative to the conventional linear paradigm of synthesis by trial and error, where several experimental parameters are tested prior to determining the optimal conditions for directed synthesis. In this context, the predictive development cycle of model, make and measure is used. The first step is to evaluate the thermodynamic feasibility of coupled reaction pathways. This approach is used to better inform the kinetic measurements. High purity Mg- and Ca-hydroxides are synthesized for comparing their reactivity with Mg- or Ca-silicates. Multi-modal characterization allows for the identification of kinetic bottlenecks. This information facilitates the design of interventionist catalytic approaches for the directed synthesis of H₂ and Ca- and Mg-carbonates using atomistically efficient reaction pathways.

Translational understanding of cross scale chemo-morphological transformations in solids arising from chemical interactions with reactive fluids will advance several geologically relevant applications. Specific examples include engineering the subsurface environments to store or recover fluids and materials of interest in the context of geologic carbon storage, reaction induced approaches for enhanced hydrocarbon recovery, and the chemical stability of nuclear waste materials stored in the subsurface environments. The methods developed in this project will facilitate the targeted design of novel carbon-embedded infrastructural materials with reduced susceptibility to chemical attack and low temperature H₂ conversion in natural and engineered environments. Time-resolved measurements allow for the determination of chemical and morphological origin of failure mechanisms in novel engineered materials. This fundamental understanding can be utilized to develop resilient and adaptive energy storage devices, high performance materials for separations (e.g., adsorbents, absorbents and membranes), sensors for applications related to energy, environment and life sciences, tune reaction-induced fractures in the built and natural environments, and limit fluid-induced corrosion in extreme environments.

To advance the understanding of coupled reaction pathways for the directed synthesis of H₂ and Ca- or Mg-carbonates (FIG. 4), the following issues are considered. First, it is assessed how to rationally construct multiple reactions to develop thermodynamically favorable reaction routes for the directed synthesis of H₂ and Ca- or Mg-carbonate, starting with precursor molecules of CO, H₂O, Mg₂SiO₄ or CaSiO₃. A second consideration is to identify fast and slow steps in coupled reaction environments at far from equilibrium environments, and how to dynamically relate changes in phase transitions, growth of new phases, evolution of grain boundaries and pore-solid interfaces to the kinetics of H₂ and carbonate formation from time scales that range from milliseconds to several hours, and length scales that range from sub-nano to millimeters. Third, to understand the role of less-reactive passivation fronts, the characterization of origin, growth, chemistry and morphology of reaction-inhibiting passivation fronts in Ca- and Mg-bearing silicate and alumino-silicate bearing minerals is considered. A fourth consideration is what alternative reaction pathways can be developed to isolate the effect of Si-passivation on the directed synthesis of H₂ and Ca- or Mg-carbonates. In this context, the reactivity of naturally occurring Ca- and Mg-silicates differing from that of high purity Ca(OH)₂ and Mg(OH)₂ synthesized from these minerals will be considered. Fifth, the influence of similar and dissimilar surface chemistry, morphology, and fluid chemistry on the nucleation and growth of Ca- and Mg-carbonates in multi-phase environments is considered. Sixth, the mechanisms associated with catalytic approaches for limiting the production of undesired side products (e.g., magnesium formate) is considered.

To address these considerations and elucidate the reaction pathways involved as shown in FIG. 5, activities are organized into three key activities which are: (i) rational design of novel geo-inspired integrated pathways, (ii) development of a multi-modal in-operando experimental methodology for a cross-scale understanding of coupled reaction pathways in multiphase environments, and (iii) harnessing integrated experimental methodology for redesigning reaction pathways.

The present disclosure will advance a fundamental understanding of structure-reactivity relationships for directed H₂ and carbonate synthesis in far from equilibrium environments starting from Ca- and Mg-silicates, CO, and H₂O as the reactants. The research efforts will advance the development of microreactor environments compatible with in-operando synchrotron characterization measurements. This research effort will advance the measurement science of multiphase reaction kinetics. For example, focus is on the convergent science emerging from exploring new frontiers in geoscience, synthesis science and energy and environmental science, with particular focus on elucidating the reaction pathways for accelerating the directed synthesis of Mg-carbonate from Mg₂SiO₄ during the co-production of H₂. There are slower reaction kinetics and limited understanding of the hydrated phases that can occur during the carbon mineralization of Mg₂SiO₄. Hanchen et al., “Precipitation in the Mg-Carbonate System—Effects of Temperature and CO2 Pressure,” Chemical Engingeering Science 63:1012-1028 (2008); Swanson et al., “Directed Precipitation of Hydrated and Anhydrous Magnesium Carbonates for Carbon Storage,” Physical Chemistry Chemical Physics 16:23440-23450 (2014); Case et al., “Precipitation of Magnesium Carbonates as a Function of Temperature, Solution Composition, and Presence of a Silicate Mineral Substrate,” Environmental Engineering Science 28:881-889 (2011); Di Tommaso, Devis and de Leeuw, Nora H. “Structure and Dynamics of the Hydrated Magnesium Ion and of the Solvated Magnesium Carbonates: Insights From First Principles Simulations,” Physical Chemistry Chemical Physics 12:894-901 (2010); and Power et al., “Room Temperature Magnesite Precipitation,” Crystral Growth & Design 17:5652-5659 (2017), all of which are hereby incorporated by reference in their entirety.

Another focus will be on the directed synthesis of CaCO₃ from CaSiO₃ with integrated H₂ production. The hypothesis is that the higher reactivity of CaSiO₃, (Huijgen et al., “Mechanisms of Aqueous Wollastonite Carbonation as a Possible CO₂ Sequestration Process,” Chemical Engineering Science 61:4242-4251 (2006); Min et al., “Wollastonite Carbonation in Water-Bearing Supercritical CO₂: Effects of Particle Size,” Environmental Science and Technology 51:13044-13053 (2017); and Zhao et al., “Tuning the Dissolution Kinetics of Wollastonite via Chelating Agents for CO₂ Sequestration with Integrated Synthesis of Precipitated Calcium Carbonates,” Physical Chemistry Chemical Physics 15:15185-15192 (2013), all of which are hereby incorporated by reference in their entirety) will yield faster kinetics of H₂ and CaCO₃ production. This will allow for establishment of robust multi-modal characterization methods to advance the development of adaptive chemical pathways for the directed synthesis of H₂ and Ca- or Mg-carbonates.

### BRIEF DESCRIPTION OF THE DRAWINGS

FIG. 1 shows a comparison of the reactivity of Ca- and Mg-bearing silicate and alumino-silicate minerals and rocks at 185° C., P_{CO2}=150 atm in 1.0 M NaCl+0.64 M NaHCO₃.

FIG. 2 shows the effect of temperature on extent of forsterite carbonation (as published in Gadikota et al., “Chemical and Morphological Changes During Olivine Carbonation for CO₂ Storage in the Presence of NaCl and NaHCO₃,” Physical Chemistry Chemical Physics 16:4679-4693 (2014), which is hereby incorporated by reference in its entirety and reported by NETL—Albany (Gerdemann et al., “Ex Situ Aqueous Mineral Carbonation,” Environmental Science and Technology 41:2587-2593 (2007) and O'Connor et al., “Final report: Aqueous mineral carbonation,” Department of Education/ARC-TR-04-002 (2004), both of which are hereby incorporated by reference in their entirety).

FIG. 3 is a schematic representation of USAXS/SAXS/WAXS instrument at APS in ANL. Gadikota et al., “Microstructural and Structural Characterization of Materials for CO₂ Storage Using Multi-Scale Scattering Methods In Materials and Processes for CO₂ Capture, Conversion, and Sequestration,” Wiley Books Ch. 7:296-318, eds. Lan, L.; Wong-Ng, K., Huang, K., Cook, L. P. (2018), which is hereby incorporated by reference in its entirety.

FIG. 4 shows a cross-scale characterization of reaction driven changes arising from solid-fluid interactions (adapted from Gadikota et al., “Microstructural and Structural Characterization of Materials for CO₂ Storage Using Multi-Scale Scattering Methods In Materials and Processes for CO₂ Capture, Conversion, and Sequestration,” Wiley Books Ch. 7:296-318, eds. Lan, L.; Wong-Ng, K., Huang, K., Cook, L. P. (2018), which is hereby incorporated by reference in its entirety).

FIG. 5 is a schematic representation of the reactions involved in the directed synthesis of H₂ with inherent capture, conversion, and storage of CO₂ as and Ca- and Mg-carbonates in a single reaction environment. CO, steam (reactants of the water-gas-shift process), and Ca- and Mg-bearing silicates are used as the building blocks to produce Ca- and Mg-bearing carbonates and H₂ in a single reaction environment.

FIG. 6 is a flow-through cell for X-ray scattering measurements.

FIG. 7 depicts a Linkam 1500 heater.

FIG. 8 illustrates the effect of [NaHCO₃] and [NaCl] on the extent of forsterite carbonation. Gadikota et al., “Chemical and Morphological Changes During Olivine Carbonation for CO₂ Storage in the Presence of NaCl and NaHCO₃,” Physical Chemistry Chemical Physics 16:4679-4693 (2014), which is hereby incorporated by reference in its entirety.

FIG. 9 shows an in-situ cell micro-tomography cell (adapted from Fusseis et al., “A Low-Cost X-Ray-Transparent Experimental Cell for Synchrotron-Based X-Ray Microtomography Studies Under Geological Reservoir Conditions,” Journal of Synchrotron Radiation 21:251-253 (2014), which is hereby incorporated by reference in its entirety).

FIG. 10 depicts an SEM image of a reacted forsterite grain bearing carbonate and silica phases.

FIG. 11 shows an in-situ cell for GI-SAXS/WAXS measurements.

FIG. 12 shows conversion of water soluble oxygenates (e.g., methanol, formic acid, glucose, glycerol) to produce H₂ and convert Ca- and Mg-bearing effluents to Ca- and Mg-bearing carbonates.

FIGS. 13A-13D illustrate evidence of nanoparticle morphology in MgO (FIG. 13A) and (FIG. 13B) and Mg₂SiO₄ (FIG. 13C) and (FIG. 13D) in SEM images.

FIGS. 14A-14B shows identification of the functional groups in reacted and unreacted (FIG. 14A) MgO and (FIG. 14B) Mg₂SiO₄ samples based on spectra reported in publications prior to the present disclosure.

FIGS. 15A-1 to 15B-3 shows identification of the crystalline phases using XRD analyses representing (FIG. 15A-1) synthesized MgO; (FIG. 15A-2) CMgO—H₂O; (FIG. 15A-3) CMgO—NaHCO₃; (FIG. 15B-1) synthesized Mg₂SiO₄; (FIG. 15B-2) CMg₂SiO₄—H₂O; and (FIG. B-3) CMg₂SiO₄—NaHCO₃. Peaks are identified based on the XRD data reported in publications prior to the present disclosure.

FIGS. 16A-16B illustrates extents of carbonate formed as a function of reaction time with (FIG. 16A) MgO and (FIG. 16B) Mg₂SiO₄ precursors reacted in water and 1M NaHCO₃. The reaction conditions are CO₂ partial pressure of 20 atm and reaction temperature of 200° C. In FIG. 16B, data are compared with published data. The experimental conditions in Gadikota's study are olivine mean particle size of 21.4 μm, 185° C., 139 atm CO₂ partial pressure, and 1 M NaCl+0.64M NaHCO₃ solution. The experimental conditions in Eikeland's study are olivine particles <10 μm, 190° C., 98.69 atm CO₂ partial pressure, 0.5 M NaHCO₃ solution. Eikeland et al., “Optimized Carbonation of Magnesium Silicate Mineral for CO₂ Storage,” ACS Applied Materials & Interfaces 7:5258-5264 (2015), which is hereby incorporated by reference in its entirety.

FIG. 17 provides evidence of nanoparticle morphology in Ca(OH)₂ from SEM image.

FIG. 18 provides evidence of nanoparticle morphology in CaO from SEM image.

FIG. 19 shows evidence of nanoparticle morphology in CaSiO₃ from SEM image.

FIG. 20 is an ATR-FTIR spectra of synthesized and unreacted CaO nanoparticles.

FIG. 21 is an ATR-FTIR spectra of synthesized and unreacted Ca(OH)₂ nanoparticles.

FIG. 22 shows an ATR-FTIR spectra of synthesized and unreacted CaSiO₃ particles.

FIG. 23 provides an ATR-FTIR spectra of synthesized CaO nanoparticles reacted in 1.0 M NaHCO₃ and deionized water. Frequencies that correspond to the vibrational modes of carbonate ions in calcium carbonate at 712, 874, and 1435 cm⁻¹ (Al-Hosney et al., “Water, Sulfur Dioxide and Nitric Acid Adsorption on Calcium Carbonate: A Transmission and ATR-FTIR Study,” Physical Chemistry Chemical Physics 7:1266-1276 (2005), which is hereby incorporated by reference in its entirety) are noted in reacted samples.

FIG. 24 is an ATR-FTIR spectra of synthesized Ca(OH)₂ nanoparticles reacted in 1.0 M NaHCO₃ and deionized water. Frequencies that correspond to the vibrational modes of carbonate ions in calcium carbonate at 712, 874, and 1435 cm⁻¹ (Al-Hosney et al., “Water, Sulfur Dioxide and Nitric Acid Adsorption on Calcium Carbonate: A Transmission and ATR-FTIR Study,” Physical Chemistry Chemical Physics 7:1266-1276 (2005), which is hereby incorporated by reference in its entirety) are noted in reacted samples.

FIG. 25 is an ATR-FTIR spectra of commercially purchased and synthesized CaSiO₃ particles reacted in 1.0 M NaHCO₃ and deionized water. Frequencies that correspond to the vibrational modes of carbonate ions in calcium carbonate at 712, 874, and 1435 cm⁻¹ (Al-Hosney et al., “Water, Sulfur Dioxide and Nitric Acid Adsorption on Calcium Carbonate: A Transmission and ATR-FTIR Study,” Physical Chemistry Chemical Physics 7:1266-1276 (2005), which is hereby incorporated by reference in its entirety) are noted in reacted samples.

FIG. 26 illustrates TGA data of the carbonate-bearing materials obtained after reacting CaO nanoparticles in 1.0 M NaHCO₃ and water.

FIG. 27 depicts TGA data of the carbonate-bearing materials obtained after reacting Ca(OH)₂ nanoparticles in 1.0 M NaHCO₃ and water.

FIG. 28 shows TGA data of the carbonate-bearing materials obtained after reacting CaSiO₃ particles in 1.0 M NaHCO₃ and water.

FIG. 29 shows hydrogen peak intensity for the water gas shift reaction with and without Mg(OH)₂ sorbent.

FIG. 30 shows evidence of CaCO₃ formation in systems starting from 10 atm CO, 200° C., 3 hours, stirring rate of 300 rpm, 0.15 g of Ni/Al₂O₃ catalyst (in the gas phase), 3 g Ca(OH)₂ and in 17 ml H₂O, 0.5 M NaHCO₃, or 1.0 M NaHCO₃.

FIG. 31 shows evidence of MgCO₃ formation in systems starting from 10 atm CO, 200° C., 3 hours, stirring rate of 300 rpm, 0.15 g of Ni/Al₂O₃ catalyst (in the gas phase), 3 g Mg(OH)₂ and in 17 ml H₂O. A and B represent the unreacted and reacted Mg(OH)₂ materials respectively.

FIG. 32 shows the relationship of conversion extent and temperature of pure water gas shift reaction.

FIG. 33 shows the relationship of conversion extent and temperature of enhanced water gas shift reaction by calcium oxide (CaO). Significant enhancement in the conversion is achieved at temperatures below 400° C. in the presence of CaO.

FIG. 34 shows the relation of conversion extent X and temperature of enhanced WGSR by calcium hydroxide (Ca(OH)₂). Significant enhancement in the WGSR is achieved in the presence of Ca(OH)₂.

FIG. 35 shows relation of conversion extent and temperature of enhanced WGSR by wollastonite (CaSiO₃). Enhancement in the WGSR is achieved in the presence of CaSiO₃.

FIG. 36 shows conversion rates of WGSR under different temperature.

FIG. 37 shows conversion rates of WGSR, and enhanced WGSR with MgO carbonation under different temperature.

FIG. 38 shows conversion rates of WGSR, and enhanced WGSR with Mg₂SiO₄ carbonation under different temperature.

FIG. 39 is a schematic representation of carbonation experiments setup. Various parts of the instrument are shown here including the CO₂ gas system (CO₂ gas cylinder, inlet and outlet valve, gas flow direction), controller system (thermocouple and stirrer), pressure gauge, and furnace to keep the reaction temperature.

FIGS. 40A-40B is a thermogravimetric analysis (TGA) data of synthesized calcium hydroxide (FIG. 40A) and commercial calcium hydroxide (FIG. 40B) as well as their reacted products after 3 hours. In FIG. 40A, unreacted synthesized calcium hydroxide (black); reacted products in H₂O after 3 hours (red); reacted products in NaHCO₃ after 3 hours (green). In FIG. 40B, unreacted commercial calcium hydroxide (black); reacted products in H₂O after 3 hours (red); reacted products in NaHCO₃ after 3 hours (green).

FIG. 41 shows thermogravimetric analysis (TGA) data of commercial calcium silicate as well as their reacted products after 3 hours: unreacted calcium hydroxide (black); reacted products in H₂O after 3 hours (red); reacted products in NaHCO₃ after 3 hours (green);

FIG. 42 depicts carbonation extent of several calcium hydroxide and calcium silicate samples in different reaction time. Black solid line: synthesized Ca(OH)₂ reacted in H₂O; red solid line: commercial Ca(OH)₂ reacted in H₂O; green solid line: commercial CaSiO₃ reacted in H₂O; black dash line: synthesized Ca(OH)₂ reacted in NaHCO₃; red dash line: commercial Ca(OH)₂ reacted in NaHCO₃; green dash line: commercial CaSiO₃ reacted in NaHCO₃.

FIGS. 43A-43B shows an FT-IR analysis of synthesized calcium hydroxide (FIG. 43A) and commercial calcium hydroxide (FIG. 43B) as well as their carbonation products after 3 h experiment. In FIG. 43A, unreacted synthesized calcium hydroxide (black), reacted product in H₂O (red), reacted product in NaHCO₃ (green). In FIG. 43B, unreacted commercial hydroxide (black), reacted product in H₂O (red), reacted product in NaHCO₃ (green). 3640 cm⁻¹: O—H bond (Galvin-Ruiz et al., “Characterization of Calcium Carbonate, Calcium Oxide, and Calcium Hydroxide as Starting Point to the Improvement of Lime for Their Use in Construction,” J. Mater. Civ. Eng. 21:625-708 (2009), which is hereby incorporated by reference in its entirety); 1800 cm⁻¹, 1420 cm⁻¹, 870 cm⁻¹ and 710 cm⁻¹: C—O bond (Andersen et al., “ChemInform Abstract: Infrared Spectra of Amorphous and Crystalline Calcium Carbonate.,” ChemInform 23(9) (2010), which is hereby incorporated by reference in its entirety).

FIG. 44 is an FT-IR analysis of commercial calcium silicate as well as its carbonation products after 3 h experiment: unreacted commercial calcium silicate (black), reacted product in H₂O (red), reacted product in NaHCO₃ (green); 1420 cm⁻¹: C—O bond (Andersen et al., “ChemInform Abstract: Infrared Spectra of Amorphous and Crystalline Calcium Carbonate.,” ChemInform 23(9) (2010), which is hereby incorporated by reference in its entirety); 900 cm⁻¹: O—Si—O bond (Ding et al., “CO₂ Mineral Sequestration by Wollastonite Carbonation,” Phys. Chem. Miner. 41(7):489-496 (2014), which is hereby incorporated by reference in its entirety); 645 cm⁻¹, 684 cm⁻¹: Si—O—Si bond (Ding et al., “CO₂ Mineral Sequestration by Wollastonite Carbonation,” Phys. Chem. Miner. 41(7):489-496 (2014), which is hereby incorporated by reference in its entirety); 1010 cm⁻¹, 1060 cm⁻¹: Si—O—Si bond; 1100 cm⁻¹ and 800 cm⁻¹: SiO₂ (Galvin-Ruiz et al., “Characterization of Calcium Carbonate, Calcium Oxide, and Calcium Hydroxide as Starting Point to the Improvement of Lime for Their Use in Construction,” J. Mater. Civ. Eng. 21:625-708 (2009), which is hereby incorporated by reference in its entirety).

FIGS. 45A-45B show an X-ray Diffraction (XRD) pattern of synthesized calcium hydroxide (FIG. 45A) and commercial calcium hydroxide (FIG. 45B) as well as their carbonation products after 3 h experiment. In FIG. 45A, unreacted synthesized calcium hydroxide (black), reacted product in H₂O (red), reacted product in NaHCO₃ (green). In FIG. 45B, unreacted commercial calcium hydroxide (black), reacted product in H₂O (red), reacted product in NaHCO₃ (green).

FIG. 46 shows an X-ray Diffraction (XRD) pattern of commercial calcium silicate powder as well as its carbonation products after 3 h experiment: unreacted synthesized calcium hydroxide (black), reacted product in H₂O (red), reacted product in NaHCO₃ (green).

FIGS. 47A-47F show scanning Electron Microscope (SEM) images of synthesized calcium hydroxide (top images) and commercial calcium hydroxide (bottom images) as well as their reacted products. FIG. 47A shows synthesized calcium hydroxide; FIG. 47B shows synthesized calcium hydroxide reacted products in H₂O after 3 hours; FIG. 47C shows synthesized calcium hydroxide reacted products in NaHCO₃ after 3 hours; FIG. 47D shows commercial calcium hydroxide; FIG. 47E shows commercial calcium hydroxide reacted product in H₂O after 3 hours; and FIG. 47F shows commercial calcium hydroxide reacted products in NaHCO₃ after 3 hours.

FIGS. 48A-48C shows Scanning Electron Microscope (SEM) images of commercial calcium silicate as well as their reacted products. FIG. 48A shows commercial calcium silicate. FIG. 48B shows commercial calcium silicate reacted products in H₂O after 3 hours. FIG. 48C shows commercial calcium silicate reacted products in NaHCO₃ after 3 hours.

FIG. 49 shows a schematic representation of the multiphase chemical interactions involved in the co-generation of bio-hydrogen and inorganic carbonates from biomass, and alkaline industrial residues or minerals.

FIG. 50 shows annual production rate in the United States and average calcium and magnesium concentrations in fly ash, cement kiln dust, steel slag, and red mud.

FIG. 51 shows the influence of methanation reactions and CaO on H₂, CO₂, and CH₄ yields in ethanol-water and ethanol-water-CaO systems at 500 K and N₂ pressure of 50 bar.

FIG. 52 shows SEM images of Ca- and Mg-carbonates.

FIG. 53 shows the Evolution of Ca(OH)₂, CaO and CaCO₃ phases in cellulose based on the characteristic XRD peaks.

FIG. 54 shows a schematic representation of the connectivity among tasks described herein in accordance with the present disclosure.

FIG. 55 depicts cross-scale characterization of reaction driven changes arising from solid-fluid interactions.

FIG. 56 depicts a flow-through cell for USAXS/SAXS/WAXS and EXAFS measurements.

### DETAILED DESCRIPTION

A first aspect relates to a method of producing hydrogen and calcium- or magnesium-bearing carbonates by capturing, converting, and storing carbon dioxide. The method includes providing one or more calcium- or magnesium-bearing compounds; providing one or more water-soluble oxygenates; providing a plurality of catalysts; and reacting said one or more calcium- or magnesium-bearing compounds and said one or more water-soluble oxygenates with said plurality of catalysts under conditions to produce hydrogen and calcium- or magnesium-bearing carbonates.

As used herein, “about” or “approximately,” when used in connection with a numerical variable, generally refers to the value of the variable and to all values of the variable that are within the experimental error (e.g., within the 95% confidence interval for the mean) or within ±10% of the indicated value, whichever is greater.

Where a range of values is provided, it is understood that each intervening value, to the tenth of the unit of the lower limit unless the context clearly dictates otherwise, between the upper and lower limit of that range and any other stated or intervening value in that stated range, is encompassed within the present disclosure. The upper and lower limits of these smaller ranges may independently be included in the smaller ranges and are also encompassed within the present disclosure, subject to any specifically excluded limit in the stated range. Where the stated range includes one or both of the limits, ranges excluding either or both of those included limits are also included in the present disclosure.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which the present disclosure belongs. Although any methods and materials similar or equivalent to those described herein can also be used in the practice or testing of the present disclosure, representative illustrative methods and materials are now described.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

The present disclosure generally relates new processes for producing hydrogen and calcium- or magnesium-bearing carbonates by capture, conversion, storage, extraction, reduction, disposal, or sequestration of carbon dioxide (CO₂), particularly from the air, and involves new processes to reduce or eliminate CO₂, e.g., greenhouse gas CO₂, from the environment. The processes described herein are aimed at effective and efficient carbon management, including cost effectiveness and efficient heat management. Thus, the processes and products of the present disclosure provide useable and economically viable technologies for tackling and handling the escalating problem of global warming.

The sequestration of carbon dioxide gas in repositories that are isolated from the atmosphere is a developing technology that is widely recognized as an essential element in global attempts to reduce carbon dioxide emissions to the atmosphere. The rapid increase in atmospheric carbon dioxide concentrations is of concern due to its properties as greenhouse gas and its contribution to the phenomena of global warming and climate change.

As described herein, the method includes capturing, converting, and storing carbon dioxide (CO₂). The source of CO₂ may be any convenient CO₂ source. The CO₂ source may be a gas, a liquid, a solid (e.g., dry ice), a supercritical fluid, or CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulates. The CO₂ may be, for example, anthropogenic, or originating from human activity. In some embodiments, the gaseous CO₂ source may be a waste gas stream (for example, a by-product of an active process of the industrial plant) such as exhaust from an industrial plant. The nature of the industrial plant may vary and may include, for example, power plants, chemical processing plants, mechanical processing plants, refineries, cement plants, steel plants, and other industrial plants that produce CO₂ as a by-product of fuel combustion or another processing step.

Waste gas streams comprising CO₂ may include both reducing (e.g., syngas, shifted syngas, natural gas, hydrogen, and the like) and oxidizing condition streams (e.g., flue gases from combustion). Waste gas streams that may be useful in accordance with the present disclosure may include oxygen-containing combustion industrial plant flue gas, for example, from coal or another carbon-based fuel with little or no pretreatment of the flue gas; turbo charged boiler product gas; coal gasification product gas; shifted coal gasification product gas; anaerobic digester product gas; wellhead natural gas stream; reformed natural gas or methane hydrates; and the like. Combustion gas from any convenient source may be used in methods and systems of the present disclosure. In some embodiments, combustion gases in post-combustion effluent stacks of industrial plants such as power plants, cement plants, and coal processing plants may be used.

Thus, a waste stream may be produced from a variety of different types of industrial plants. Suitable waste streams in accordance with the present disclosure may include waste streams produced by industrial plants that combust fossil fuels (e.g., coal, oil, natural gas) and anthropogenic fuel products of naturally occurring organic fuel deposits (e.g., tar sands, heavy oil, oil shale). In some embodiments, waste streams suitable for systems and methods of the present disclosure are sourced from a coal-fired power plant, such as a pulverized coal power plant, a supercritical coal power plant, a mass burn coal power plant, or a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas, or, gas that is produced by the gasification of organic matter, for example, coal, or biomass may be used. In other embodiments, waste streams from integrated gasification combined cycle plants may be used. In other embodiments, waste streams produced by Heat Recovery Steam Generator plants may be used in accordance with systems and methods of the present disclosure.

Waste streams produced by cement plants are also suitable sources of carbon dioxide for the systems and methods of the present disclosure. Cement plant waste streams include waste streams from both wet process and dry process plants, which plants may employ shaft kilns or rotary kilns, and may include pre-calciners. These industrial plants may burn a single fuel, or may burn two or more fuels sequentially or simultaneously. Other industrial plants such as smelters and refineries are also useful sources of waste streams that include carbon dioxide.

Industrial waste gas streams may contain carbon dioxide as the primary non-air derived component, or may, especially in the case of coal-fired power plants, contain additional components such as nitrogen oxides (NOx), sulfur oxides (SOx), and one or more additional gases. Additional gases and other components may include carbon monoxide, mercury and other heavy metals, and dust particles, for example, from calcining and combustion processes. Additional components in the gas stream may also include halides like hydrogen chloride and hydrogen fluoride; particulate matter such as fly ash, dusts, and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and PAH compounds. Suitable gaseous waste streams that may be treated have, for example, CO₂ present in amounts of 10 ppm to 1,000,000 ppm, for example, about 10 ppm to about 200,000 ppm, including about 1000 ppm to about 200,000 ppm, about 2000 ppm to about 200,000 ppm, about 3000 ppm to about 200,000 ppm, about 4000 ppm to about 200,000 ppm, about 5000 ppm to about 200,000 ppm, about 6000 ppm to about 200,000 ppm, about 7000 ppm to about 200,000 ppm, about 8000 ppm to about 200,000 ppm, about 9000 ppm to about 200,000 ppm, and about 10,000 ppm to about 200,000 ppm, or any amount between 10 ppm and 1,000,000 ppm. The waste streams, particularly various waste streams of combustion gas, may include one or more additional components, for example, water, NOx (mononitrogen oxides: NO and NO₂), SOx (monosulfur oxides: SO, SO₂ and SO₃), VOC (volatile organic compounds), heavy metals such as mercury, and particulate matter (particles of solid or liquid suspended in a gas).

The methods of the present disclosure develop a cross-scale experimental strategy that establishes the chemo-morphological basis for observed reactivity in multiphase environments. The method draws on the emerging need to couple feasibility assessments from thermodynamic predictions, synthesis, and characterization to accelerate scientific advancements for critical energy and environmental technologies. This research approach is an alternative to the conventional linear paradigm of synthesis by trial and error, where several experimental parameters are tested prior to determining the optimal conditions for directed synthesis.

The methods and processes described herein create new understanding of fluid-solid interactions in reactive multi-phase environments by integrating in-operando cross-scale characterization methods including synchrotron X-ray scattering, spectroscopy, and tomography measurements with laboratory scale methods.

Scientific outcomes relevant to the directed synthesis of H₂ and Ca- and Mg-carbonates in accordance with the methods and processes of the present disclosure include the development of a multi-modal experimental methodology to elucidate the rate-limiting steps and elucidation of the role of aqueous chemistry and solid surfaces on the directed synthesis of carbonates. Further, the present disclosure in one embodiment evaluates morphological controls (e.g., silica passivation, reduced porosity arising from carbonate crystallization) on the predicted conversions of H₂ and Ca- and Mg-carbonates and designs catalytic interventions to accelerate the synthesis of H₂ and Ca- and Mg-carbonates.

MATTER as conducted in accordance with the methods and processes described herein relates to a cross-scale experimental strategy that establishes the chemo-morphological basis for observed reactivity in multiphase environments. This approach is an alternative to the conventional linear paradigm of synthesis by trial and error, where several experimental parameters are tested prior to determining the optimal conditions for directed synthesis. In this context, the predictive development cycle of model, make, and measure is used. The first step is to evaluate the thermodynamic feasibility of coupled reaction pathways. This approach is used to better inform the kinetic measurements. High purity Mg- and Ca-hydroxides may be synthesized for comparing their reactivity with Mg- or Ca-silicates. Multi-modal characterization may allow for the identification of kinetic bottlenecks. This information may facilitate the design of interventionist catalytic approaches for the directed synthesis of H₂ and Ca- and Mg-carbonates using atomistically efficient reaction pathways.

The one or more calcium- or magnesium-bearing compounds as described herein may include any compound that contains a calcium or magnesium group, or a combination of a calcium and magnesium group. In one embodiment, the one or more calcium- or magnesium-bearing compounds may be calcium-bearing silicate, magnesium-bearing silicate (e.g., Mg₂SiO₄), calcium-bearing hydroxide, or magnesium-bearing hydroxide. In one embodiment, the one or more calcium- or magnesium-bearing compounds may be a synthetic compound or, alternatively, the one or more calcium- or magnesium-bearing compounds may be a naturally-occurring compound. Alternatively, the one or more calcium- or magnesium-bearing compounds may be a combination of synthetic and naturally-occurring compounds. High purity silica-free Ca- and Mg-hydroxides may, in one embodiment, be synthesized from CaSiO₃ and Mg₂SiO₄, respectively.

Magnesium- or calcium-bearing silicate and/or hydroxide as described herein includes silicates and/or hydroxides comprising magnesium, calcium, or both magnesium and calcium. Part of the magnesium or calcium may be replaced by other metals, for example iron, aluminium, or manganese. Any magnesium or calcium silicate or hydroxide belonging to the group of sheet silicates may be used in the methods and processes of the present disclosure. Examples of suitable silicates or hydroxides are serpentine, talc, and sepiolite. Serpentine and talc are examples of useful silicate hydroxides.

The methods and processes described herein may use, for example, silicate-based minerals or materials. A non-limiting example of a silicate based material is serpentine, which occurs naturally and may be generally described by the formula of X₂₋₃Si₂O₅(OH)₄, where X is selected from the following: Mg, Ca, Fe²⁺, Fe³⁺, Ni, Al, Zn, and Mn, where the serpentine material is a heterogeneous mixture comprised primarily of magnesium hydroxide and silica. Other examples of silicate-based minerals include, but are not limited to, olivine, which is a natural magnesium-iron silicate ((Mg, Fe)₂SiO₄), and can be generally described by the formula X₂(SiO₄)ₙ, where X is selected from Mg, Ca, Fe²⁺, Fe³⁺, Ni, Al, Zn, and Mn, and n=2 or 3; and a calcium silicate, for example wollastonite, which naturally occurs in metamorphic rocks. The silicate-based minerals may be used individually or in combination with each other. Additionally, the silicate based materials may be found in nature or may be manufactured. Examples of industrial by-products include but are not limited to waste cement and calcium-rich fly ash.

In some embodiments, the silica present in methods and processes of the present disclosure is provided by material comprising metal silicates or a combination of materials comprising metal silicates with supplemental sources of silica (e.g., fly ash, cement kiln dust, and/or other anthropogenic sources).

Rock, a naturally occurring solid aggregate comprising minerals and/or mineraloids, is suitable for use in the present disclosure, particularly rock comprising magnesium and/or calcium (e.g., peridotite, basalt, gabbro, diabase) that, upon processing like size reduction or digestion, provides one or more calcium- or magnesium-bearing compounds. Rock may also provide silica content to compounds of the present disclosure. Minerals, which have characteristic compositions with highly ordered atomic structure and distinct physical properties, may be useful in some embodiments. Minerals comprising magnesium and/or calcium may also provide silicates (e.g., metal silicates, which contain at least one metal along with silicon such as such as calcium silicates, magnesium silicates, aluminosilicates, iron-bearing silicates, and mixtures thereof) that, upon processing, provide silica to compositions of the present disclosure. As rock may be used in the present disclosure, both pure or impure minerals are suitable for the methods and processes of the present disclosure.

Many different materials comprising metal silicates are suitable for use in accordance with the present disclosure, including naturally occurring materials comprising metal silicates such as those present in rocks, minerals, and mineral-rich clays. Metal silicates that may be used in the present disclosure include, but are not limited to, orthosilicates, inosilicates, phyllosilicates, and tectosilicates. Orthosilicates may include, for example, olivine group minerals ((Mg,Fe)₂SiO₄). Inosilicates, which are often referred to as “chain silicates”, include, for example, single chain inosilicates such as pyroxene group minerals (XY(Si,Al)₂O₆), where X represents ions of calcium, sodium, iron (e.g., Fe²⁺), or magnesium and Y represents ions of smaller size, like chromium, aluminum, iron (e.g., Fe³⁺ or Fe²⁺), magnesium, manganese, scandium, titanium, and vanadium, and where pyroxene group minerals richer in magnesium may be used in some embodiments. Single chain inosilicates may also include, for example, pyroxenoid group minerals such as wollastonite (CaSiO₃), commonly in contact-metamorphosed limestone, and pectolite (NaCa₂(Si₃O₈)(OH)), which are also suitable for use in the present disclosure. Double chain inosilicates may include, for example, amphibole group minerals such as anthophyllite ((Mg,Fe)₇Si₈O₂₂(OH)₂). Phyllosilicates (i.e., sheet silicates) include, for example, serpentine group minerals (e.g., antigorite, chrysotile, and/or lizardite polymorphs of serpentine), phyllosilicate clay minerals (e.g., montmorillonite and talc), and mica group minerals (e.g., biotite). Tectosilicates (i.e., framework silicates), which are aluminosilicates (with the exception of quartz group minerals), include, for example, plagioclase feldspars such as labradorite and anorthite.

Mafic and ultramafic minerals (i.e., silicate-containing minerals rich in magnesium and iron, sometimes referred to as magnesium silicates) are examples of metal silicates described above. As such, mafic minerals and ultramafic minerals, and products or processed forms thereof, are also suitable for use in accordance with the present disclosure. Mafic and ultramafic rocks, which include mafic and ultramafic minerals, are suitable for use in accordance with the present disclosure as well. Such rocks may include, but are not limited to, pyroxenite, troctolite, dunite, peridotite, basalt, gabbro, diabase, and soapstone. Common rock-forming mafic minerals include olivine, pyroxene, amphibole, and biotite. Significant masses of olivine- and serpentine-bearing rocks exist around the world, particularly in ultramafic complexes, and in large serpentinite bodies. As described herein, serpentine is an abundant naturally occurring mineral having minor amounts of elements such as chromium, manganese, cobalt, and nickel. Serpentine may refer to any of more than twenty varieties belonging to the serpentine group. Olivine is a naturally occurring magnesium-iron silicate ((Mg,Fe)₂SiO₄), which ranges from forsterite (Fo) (MgSiO₄) to fayalite (Fa) (Fe₂SiO₄). Wollastonite is a naturally occurring calcium silicate that may be used in accordance with the present disclosure.

Mg(OH)₂, in one embodiment, may be produced by recycling ammonium sulphate salts as the extraction agents with magnesium silicates. In this extraction route, a solid-solid reaction of ammonium sulfate with magnesium silicate-bearing minerals such as serpentine (e.g., Mg₃Si₂O₅(OH)₄) may be completed at temperature in the range of 400° C.-550° C. extracts Mg into magnesium sulfate (MgSO₄). The gaseous by-products may include ammonia, water vapor, and sulfur dioxide. Ammonia and water may be recovered to produce ammonium hydroxide. Magnesium sulfate and ammonia hydroxide may be reacted in the aqueous phase at pH 11-12 and room temperature to produce high purity magnesium hydroxide and regenerate ammonium sulfate. In one embodiment, iron may be precipitated as FeO(OH) at pH 8-9.

The one or more calcium- or magnesium-bearing compounds (e.g., Ca- and Mg-hydroxides) may have a varying and adjustable pH. For example, the pH of the calcium- or magnesium-bearing compounds may be 2, 3, 4, 5, 6, 7, 8, 9, 10, 11, or 12, or any amount therebetween and may be adjusted. For example, in various embodiments, the precipitation of silica may occur at pH 2-3, iron oxide precipitation may occur at pH of 8-9 (if iron is present in the silicates), and precipitation of Ca- or Mg-hydroxides may occur at a pH of 11-12.

In one embodiment, the method may evaluate the extent to which silica passivation and lower dissolution rates of Ca- and Mg-silicate influence the directed synthesis of H₂ and Ca- and Mg-carbonate. Quantitative measurements of the differences in the kinetics of H₂ and Ca- and Mg-carbonates using Ca- and Mg-silicates vs. Ca- and Mg-hydroxides may, in one embodiment, provide the fundamental basis for these evaluations.

These multi-phase reactions of the present disclosure may, in one embodiment, be performed in a high temperature and high-pressure reactor (for example, Model #4597 HP-T, Parr Instrument Company, Moline, IL) which may be equipped with multiple ports for introducing gases and recovering gas phase and slurry constituents. The system may, in one embodiment, be continuously mixed. The gas phase concentrations may be determined using a micro gas chromatograph during the reaction. Post-reaction, the slurry phase may, in one embodiment, be filtered to separate the aqueous and solid constituents. The compositions of dissolved metals and potential organic constituents (e.g., formate) in the aqueous phase may be determined using Inductively Coupled Plasma—Atomic Emission Spectroscopy (“ICP-AES”). Nuclear Magnetic Resonance (“NMR”) and Ion Chromatography (“IC”) analyses. A carbonate content in the solids in one embodiment may be determined using Thermogravimetric Analysis (“TGA”). Changes in the crystalline phases and the functional groups in the solid materials may be determined from WAXS/XRD analyses and Fourier Transform-Infrared Spectroscopy measurements. Particle and pore sizes may, in one embodiment, be quantified using Laser Diffraction Particle Size Analysis, and BET Pore Size Analysis.

In one embodiment, the experimental conditions of interest may include solids having, for example, a composition of Ca(OH)₂, Mg(OH)₂, CaSiO₃, and Mg₂SiO₄. The experimental conditions may further include, for example, liquid compositions of deionized water, 0.5 M NaHCO₃, and/or 1.0 M NaHCO₃. In one embodiment, the method is hydrated with between about 0.1 to 1.0 M NaCl and about NaHCO₃ or any amount therebetween.

In one embodiment, the method may occur at a temperature range of between about 150° C. to about 250° C. For example, the temperature range may be between about 150° C. and about 250° C.; between about 150° C. and about 225° C.; between about 150° C. and about 200° C.; between about 150° C. and about 175° C.; between about 175° C. and about 250° C.; between about 200° C. and about 250° C.; between about 225° C. and about 250° C.; and any range therebetween. The temperature, in various embodiments, may be about 150° C., about 155° C., about 160° C., about 165° C., about 170° C., about 175° C., about 180° C., about 185° C., about 190° C., about 195° C., about 200° C., about 205° C., about 210° C., about 215° C., about 220° C., about 225° C., about 230° C., about 235° C., about 240° C., about 245° C., about 250° C., and any temperature therebetween. In one embodiment, coupling aqueous carbon mineralization and WGSR causes dynamic reactive separation of CO₂ that may aid the enhanced H₂ production at lower temperatures in the range of 150-250° C.

The method may, in one embodiment, evaluate whether the reactivity of Ca- and Mg-hydroxides differs from Ca- and Mg-silicates for the directed synthesis of H₂ and Ca- and Mg-carbonates. The Water-Gas Shift Reaction (referred to interchangeably herein as “WGSR” and “WGS reaction”) and carbon mineralization reactions may, for example, be coupled in a single environment. In this system, the limiting conditions may be the conversion of CO and steam to CO₂ and H₂; CO₂ solvation in water; dissolution of hydroxide and silicate minerals to release Ca²⁺ and Mg²⁺ ions; and precipitation of Ca- and Mg-carbonate.

Carbon monoxide can be converted into carbon dioxide with additional hydrogen by reaction with steam according to the following equation

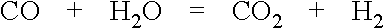

This reaction is termed the water-gas-shift reaction (WGSR). The water-gas-shift reaction is usually carried out in two stages. In the first stage, a reactor packed with iron oxide/chrome oxide catalyst is operated in a temperature range of 300-450° C. and carbon monoxide concentration is decreased from more than 10% to 2-4%. In the second stage, another reactor packed with copper/zinc oxide/aluminum oxide (Cu/ZnO/Al₂O₃) is operated in a lower temperature range, typically 160-250° C., and CO concentration after this stage is further decreased to <1%. According to their operating temperature, the iron oxide/chrome oxide catalyst and the copper/zinc oxide/aluminum oxide catalyst are referred to as the high temperature shift (HTS) catalyst and low temperature shift (LTS) catalyst, respectively.

In one embodiment, the pressure of the methods and processes described herein may be between about 10 atm and about 30 atm. For example, the pressure may be between about 10 atm and about 25 atm; between about 10 atm and about 20 atm; between about 10 atm and about 15 atm; between about 15 atm and about 30 atm; between about 20 atm and about 30 atm; between about 25 atm and about 30 atm, and/or any range therebetween. The pressure may be, for example about 10 atm, about 11 atm, about 12 atm, about 13 atm, about 14 atm, about 15 atm, about 16 atm, about 17 atm, about 18 atm, about 19 atm, about 20 atm, about 21 atm, about 22 atm, about 23 atm, about 24 atm, about 25 atm, about 26 atm, about 27 atm, about 28 atm, about 29 atm, about 30 atm, or any pressure therebetween. Alternatively, the pressure in one embodiment may be as high as 200 atm. For example, the pressure may be about 35 atm, about 40 atm, about 45 atm, about 50 atm, about 55 atm, about 60 atm, about 65 atm, about 70 atm, about 75 atm, about 80 atm, about 85 atm, about 90 atm, about 95 atm, about 100 atm, about 105 atm, about 110 atm, about 115 atm, about 120 atm, about 125 atm, about 130 atm, about 135 atm, about 140 atm, about 145 atm, about 150 atm, about 155 atm, about 160 atm, about 165 atm, about 170 atm, about 175 atm, about 180 atm, about 185 atm, about 190 atm, about 195 atm, about 200 atm, or any pressure therebetween.

The method and processes of the present disclosure may be performed with a water to solids ratio of between about 0.8-0.05 and any amount therebetween. In one embodiment, the water to solids ratio may be between about 0.8-0.75, between about 0.8-0.7, between about 0.8-0.65, between about 0.8-0.6, between about 0.8-0.55, between about 0.8-0.5, between about 0.8-0.45, between about 0.8-0.4, between about 0.8-0.35, between about 0.8-0.3, between about 0.8-0.25, between about 0.8-0.2, between about 0.8-0.15, between about 0.8-0.1, between about 0.8-0.05, or any amount therebetween.

In one embodiment of the methods and processes described herein, there is a reaction time of between about 1 hour and about 5 hours or any amount of time therebetween. For example, the reaction time may be about 1 hour, about 1.5 hours, about 2 hours, about 2.5 hours, about 3 hours, about 3.5 hours, about 4 hours, about 4.5 hours, or any amount of time therebetween.

A water-soluble oxygenate as described herein may include any oxygenate compound or mixture of oxygenate compounds that are soluble in water. Oxygenate compounds may be alcohol, ether, aldehyde, or mixtures thereof. In one embodiment, the one or more water-soluble oxygenates may be methanol, ethanol, formic acid, glucose and other sugars, glycerol, and ether. Liquid compositions that have water soluble oxygenates may be used.

A catalyst as described herein may include any substance that may increase the rate of the methods and processes described herein without itself being consumed. In one embodiment, catalyst is a single catalyst, or alternatively, the catalyst in another embodiment is more than one catalyst or a plurality of catalysts. In one embodiment, the plurality of catalysts may include a catalyst in the gas phase and a catalyst in the liquid phase. In another embodiment, the catalyst may include a catalyst in the gas phase. In another embodiment, the catalyst may include a catalyst in the liquid phase. A gas phase catalyst may include, but is not limited to, copper, platinum, zinc oxide, and/or alumina. A liquid phase catalyst, in one embodiment, may be Pt, Cu, Zn on Al₂O₃ support, and/or metal carbonyl. In one embodiment, the metal carbonyl is ruthenium or iron.

The catalyst concentration may be any concentration that is useful for its intended purpose. Concentration of the catalyst may range from between about 0.5 wt % to about 10 wt %. For example, the concentration of catalyst may be about 0.5 wt %, about 0.6 wt %, about 0.7 wt %, about 0.8 wt %, about 0.9 wt %, about 1.0 wt %, about 2.0 wt %, about 3.0 wt %, about 4.0 wt %, about 5.0 wt %, about 6.0 wt %, about 7.0 wt %, about 8.0 wt %, about 9.0 wt %, about 10.0 wt %, or any concentration therebetween. The concentration of the catalyst may also fall within a range, for example, between about 0.5 wt % to about 10.0 wt %, or between about 0.6 wt % to about 10.0 wt %, or between about 0.7 wt % to about 10.0 wt %, or between about 0.8 wt % to about 10.0 wt %, or between about 0.9 wt % to about 10.0 wt %, or any concentration therebetween. Alternatively, the concentration of the catalyst may also fall within a range, for example, between about 0.5 wt % to about 1.0 wt %, or between about 0.6 wt % to about 1.0 wt %, or between about 0.7 wt % to about 1.0 wt %, or between about 0.8 wt % to about 1.0 wt %, or between about 0.9 wt % to about 1.0 wt %, or any concentration therebetween. The concentration of the catalyst may, alternatively be between about 0.5 wt % to about 0.9 wt %, or between about 0.6 wt % to about 0.9 wt %, or between about 0.7 wt % to about 0.9 wt %, or between about 0.8 wt % to about 0.9 wt %, or between about 0.5 wt % to about 0.8 wt %, or between about 0.6 wt % to about 0.8 wt %, or between about 0.7 wt % to about 0.8 wt %, or between about 0.5 wt % to about 0.7 wt %, or between about 0.6 wt % to about 0.7 wt %, or any range therebetween. Alternatively, the concentration of the catalyst may also fall within a range, for example, between about 1.0 wt % to about 10.0 wt %, or between about 2.0 wt % to about 10.0 wt %, or between about 3.0 wt % to about 10.0 wt %, or between about 4.0 wt % to about 10.0 wt %, or between about 5.0 wt % to about 10.0 wt %, or between about 6.0 wt % to about 10.0 wt %, or between about 7.0 wt % to about 10.0 wt %, or between about 8.0 wt % to about 10.0 wt %, or between 9.0 wt % to about 10.0 wt %, or any concentration therebetween. In one embodiment, the catalyst is 5-10% palladium (Pd) on activated carbon. For example, the catalyst may be 5% Pd, 6% Pd, 7% Pd, 8% Pd, 9% Pd, 10% Pd, or any amount therebetween, on activated carbon.

In one embodiment, the gas phase conversion of CO and H₂O to CO₂ and H₂ may be rate limiting. If this step is rate limiting, then, in one embodiment, the subsequent carbon mineralization steps may be CO₂ limited. Accordingly, in one embodiment, the a gas phase catalyst may be used. Conventional catalysts for low temperature WGSR, in one embodiment, may include copper/zinc oxide/alumina catalysts. In alternative embodiments, Pt-bearing catalysts which are known for high activity for the WGSR at relatively low temperature may be useful.

The calcium-bearing carbonates of the present disclosure may be, for example, calcite, vaterite, and/or aragonite. A desirable feature of the disclosed reaction is to optimize the conditions to allow formation of desirable and stable Mg or Ca carbonates. Calcite, for example, is a stable form and desirable product. Vaterite and aragonite are metastable.

The magnesium-bearing carbonates of the present disclosure may be, for example, magnesite, hydromagnesite, and hydrated magnesium carbonates. Magnesium, for example, is stable and desirable product and hydrated magnesium carbonates are meta stable.

A second aspect relates to a method for producing hydrogen and calcium- or magnesium-bearing carbonates by capturing, converting, and storing carbon dioxide. The method includes providing one or more calcium- or magnesium-bearing silicates; providing carbon monoxide; providing water vapor; and reacting said one or more calcium- or magnesium-bearing silicates, said carbon monoxide, and said water vapor under conditions effective to produce hydrogen and calcium- or magnesium-bearing carbonates.

This aspect is carried out in accordance with the previously described aspect.

In one embodiment, the method further includes a catalyst. In one embodiment, the catalyst is in the gas phase and may be selected from the group consisting of copper, platinum, zinc oxide, and alumina, in accordance with the previously described aspect.

A third aspect relates to a method of producing hydrogen and calcium- or magnesium-bearing carbonates by capturing, converting, and storing carbon dioxide. The method includes providing one or more calcium- or magnesium-bearing compounds; providing one or more water-soluble oxygenates; providing a catalyst; and reacting said one or more calcium- or magnesium-bearing compounds and said one or more water-soluble oxygenates with said catalyst under conditions to produce hydrogen and calcium- or magnesium-bearing carbonates.

This aspect is carried out in accordance with the previously described aspects.

In one embodiment, a catalyst in the liquid phase is added and may be selected from the group consisting of Pt, Cu, Zn on Al₂O₃ support, and metal carbonyl, in accordance with the previously described aspects.

In the following description, reference is made to the accompanying drawings that form a part hereof, and in which is shown by way of illustration specific embodiments which may be practiced. These embodiments are described in detail to enable those skilled in the art to practice the invention, and it is to be understood that other embodiments may be utilized and that structural, logical, and electrical changes may be made without departing from the scope of the present invention. The following description of example embodiments is, therefore, not to be taken in a limited sense.

The present disclosure may be further illustrated by reference to the following examples.

### EXAMPLES

The following examples are intended to illustrate, but by no means are intended to limit, the scope of the present disclosure as set forth in the appended claims.

### Example 1—Rational Design of Novel Geo-Inspired Integrated Pathways

Reaction pathways for the directed synthesis of H₂ and Ca- or Mg-carbonates can be designed by two routes, starting from CO, H₂O, and CaSiO₃ or Mg₂SiO₄ as the building blocks. In the first route, Ca- or Mg-silicates are used directly as the sources of alkalinity. However, the formation of Si-passivation layers and the slow dissolution rates of the silicates may limit the overall reactivity. Daval et al., “Influence of Amorphous Silica Layer Formation on the Dissolution Rate of Olivine at 90° C. and Elevated pCO₂,” Chemical Geology 284:193-209 (2011); Daval et al., “The Effect of Silica Coatings on the Weathering Rates of Wollastonite (CaSiO₃) and Forsterite (Mg₂SiO₄): An Apparent Paradox,” Water-rock Interaction. Taylor Fr. Group, London 713-716 (2010); Béarat et al., “Carbon Sequestration via Aqueous Olivine Mineral Carbonation: Role of Passivating Layer Formation,” Environmental Science and Technology 40:4802-4808 (2006); Daval et al., “Linking NM-Scale Measurements of the Anisotropy of Silicate Surface Reactivity to Macroscopic Dissolution Rate Laws: New Insights Based on Diopside,” Geochimica et Cosmochimica Acta 107:121-134 (2013); and King et al., “Effect of Secondary Phase Formation on the Carbonation of Olivine,” Environmental Science and Technology 44:6503-6509 (2010), all of which are hereby incorporated by reference in their entirety. To isolate these effects on reactivity, high purity Ca(OH)₂ or Mg(OH)₂ can be synthesized from CaSiO₃ or Mg₂SiO₄. This research approach addresses the following research issues: (i) how to quantify the differences in the reactivities arising from the use of Ca-and Mg-silicates as opposed to Ca-and Mg-hydroxides; and (ii) how to develop relationships of the solid structure—aqueous phase composition—reactivity for the directed synthesis of H₂ and Ca- or Mg-carbonates.

### Example 2—Synthesis of Ca- and Mg-Hydroxides from CaSiO₃ and Mg₂SiO₄

The development and dynamic characterization of high purity silica-free Ca- and Mg-hydroxides to isolate the effects of silica passivation and slow dissolution kinetics of Ca- and Mg-silicates is sought. High purity silica-free Ca- and Mg-hydroxides will be synthesized from CaSiO₃ and Mg₂SiO₄, respectively. The scientific challenges in synthesizing high purity Ca- and Mg-hydroxides from naturally occurring minerals is the presence of other constituents such as iron. Typically, sequential adjustments in the aqueous pH conditions have been proposed to synthesize high purity Ca- and Mg-hydroxides. For example, the precipitation of silica at pH 2-3, iron oxide (if iron is present in the silicates) at pH 8-9 and Ca- or Mg-hydroxides at pH 11-12 is achieved through these sequential adjustments. Park, Ah-Hyung Alissa and Fan, Liang-Shih “CO₂ Mineral Sequestration: Physically Activated Dissolution of Serpentine and pH Swing Process,” Chemical Engineering Science 59:5241-5247 (2004), which is hereby incorporated by reference in its entirety. Nitric acid has been conventionally used for pH adjustments. This approach allows for synthesis of high purity Ca- and Mg-hydroxides at low temperature. Alternative routes for producing Mg(OH)₂ by recycling ammonium sulphate salts as the extraction agents with magnesium silicates will be explored. In this extraction route, a solid-solid reaction of ammonium sulfate with magnesium silicate-bearing minerals such as serpentine (Mg₃Si₂O₅(OH)₄) at temperature in the range of 400° C.-550° C. extracts Mg into magnesium sulfate (MgSO₄). The gaseous by-products include ammonia, water vapor and sulfur dioxide. Ammonia and water are recovered to produce ammonium hydroxide. Magnesium sulfate and ammonia hydroxide are reacted in the aqueous phase at pH 11-12 and room temperature to produce high purity magnesium hydroxide and regenerate ammonium sulfate. Iron is precipitated as FeO(OH) at pH 8-9. Nduagu et al., “Production of Magnesium Hydroxide From Magnesium Silicate for the Purpose of CO₂ Mineralisation—Part 1: Application to Finnish Serpentinite,” Minerals Engineering 30:75-86 (2012) and Nduagu et al., “Production of Magnesium Hydroxide From Magnesium Silicate for the Purpose of CO₂ Mineralization—Part 2: Mg Extraction Modeling and Application to Different Mg Silicate Rocks,” Minerals Engineering 30:87-94 (2012), which are hereby incorporated by reference in their entirety.

While the synthesis routes involving the looping of ammonia (Nduagu et al., “Production of Magnesium Hydroxide From Magnesium Silicate for the Purpose of CO₂ Mineralisation—Part 1: Application to Finnish Serpentinite,” Minerals Engineering 30:75-86 (2012) and Nduagu et al., “Production of Magnesium Hydroxide From Magnesium Silicate for the Purpose of CO₂ Mineralization—Part 2: Mg Extraction Modeling and Application to Different Mg Silicate Rocks,” Minerals Engineering 30:87-94 (2012), which are hereby incorporated by reference in their entirety) or the use of acid/base reagents (Park, Ah-Hyung Alissa and Fan, Liang-Shih “CO₂ Mineral Sequestration: Physically Activated Dissolution of Serpentine and pH Swing Process,” Chemical Engineering Science 59:5241-5247 (2004) and Sanna et al., “Post-Processing Pathways in Carbon Capture and Storage by Mineral Carbonation (CCSM) Towards the Introduction of Carbon Neutral Materials,” Energy & Environmental Science 5:7781-7796 (2012), both of which are hereby incorporated by reference in their entirety) may yield the same chemical composition of hydroxides, the chemical transformations involved are different. In the context of using acid-base reagents, dissolution rates of silicate minerals have often been evaluated at close to equilibrium environments (Palandri, James L. and Kharaka, Yousif K. “A Compilation of Rate Parameters of Water-Mineral Interaction Kinetics for Application to Geochemical Modeling,” United States Geological Survey, Open File Report 2004-1068 (2004), which is hereby incorporated by reference in its entirety) to represent chemical transformation in surface geologic conditions. However, there is a limited understanding of the rapid solid-state chemical and morphological transformations as silicate minerals are reacted at far from equilibrium aqueous environments. Rapid online measurements of the aqueous fluid compositions suggested that the surface dissolution kinetics of serpentine captured in the first few minutes of the reaction differ from the long-term kinetics characterized by the growth of the silica passivation layers. Gadikota et al., “Experimental Design and Data Analysis for Accurate Estimation of Reaction Kinetics and Conversion for Carbon Mineralization,” Industrial Engineering Chemistry Research 53:6664-6676 (2014), which is hereby incorporated by reference in its entirety.

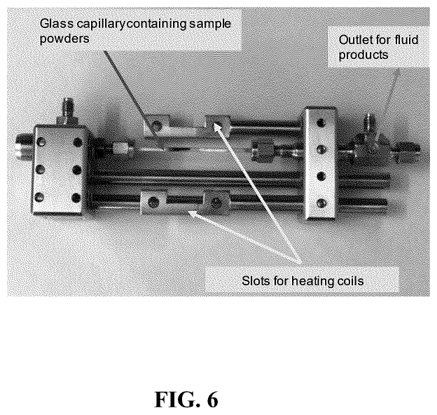

The structural and morphological features during the recovery of Mg and Ca into the aqueous phase from Mg₂SiO₄ and CaSiO₃ are simultaneously determined from Ultra-Small, Small and Wide Angle X-Ray Scattering (USAXS/SAXS/WAXS) using an in-situ flow-through cell (FIG. 6). Changes in the local atomic structure are determined using Total Scattering measurements using the same cell. The influence of pH, far-from-equilibrium and close to equilibrium conditions are probed using these measurements. Rapid time-resolved measurements as early as a few minutes into the reaction can be successfully determined using this setup. The cell has been successfully used to perform measurements at temperatures as high as 800° C. (Asgar et al., “Relating Structural and Microstructural Evolution to the Reactivity of Cellulose and Lignin during Alkaline Thermal Treatment with Ca(OH)₂ for Sustainable Energy Production Integrated with CO₂ Capture,” ACS Sustainable Chemistry & Engineering 7:5449-5461 (2019), which is hereby incorporated by reference in its entirety), and can withstand fluid pressures that range from 1 atm-100 atm. Solid-solid reaction kinetics of olivine with ammonium sulfate to produce magnesium sulfate will be performed at temperatures up to 550° C. FIG. 7 is a schematic representation of the Linkam 1500 heater for these measurements. Solid-solid chemical transformations will be evaluated using thermogravimetric analysis for congruency in measurements. Complementary ex-situ measurements of the reacted samples using BET Pore Size Analysis and Laser Diffraction Particle Size Analysis will be used to discern the particle and pore size fractions of the reacting solids. Scanning and Transmission Electron Microscopy will be used to map the morphological features of the Ca- and Mg-hydroxides.

### Example 3—Determination of the Reactivity of Ca- and Mg-Hydroxides and Silicates on the Directed Synthesis of H₂ and Ca- or Mg-Carbonates

The development of relationships of the solid structure—aqueous phase composition—reactivity for the directed synthesis of H₂ and Ca- or Mg-carbonates is sought. The research activities in this area are aimed at evaluating the hypothesis that the reactivity of Ca- and Mg-hydroxides differs from Ca- and Mg-silicates for the directed synthesis of H₂ and Ca- and Mg-carbonates. To quantitatively evaluate this hypothesis, the WGSR and carbon mineralization reactions are coupled in a single environment. In this system, the limiting conditions could be: (i) the conversion of CO and steam to CO₂ and H₂, (ii) CO₂ solvation in water, (iii) dissolution of hydroxide and silicate minerals to release Ca²⁺ and Mg²⁺ ions, and (iv) precipitation of Ca- and Mg-carbonate. Given these multiple reactions, one of the challenges lies in developing a simplified set of feasible reaction conditions for the directed synthesis of H₂ and Ca- and Mg-carbonates.

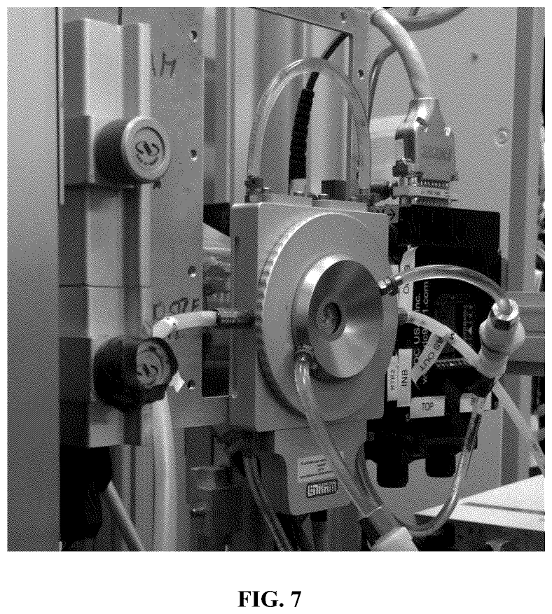

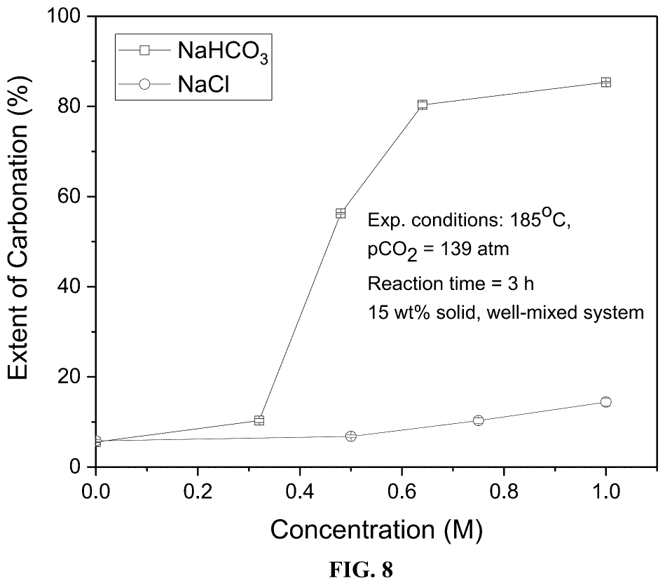

Given the wide range of experimental parameters that can be chosen and tested, a rational basis is used to establish the choice of experimental conditions. Carbon mineralization studies suggested that temperatures in the range of 150-250° C. and CO₂ partial pressures that range from 1 atm-200 atm aid the conversion of CO₂ to Ca- or Mg-carbonates in hydrothermal environments starting from Ca- and Mg-silicate and hydroxides. Gadikota et al., “Accelerated Carbonation of Ca- and Mg-Bearing Minerals and Industrial Wastes Using CO₂,” In Carbon Dioxide Utilization: Closing the Carbon Cycle 115-137 (2015), which is hereby incorporated by reference in its entirety. This temperature range corresponds to that of the low temperature WGSR and gas pressures in the range of 10-30 atm. Pal et al., “Performance of Water Gas Shift Reaction Catalysts: A Review,” Renewable and Sustainable Energy Reviews 93:549-565 (2018) and Bukur et al., “Role of Water-Gas-Shift Reaction in Fischer-Tropsch Synthesis on Iron Catalysts: A Review,” Catalysis Today 275:66-75 (2016), both of which are hereby incorporated by reference in their entirety. Another key consideration is the influence of the aqueous phase. The aqueous phase aids the mobility of ions, and shifts the product composition due to excess water. Elliott et al., “Aqueous Catalyst Systems for the Water-Gas Shift Reaction. 1. Comparative Catalyst Studies,” Industrial & Engineering Chemistry Product Research and Developement 22:426-431 (1983), which is hereby incorporated by reference in its entirety. Inadequate information of the kinetics arising from coupling these reactions at system conditions limits the ability to predict the optimal water-solid ratios needed. Therefore, water to solid ratios that range from as high as 0.8 to as low as 0.05 will be probed. Another consideration is the pH of the fluidic environment. Kinetic measurements of forsterite (Mg₂SiO₄) conversion to MgCO₃ supported by thermodynamic analyses showed that sodium bicarbonate concentrations greater than 0.5 M buffer the solution pH in the range of 7-8, while serving as a carbon carrier (Gadikota et al., “Chemical and Morphological Changes During Olivine Carbonation for CO₂ Storage in the Presence of NaCl and NaHCO₃,” Physical Chemistry Chemical Physics 16:4679-4693 (2014) and Chizmeshya et al., “A Novel Approach to Mineral Carbonation: Enhancing Carbonation While Avoiding Mineral Pretreatment Process Cost: Final Report 924162,” Department of Education (2007), both of which are hereby incorporated by reference in their entirety) (FIG. 8). This, integrating prior knowledge of the conditions that favor WGSR and carbon mineralization allows for the development of a simplified set of feasible experimental conditions.

The experiments are designed to evaluate the extent to which silica passivation and lower dissolution rates of Ca- and Mg-silicate influence the directed synthesis of H₂ and Ca- and Mg-carbonate as opposed to using Ca- and Mg-hydroxide. Quantitative measurements of the differences in the kinetics of H₂ and Ca- and Mg-carbonates using Ca- and Mg-silicates vs. Ca- and Mg-hydroxides provide the fundamental basis for these evaluations. Table 2 summarizes the simplified set of experimental conditions for probing these phenomena. The rational basis for selecting these experimental conditions is described herein.

TABLE 2
Experimental conditions of interest

| | | | | Water to solid | Reaction |
|---|---|---|---|---|---|
| Solids composition | Liquid compositions | T (° C.) | P (atm) | ratios | time |
| Ca(OH)₂, Mg(OH)₂, | DI water, | 150° C.-250° C. | 10-30 atm | 0.8-0.05 | 1-5 hours |
| CaSiO₃, Mg₂SiO₄ | 0.5M NaHCO₃, | | | | |
| | 1.0M NaHCO₃ | | | | |

These multi-phase reactions will be performed in a high temperature and high pressure reactor (Model #4597 HP-T, Parr Instrument Company, Moline, IL) equipped with multiple ports for introducing gases and recovering gas phase and slurry constituents. The reactivity of synthetic and natural Mg₂SiO₄ and CaSiO₃ will be studied. The system is continuously mixed to prevent mass transfer limitations. The gas phase concentrations are determined using a micro gas chromatograph during the reaction. Post-reaction, the slurry phase is filtered to separate the aqueous and solid constituents. The compositions of dissolved metals and potential organic constituents (e.g., formate) in the aqueous phase are determined using ICP-AES and IC analyses, respectively. The carbonate content in the solids is determined using Thermogravimetric Analysis (TGA) by observing the changes in the weight of the sample that correspond to the calcination of the carbonate phases. The changes in the crystalline phases and the functional groups in the solid materials are determined from WAXS/XRD analyses and Fourier Transform-Infrared Spectroscopy measurements, respectively. Particle and pore sizes are quantified using Laser Diffraction Particle Size Analysis, and BET Pore Size Analysis, respectively. Morphological features of the reactants and products are determined from SEM/TEM analyses.

However, the proposed characterization approach is an invasive approach in which gas and slurry phase compositions are withdrawn from the reacting environment. Careful calculations need to be performed to ascertain that this approach does not alter the kinetics of solid and fluidic transformations in this multiphase system. The number of measurements is limited by the volume of the reacting system. Further, rapid time-dependent transitions in the solid phases are not achieved in this process. As a result, it is challenging to decouple the limiting reaction in the series of reactions occurring in this multiphase system. To address these limitations, the non-invasive characterization approaches are described in the following examples.

### Example 4—Multi-Modal in-Operando Experimental Methodology for a Cross-Scale Understanding of Coupled Reaction Pathways in Multiphase Environments

Basic Science of harnessing innovative experimental tools for investigating “real-world” systems: Designing non-invasive characterization approaches are used for elucidating reaction limiting pathways during the directed synthesis of H₂ and Ca- and Mg-carbonates. The kinetics of H₂ and carbonate synthesis will be linked to the structural and morphological changes in solid substrates in multiphase environments.

In-operando cross-scale X-ray scattering and tomography methods will be used to elucidate chemo-morphological transformations during the directed synthesis of H₂ and Ca- and Mg-carbonates. One of the challenges in achieving high conversions of H₂ and Ca- and Mg-carbonates is a limited understanding of transient kinetics in far-from-equilibrium environments. Since critical scientific insights remain locked in transient kinetics, the development of a non-invasive experimental strategy that captures chemical and morphological changes in the solids and the composition of the fluid phase is essential. Therefore, the key research issues that the present disclosure seeks to address are: (i) how to develop a non-invasive, in-operando cross-scale experimental strategy to develop structure-reactivity relationships in multi-phase environments; and (ii) how to unlock critical scientific insights in transient kinetics to advance the directed synthesis of H₂ and Ca- and Mg-carbonates. Addressing these research questions will allow for the determination of the rate limiting reactions during the directed synthesis of H₂ and Ca-or Mg-carbonates (Table 3).

TABLE 3
Relationship between observed measurements and rate limiting steps

| | | | | |
|---|---|---|---|---|
| Observed | Low H₂ and CO₂ | High H₂ and CO₂ | High H₂ and low CO₂ | High H₂, low CO₂, high |
| conditions | conversions | conversions, low | conversions, low | concentration of Ca or Mg in |
| | | dissolved carbon | concentration of Ca or Mg | solution, low carbonate |
| | | | in solution, low carbonate | formation |
| | | | formation | |
| Limiting | Water gas shift | CO₂ hydration | Mineral dissolution is | Carbonate precipitation |
| step | reaction | | limiting and potential | |
| | | | mass transfer limitations | |
| | | | due to silica passivation | |

To establish a chemical and morphological basis, particularly when the dissolution of hydroxide or silicate precursors or carbonate formation is rate limiting, in-operando and non-invasive characterization approaches are needed.

The outcomes will allow for the determination of whether the WGSR or CO₂ dissolution are the rate-limiting steps. This approach allows for the selection of experimental conditions that overcome these limitations. By following the solid-state transformations as a function of time using USAXS/SAXS/WAXS measurements (Ilavsky et al., “Development of Combined Microstructure and Structure Characterization Facility for In Situ and Operando Studies at the Advanced Photon Source,” Journal of Applied Crystallography 51:867-882 (2018), which is hereby incorporated by reference in its entirety), and the gas and aqueous phase compositions, it is now possible to determine if dissolution or carbonate formation are the rate-limiting steps. USAXS/SAXS measurements have been conventionally used to determine the size and shape of morphological features that range from the nanometer to micrometer scales in static material (Ilavsky et al., “Ultra-Small-Angle X-Ray Scattering at the Advanced Photon Source,” Journal of Applied Crystallography 42:469-479 (2009), which is hereby incorporated by reference in its entirety). The critical information that is needed to extract this information from the USAXS/SAXS measurements are the scattering length density and the density of the samples. Beaucage, G. “Approximations Leading to a Unified Exponential/Power-Law Approach to Small-Angle Scattering,” Journal of Applied Crystallography 28:717-728 (1995), which is hereby incorporated by reference in its entirety. The scattering length density is a function of the chemical composition of the material. With the Wide Angle X-Ray Scattering capability, it is now possible to ascertain the chemical composition of crystalline materials. The strong X-ray scattering signals obtained from Ca- and Mg-hydroxides and silicates and the relatively small contributions of water to the overall observed scattering aid these measurements. The short data collection times of USAXS/SAXS/WAXS to the order of 3 minutes allow for rapid quantification of chemical and morphological changes in materials across four decades in spatial scale i.e., from the Angstrom to micrometer scales.

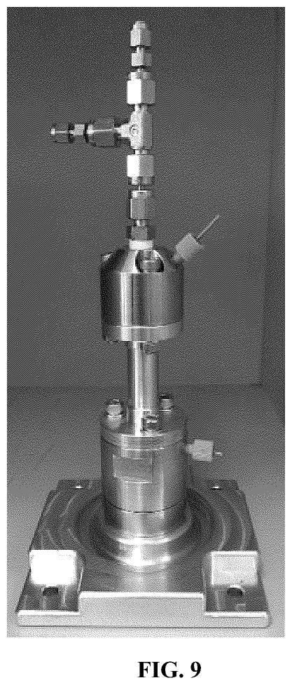

To avoid multiple scattering, which emerges from incoherent contributions to the scattering pattern and makes data analyses challenging (Schelten et al., “Multiple-Scattering Treatment For Small-Angle Scattering Problems,” Journal of Applied Crystallography 13:385-390 (1980) and Jensen et al., “Effects of Multiple Scattering Encountered for Various Small-Angle Scattering Model Functions,” Journal of Applied Crystallography 51 (2018), both of which are hereby incorporated by reference in their entirety), samples will be compacted to thickness no greater than 1 mm. The flow cell shown in FIG. 6 is aligned vertically and adapted for the gas-liquid-solid reactions. Experiments will be performed at a subset of the conditions listed in Table 2 that are known to facilitate high conversions. Changes in the grain boundaries from the micrometer-to-millimeter scale range will be determined using in-situ synchrotron X-ray tomography measurements. FIG. 9 is a schematic representation of an in-situ flow-through cell adapted for observing reaction-driven microstructural changes. Fusseis et al., “A Low-Cost X-Ray-Transparent Experimental Cell for Synchrotron-Based X-Ray Microtomography Studies Under Geological Reservoir Conditions,” Journal of Synchrotron Radiation 21:251-253 (2014), which is hereby incorporated by reference in its entirety. This in-situ cell was initially built to accommodate temperatures as high as 200° C. and fluid pressures as high as 200 atm with core samples. The internal design of this cell has been adapted to accommodate micrometer-sized grains for proposed measurements. Specifically, the influence of carbonate and silica formation on the changes in the grain boundaries and their influence of diffusion-limiting behavior will be evaluated.

Role of sample preparation—Significant scientific information such as the role of mass transfer and morphology (e.g., surface area, grain boundaries) on reactivity can be inferred from performing the same sets of measurements on materials with the same chemistry but different morphological organizations. With this context, select scattering measurements will be performed on polished thin sections of Ca- and Mg-silicates, compacted pellets and powders. The morphological changes in the polished thin sections before and after the scattering experiments will be directly imaged using TEM and SEM. Important information such as the spatial variation in the reactivity of pellets can be mapped to changes in the chemistry, morphology and grain boundary contacts using multi-scale X-ray scattering and X-ray tomography measurements, respectively. Closely compacted powders will allow for exploration of the hypothesis that carbonate growth in interparticle pore spaces is sufficient to cause cementation and limit further reactivity. Alternatively, enhanced crystallization pressures arising from carbonate growth may cause the pellet to disintegrate. This concept is analogous to reaction-induced fracturing (Kelemen et al., “Rates and Mechanisms of Mineral Carbonation in Peridotite: Natural Processes and Recipes for Enhanced, In Situ CO₂ Capture and Storage,” Annual Review Earth and Planetary Science 39:545-576 (2011); Kelemen et al., “In Situ Carbonation of Peridotite for CO₂ Storage,” Proceedings of the National Academy of Sciences of the United States of America 105:17295-17300 (2008); Røyne et al., “Pore-Scale Controls on Reaction-Driven Fracturing,” Reviews in Mineralogy and Geochemistry 80:25-44 (2015); and Zhu et al., “Experimental Evidence of Reaction-Induced Fracturing During Olivine Carbonation,” Geophysical Research Letters 43:9535-9543 (2016), all of which are hereby incorporated by reference in their entirety), or salt induced crystallization and chemo-mechanical weakening (Espinosa-Marzal et al., “Impact of In-Pore Salt Crystallization on Transport Properties,” Environmental Earth Sciences 69:2657-2669 (2013); Flatt et al., “Chemo-Mechanics of Salt Damage in Stone,” Nature Communications 5:4823 (2014); and Desarnaud et al., “The Pressure Induced by Salt Crystallization in Confinement,” Scientific Reports 6:30856 (2016), all of which are hereby incorporated by reference in their entirety). Further, the influence of high surface area powders on the directed synthesis of H₂ and Ca- and Mg-carbonates will be evaluated.

Data Analyses—The changes in the crystallographic features in the WAXS regime will be determined using rietveld refinement. Rietveld, H., “The Rietveld Method,” Physica Scripta 89:98002 (2014), which is hereby incorporated by reference in its entirety. Several important morphological features can be determined from the USAXS/SAXS regime. The specific surface area and the morphology pore-solid interface (e.g., smooth, fractal, rod-shaped) are obtained from the Porod's Law. Porod, G. “X-Ray Low Angle Scattering of Dense Colloid Systems, Part I,” Kolloid Z. 124:83-114 (1951), which is hereby incorporated by reference in its entirety. The sizes and the shapes of the particles as they are reacted are determined from the Form Factor analyses. Pauw, Brian R. “Everything SAXS: Small-Angle Scattering Pattern Collection and Correction,” Journal of Physics: Condensed Matter 26 (2014), which is hereby incorporated by reference in its entirety. Previous USAXS/SAXS measurements suggest that interference effects may arise as a result of the scattering features becoming concentrated. In such scenarios, analyses of the structure factors will be performed (as described in Gadikota et al., “In Situ Angstrom-to-Micrometer Characterization of the Structural and Microstructural Changes in Kaolinite on Heating Using Ultrasmall-Angle, Small-Angle, and Wide-Angle X-ray Scattering (USAXS/SAXS/WAXS),” Industrial Engineering Chemistry Research 56 (2017), which is hereby incorporated by reference in its entirety). Several approaches exist for modeling the morphological features in Ultra-Small and Small Angle X-Ray Scattering in the Irena (Ilavsky et al., “Irena: Tool Suite for Modeling and Analysis of Small-Angle Scattering,” Journal of Applied Crystallography 42:347-353 (2009), which is hereby incorporated by reference in its entirety) and Nika (Ilavsky, Jan “Nika: Software for Two-Dimensional Data Reduction,” Journal of Applied Crystallography 45:324-328 (2012), which is hereby incorporated by reference in its entirety) packages available through IgorPro. A few examples include Unified Fit Model (Beaucage, G. “Approximations Leading to a Unified Exponential/Power-Law Approach to Small-Angle Scattering,” Journal of Applied Crystallography 28:717-728 (1995), which is hereby incorporated by reference in its entirety), Maximum Entropy (Potton et al., “Ferrofluid Particle Size Distributions From Magnetisation and Small Angle Neutron Scattering Data,” Journal of Magnetism Magnetic Materials 39:95-98 (1983); Potton et al., “A New Method for the Determination of Particle Size Distributions from Small-Angle Neutron Scattering Measurements,” Journal of Applied Crystallography 21: 891-897 (1988); Potton et al., “Particle Size Distributions from SANS Data Using the Maximum Entropy Method,” Journal of Applied Crystallography 21:663-668 (1988); Jemian et al., “Characterization of 9Cr-1MoVNb Steel by Anomalous Small-Angle X-Ray Scattering,” Acta Metallurgica et Materialia 39:2477-2487 (1991), all of which are hereby incorporated by reference in their entirety), and fractal analyses (Beaucage, G. “Determination of Branch Fraction and Minimum Dimension of Mass-Fractal Aggregates,” Physical Review E 70:031401 (2004) and Kammler et al., “Monitoring Simultaneously the Growth of Nanoparticles and Aggregates by In Situ Ultra-Small-Angle X-Ray Scattering,” Journal of Applied Physics 97:54309 (2005), both of which are hereby incorporated by reference in their entirety). Quantification of the morphological features is grounded in the physical observations of the reacted ex-situ materials using SEM and TEM, BET pore size analyses, and particle size analyses. The use of TomoPy software (Pelt ET AL., “Integration of TomoPy and the ASTRA Toolbox for Advanced Processing and Reconstruction of Tomographic Synchrotron Data,” Journal of Synchrotron Radiation 23:842-849 (2016) and Gürsoy et al., “TomoPy: A Framework for the Analysis of Synchrotron Tomographic Data,” Journal of Synchrotron Radiation 21:1188-1193 (2014), both of which are hereby incorporated by reference in theire entirety) available at Sector 2-BM is proposed for the 3-D reconstruction of the samples analyzed using X-Ray Tomography measurements.

### Example 5—Elucidating the Role of Chemical Controls of Aqueous Fluids on Passivation Induced Kinetics in Multi-Phase Reactive Environments

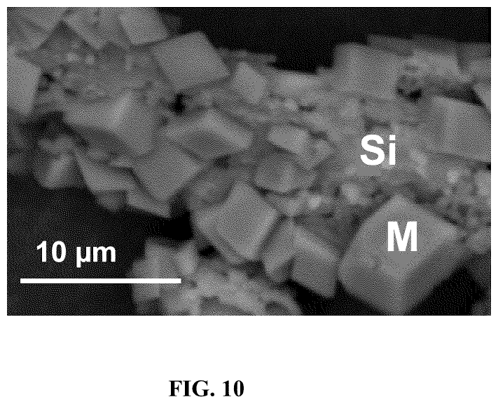

The scientific objective is to investigate the influence of aqueous fluid composition on the development of silica-passivation layers and connect the role of these mass-transfer limiting layers to transient kinetics. The efforts in this research area are motivated by limited understanding of aqueous chemical controls on the structure and morphology of Si-passivation layers. Specifically, the hypothesis that the aqueous fluid chemistry influences the morphology and composition of precipitated silica is tested. Several scientific uncertainties exist regarding the formation of the Si-passivation layer and its influence on reactivity. The precipitated silica has been reported to be an agglomeration of particles and is discontinuous (Seyama et al., “Surface Characterization of Acid-Leached Olivines by X-Ray Photoelectron Spectroscopy,” Chemocal Geology 129:209-216 (1996) and Zakaznova-Herzog et al., “Characterization of Leached Layers on Olivine and Pyroxenes Using High-Resolution XPS and Density Functional Calculations,” Geochimica et Cosmochimica Acta 72:69-86 (2008), both of which are hereby incorporated by reference in their entirety), has thickness of a few unit cells (Pokrovsky et al., “Kinetics and Mechanism of Forsterite Dissolution at 25° C. and pH from 1 to 12,” Geochimica et Cosmochimica Acta 64:3313-3325 (2000) and Pokrovsky et al., “Forsterite Surface Composition in Aqueous Solutions: A Combined Potentiometric, Electrokinetic, and Spectroscopic Approach,” Geochimica et Cosmochimica Acta 64:3299-3312 (2000), both of which are hereby incorporated by reference in their entirety), or is composed of amorphous hydrated magnesium silicate (or serpentine)-like phase (Davis et al., “Magnesium Silicate Dissolution Investigated by ²⁹Si MAS, ¹H-²⁹Si CPMAS, ²⁵Mg QCPMG, and ¹H-²⁵Mg CP QCPMG NMR,” Physical Chemistry Chemical Physics 11:7013-7021 (2009), which is hereby incorporated by reference in its entirety). Prior studies provide strong evidence suggesting that the composition of the aqueous phase has an influence on the carbon mineralization behavior. However, the role of the silica-passivation layer in this context is uncertain. For example, fluid concentrations of 1.0 M NaHCO₃ and 1.0 M NaCl yielded olivine conversions of 85% and 14%, respectively (FIG. 8), all other experimental conditions remaining the same. The co-existence of magnesite (represented by M) and silica (represented by Si) on a reacted forsterite grain is shown in the SEM image in FIG. 10. These observations suggest that the higher surface area provided by the precipitated silica layers may aid carbonate precipitation. Further, universal textural and transport properties may not be ascribed to these layers. Daval et al., “The Effect of Silica Coatings on the Weathering Rates of Wollastonite (CaSiO₃) and Forsterite (Mg₂SiO₄): An Apparent Paradox,” Water-rock Interaction. Taylor Fr. Group, London 713-716 (2010), which is hereby incorporated by reference in its entirety. These properties may be specific to the mineral, fluidic properties, and temperature, which also influence the reaction kinetics. The high conversions of forsterite to magnesite in the presence of 1.0 M NaHCO₃ (FIG. 8) suggest that Si-passivation layers may not limit reactivity in the appropriate fluidic environments. However, the scientific basis for this observation has not been established. In this context, the research issues of interest are: (i) how to characterize the chemical composition and morphology of the precipitated silica as calcium silicate (CaSiO₃) and magnesium silicate (Mg₂SiO₄) are reacted at system conditions; and (ii) what is the influence of aqueous fluid chemistry on the chemical composition and morphology of the precipitated silica.

To delineate the influence of mineralogy and aqueous fluid chemistry on the chemistry and morphology of Si-passivation layers, a reaction environment is constructed where other reactions such as the WGSR and CO₂ hydration are not rate-limiting. The influence of deionized water, 0.1-1.0 M NaCl and NaHCO₃ on the coupled growth of Si and carbonates will be probed at temperatures and pCO₂ in the range of 150° C.-250° C. and 10-30 atm, respectively. These measurements are performed in a laboratory environment where the reacting solids and the aqueous, and gas phases are sampled and analyzed. Experimental conditions that yield significant differences in chemical compositions of the solid, aqueous and gas phases, and the morphology of the reacting solid, are dynamically characterized. The changes in the structure of amorphous silica will be determined using NMR and total scattering measurements. Central to these investigations is the hypothesis that Si bonding differs with the extent of dissolution (Cui et al., “Evidence from ²⁹Si Solid-State Nuclear Magnetic Resonance of Dissolution Reactions of Forsterite,” Environmental Engineering Science 33:799-805 (2016), which is hereby incorporated by reference in its entirety) and carbonate formation. ²⁹Si NMR measurements are proposed to identify if Si has zero, one, two, three, or four connections to another Si atoms, and quantify the proportion of these species in solid and aqueous phases.

Crystalline to amorphous transitions at system conditions will be determined using total scattering measurements. The pair distribution functions (“PDFs”) determined from the total scattering measurements provide local atomic structural information from the Bragg scattering and the underlying diffuse scattering. Proffen, Thomas “Analysis of Disordered Materials Using Total Scattering and the Atomic Pair Distribution Function,” Reviews in Mineralogy and Geochemistry 63:255-274 (2006) and White et al., “Uncovering the True Atomic Structure of Disordered Materials: The Structure of a Hydrated Amorphous Magnesium Carbonate (MgCO₃·3D₂O),” Chemistry of Materials 26:2693-2702 (2014), both of which are hereby incorporated by reference in their entirety. The in-situ cell that is constructed for USAXS/SAXS/WAXS analyses for measurements proposed above is compatible with total scattering measurements. Data processing software such as GSAS-II (Toby, Brian. H. and Von Dreele, Robert B. “GSAS-II: The Genesis of a Modern Open-Source All Purpose Crystallography Software Package,” Journal of Applied Crystallography 46:544-549 (2013) and Toby, Brian. H. and Von Dreele, Robert B. “What's New in GSAS-II,” Powder Diffraction 29:S2-S6 (2014), both of which are hereby incorporated by reference in their entirety), xPDFsuite (Yang et al., “xPDFsuite: An End-To-End Software Solution for High Throughput Pair Distribution Function Transformation, Visualization and Analysis,” Condensed Matter arXiv Preprared arXiv1402.3163 (2014), which is hereby incorporated by reference in its entirety), Fit2D (Hammersley, A. P. “FIT2D: An Introduction and Overview,” European Synchrotron Radiation Facility Internal Report ESRF97HA02T 68:58 (1997) and Hammersley, A. P. “FIT2D: A Multi-Purpose Data Reduction, Analysis and Visualization Program,” Journal of Applied Crystallography 49:646-652 (2016), both of which are hereby incorporated by reference in their entirety), pdfgetX2 (Qiu et al., “PDFgetX2: a GUI-Driven Program to Obtain the Pair Distribution Function From X-Ray Powder Diffraction Data,” Journal of Applied Crystallography 37:678 (2004), which is hereby incorporated by reference in its entirety), and pdfgetX3 (Juhis et al., “PDFgetX3: A Rapid and Highly Automatable Program for Processing Powder Diffraction Data into Total Scattering Pair Distribution Functions,” Journal of Applied Crystallography 46:560-566 (2013), which is hereby incorporated by reference in its entirety) available at Sector 11-ID at APS will be used for analyzing the changes in the local atomic structures. As described herein, experiments will be performed with the polished thin sections, compacted pellets, and powders with sizes in the tens of micrometer range to investigate the role of coupled reaction and transport on the development of the silica passivation layer.

To resolve if the Si-passivation layers are a series of consecutive uniform layers or an agglomeration of deposited silica particles or both, the cross sectional morphological features of the reacted Ca- and Mg-silicates are mapped using TEM. To evaluate the hypothesis that the high surface area of precipitated silica facilitates nucleation and growth of carbonates, BET pore size measurements, and USAX/SAXS analyses are to be performed. The outcome of these efforts is to map the chemical compositions and morphologies of the silica layers to the chemical composition of the aqueous fluid and the kinetics and extents of dissolution and carbon mineralization of Ca- and Mg-silicates.

### Example 6—Role of Solid Interfaces on Structure and Morphology of Ca- and Mg-Carbonates

The scientific objective is to explore the role of similar and dissimilar surfaces on the structure and morphology of precipitated Ca- and Mg-carbonates.

The efforts in this research area are motivated by two factors: (i) the need to develop predictive chemical controls on the structures and morphologies of Ca- and Mg-carbonates at the system conditions of interest and (ii) the need to enable effective utilization of Ca and Mg species to produce stable carbonates, as opposed to metastable hydrated species. However, it has been shown that in multiphase reactive environments, silica and metastable hydrated Mg-carbonates can dissolve and reprecipitate. Swanson et al., “Directed Precipitation of Hydrated and Anhydrous Magnesium Carbonates for Carbon Storage,” Physical Chemistry Chemical Physics 16:23440-23450 (2014), which is hereby incorporated by reference in its entirety. Similar seeding surfaces enable the precipitation of stable phases of magnesite (Giammar et al., “Forsterite Dissolution and Magnesite Precipitation at Conditions Relevant for Deep Saline Aquifer Storage and Sequestration of Carbon Dioxide,” Chemical Geology 217:257-276 (2015) and Swanson et al., “Directed Precipitation of Hydrated and Anhydrous Magnesium Carbonates for Carbon Storage,” Physical Chemistry Chemical Physics 16:23440-23450 (2014), both of which are hereby incorporated by reference in their entirety) and calcite (Lin et al., “Effects of Seed Material and Solution Composition on Calcite Precipitation,” Geochimica et Cosmochimica Acta 69:4495-4504 (2005); Nancollas et al., “The Crystallization of Calcium Carbonate. II. Calcite Growth Mechanism,” Journal of Colloid and Interface Science 37:824-830 (1971); and Reddy et al., “Kinetics of Calcium Carbonate (Calcite)-Seeded Crystallization: Influence of Solid/Solution Ratio on the Reaction Rate Constant,” Journal of Colloid and Interface Science 80:171-178 (1981), all of which are hereby incorporated by reference in their entirety) by circumventing slow nucleation steps. Hovelmann and co-workers attributed carbonate growth on MgCO₃ surfaces as opposed to Mg(OH)₂ to higher self-adhesion and larger misfit between the two phases. Chernov, A. A. “Modem Crystallography III: crystal growth,” Springer Science & Business Media 36 (2012), which is hereby incorporated by reference in its entirety. The studies show the co-existence of stable magnesium carbonate phases and amorphous silica (FIG. 10). These observations suggest that the nucleation of carbonates may start on an amorphous silica surface and accelerate as increasing number of similar carbonate surfaces originate. Favorable interactions between the substrate and precipitate were found to influence CaCO₃ precipitation in the nanopores and macropores of amorphous silica. Stack et al., “Pore-Size-Dependent Calcium Carbonate Precipitation Controlled by Surface Chemistry,” Environmental Science & Technology 48:6177-6183 (2014), which is hereby incorporated by reference in its entirety. However, carbonate nucleation and growth phenomena have not been reported for temperatures exceeding 150° C., despite temperature having a strong influence on the carbonate phases formed. Hänchen et al., “Precipitation in the Mg-Carbonate System—Effects of Temperature and CO2 Pressure,” Chemical Engingeering Science 63:1012-1028 (2008); Swanson et al., “Directed Precipitation of Hydrated and Anhydrous Magnesium Carbonates for Carbon Storage,” Physical Chemistry Chemical Physics 16:23440-23450 (2014); and Chen, J. and Xiang, L. “Controllable Synthesis of Calcium Carbonate Polymorphs at Different Temperatures,” Powder Technology 189:64-69 (2009), all of which are hereby incorporated by reference in their entirety. With this perspective, the two research issues that the present disclosure aims to address are: (i) what is the influence of similar surfaces (e.g., calcite, magnesite) and dissimilar surfaces (e.g., silica) on the structure and morphology of Ca- and Mg-carbonates at representative system conditions; and (ii) how to quantify the influence of pores within amorphous silica on the structure and morphology of precipitated Ca- and Mg-carbonates.

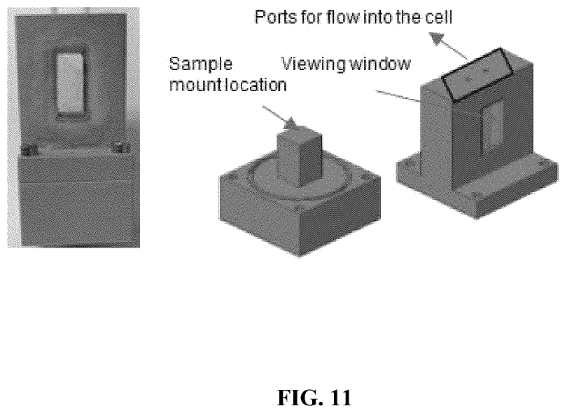

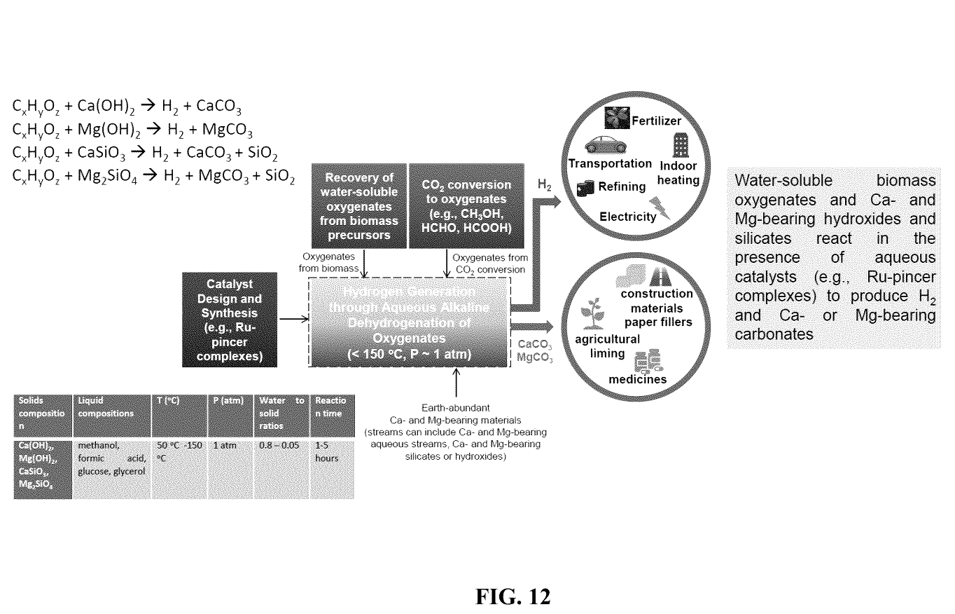

The initial set of experimental studies are designed to test the hypothesis that all other experimental conditions held constant, similar vs. dissimilar surfaces influence the type of carbonate phases formed in multiphase environments. The effect of seeding surfaces such as silica, stable carbonates such as calcite and magnesite on aiding the structure and morphology of precipitated carbonates will be inferred from Grazing Incidence—Wide Angle X-Ray and Small Angle X-Ray Scattering (“GI-WAXS/SAXS”) measurements at system conditions. Extensive experimental methodologies using GI-SAXS developed to distinguish between homogenous and heterogeneous nucleation and growth of carbonates at inorganic and organic interfaces at temperatures below 100° C. will be utilized. De Yoreo et al., “In Situ Investigations of Carbonate Nucleation on Mineral and Organic Surfaces,” Reviews in Mineralogy & Geochemistry 77:229-257 (2013); Li et al., “Interfacial Energies for Heterogeneous Nucleation of Calcium Carbonate on Mica and Quartz,” Environmental Science and Technology 48:5745-5753 (2014); Fernandez-Martinez et al., “In Situ Determination of Interfacial Energies Between Heterogeneously Nucleated CaCO₃ and Quartz Substrates: Thermodynamics of CO2 Mineral Trapping,” Environmental Science and Technology 47:102-109 (2012); and Radha et al., “Energetic and Structural Studies of Amorphous Ca₁₋ₓMgₓCO₃·nH₂O (0≤x≤1),” Geochimica et Cosmochimica Acta 90:83-95 (2012), all of which are hereby incorporated by reference in their entirety. The GI-SAXS cell shown in FIG. 11 will be adapted for measurements at system conditions of temperature (i.e., 150-250° C.), pCO₂ (10-30 atm), and fluidic environments of DI water, NaCl and NaHCO₃ (0.1-1.0 M). Specifically, the influence of ionic strength and temperature on the structure and morphology of carbonate-phases will be investigated. GI-SAXS/WAXS measurements are typically performed on highly polished sections of fused silica or stable thin films. While this approach will allow for isolation of the influence of chemistry of solid interfaces on nucleation and growth of carbonates, the influence of micro-, meso-, and macro-scale pores of amorphous silica on carbonate precipitation needs to determined using a different set of measurements.

In-operando USAXS/SAXS/WAXS measurements are proposed to delineate the influence of varying pore size of amorphous silica (e.g., CPG-75 and CPG-350 (Stack et al., “Pore-Size-Dependent Calcium Carbonate Precipitation Controlled by Surface Chemistry,” Environmental Science & Technology 48:6177-6183 (2014), which is hereby incorporated by reference in its entirety)) on the structure and morphology of precipitated Ca- and Mg-carbonates, at the system conditions noted above. These results will be contrasted with published data on calcium carbonate at room temperature. Stack et al., “Pore-Size-Dependent Calcium Carbonate Precipitation Controlled by Surface Chemistry,” Environmental Science & Technology 48:6177-6183 (2014), which is hereby incorporated by reference in its entirety. The influence of seeding surfaces (e.g., calcite, magnesite, amorphous silica), normalized for the surface area, on the structure and morphology of precipitated CaCO₃ and MgCO₃ at system conditions will be evaluated. TEM and SEM images will be used to determine the morphological features of the precipitates.

### Example 7—Harnessing Integrated Experimental Methodology for Redesigning Reaction Pathways

Basic science of overcoming kinetic barriers will occur through the targeted selection of chemical pathways.

Catalytic interventions in the gas and aqueous phase to enhance H₂ and carbonate formation. A scientific objective is to delineate the role of catalytic interventions in the gas and aqueous phases for the directed synthesis of H₂ and Ca- and Mg-carbonates.

The hypothesis behind coupling aqueous carbon mineralization and WGSR is that dynamic reactive separation of CO₂ will aid the enhanced H₂ production at lower temperatures in the range of 150-250° C. However, the likelihood that the gas phase conversion of CO and H₂O to CO₂ and H₂ may be rate limiting exists. If this step is rate limiting, then the subsequent carbon mineralization steps would be CO₂ limited. To overcome this challenge, the use of gas phase catalysts is proposed. Conventional catalysts for low temperature WGSR include copper/zinc oxide/alumina catalysts. Rhodes et al., “Water-Gas Shift Reaction: Finding the Mechanistic Boundary,” Catalysis Today 23:43-58 (1995), which is hereby incorporated by reference in its entirety. Pt-bearing catalysts are also known for their high activity for the WGSR at relatively low temperature. Ding et al., “Identification of Active Sites in CO Oxidation and Water-Gas Shift Over Supported Pt Catalysts,” Science 350:189-192 (2015), which is hereby incorporated by reference in its entirety. Extensive studies have been reported on the catalytic enhancement of WGSR. Pal et al., “Performance of Water Gas Shift Reaction Catalysts: A Review,” Renewable and Sustainable Energy Reviews 93:549-565 (2018); Levalley et al., “The Progress in Water Gas Shift and Steam Reforming Hydrogen Production Technologies—A Review,” International Journal of Hydrogen Energy 39: 16983-17000 (2014); and Bukur et al., “Role of Water-Gas-Shift Reaction in Fischer-Tropsch Synthesis on Iron Catalysts: A Review,” Catalysis Today 275:66-75 (2016), all of which are hereby incorporated by reference in their entirety. In the context of this study, the following issue should be addressed: by what extent is H₂ production enhanced by coupling interventionist catalytic routes in the gas phase with carbon mineralization.

Another consideration is the formation of undesirable side products such as formate (Elliott et al., “Aqueous Catalyst Systems for the Water-Gas Shift Reaction. 2. Mechanism of Basic Catalysis,” Industrial & Engineering Chemistry Product Research and Development 22:431-435 (1983) and Elliott et al., “Aqueous Catalyst Systems for the Water-Gas Shift Reaction. 1. Comparative Catalyst Studies,” Industrial & Engineering Chemistry Product Research and Developement 22:426-431 (1983), both of which are hereby incorporated by reference in their entirety) resulting from the reaction between hydroxide ions and CO. In aqueous WGSR, heterogeneous catalysts such as 5-10% palladium (Pd) on activated carbon (Onsager et al., “Hydrogen Production From Water and CO via Alkali Metal Formate Salts,” International Journal of Hydrogen Energy 21:883-885 (1996), which is hereby incorporated by reference in its entirety) and homogeneous catalysts such as metal carbonyls (Ungermann et al., “Homogeneous Catalysis of the Water Gas Shift Reaction by Ruthenium and Other Metal Carbonyls. Studies in Alkaline Solutions,” Journal of the American Chemical Society 101:5922-5929 (1979); King Jr et al., “Homogeneous Catalysis of the Water Gas Shift Reaction Using Iron Pentacarbonyl,” Journal of the American Chemical Society 102:1028-1032 (1980); Ishida et al., “Isolation of Intermediates in the Water Gas Shift Reactions Catalyzed by [Ru(bpy)₂(CO)Cl]⁺ and [Ru(bpy)₂(CO)₂]²⁺,” Organometallics 5:724-730 (1986); and Laine, Richard M. and Crawford, Edward J. “Homogeneous Catalysis of the Water-Gas Shift Reaction,” Journal of Molecular Catalysis 44:357-387 (1988), all of which are hereby incorporated by reference in their entirety) were effective in decomposing potassium formate in water to yield H₂. Onsager et al., “Hydrogen Production From Water and CO via Alkali Metal Formate Salts,” International Journal of Hydrogen Energy 21:883-885 (1996), which is hereby incorporated by reference in its entirety. In the context of this study, the potential formation of Mg- or Ca-formate needs to be circumvented through catalytic interventions in the aqueous phase. In the context of this study, the following question should be addressed: By what extent is H₂ and carbonate production enhanced with interventionist catalytic routes in the aqueous phase?

To test this hypothesis, the base case will be evaluated for the directed synthesis of H₂ and Ca- and Mg-carbonates, starting from Mg- and Ca-silicates and hydroxides as the sorbents in the absence of a catalyst. Then the influence of catalyst such as Pt, Cu, and Zn on Al₂O₃ support with concentrations ranging from 0.5-1.0 wt % will be evaluated. These lab-scale experiments will be performed holding other factors such as the aqueous phase composition and slurry composition constant to delineate the influence of the catalyst. Changes in the gas phase compositions will be monitored using a micro-gas chromatograph. In-operando X-Ray Absorption Fine Structure (EXAFS) measurements are proposed to determine the bonding mechanisms from the changes in the number of atoms in the first few shells of the absorbing atom. Mansour et al., “X-Ray Absorption Studies of Some Platinum Oxides,” Journal of Physical Chemistry 88:1778-1781 (1984), which is hereby incorporated by reference in its entirety. The influence of heterogeneous catalysts such as 5-10% palladium (Pd) on activated carbon (Onsager et al., “Hydrogen Production From Water and CO via Alkali Metal Formate Salts,” International Journal of Hydrogen Energy 21:883-885 (1996), which is hereby incorporated by reference in its entirety) on the decomposition of Mg- or Ca-formate in the aqueous phase will be determined at the system conditions. Since the stability and fate of homogeneous catalysts such as ruthenium and iron carbonyls (Ungermann et al., “Homogeneous Catalysis of the Water Gas Shift Reaction by Ruthenium and Other Metal Carbonyls. Studies in Alkaline Solutions,” Journal of the American Chemical Society 101:5922-5929 (1979); King Jr et al., “Homogeneous Catalysis of the Water Gas Shift Reaction Using Iron Pentacarbonyl,” Journal of the American Chemical Society 102:1028-1032 (1980); Ishida et al., “Isolation of Intermediates in the Water Gas Shift Reactions Catalyzed by [Ru(bpy)₂(CO)Cl]⁺ and [Ru(bpy)₂(CO)₂]2+,” Organometallics 5:724-730 (1986); and Laine et al., “Homogeneous Catalysis of the Water-Gas Shift Reaction,” Journal of Molecular Catalysis 44:357-387 (1988), all of which are hereby incorporated by reference in their entirety) is uncertain at system conditions, they will not be considered. All other factors such as the gas phase compositions, slurry compositions, and temperature will be held constant. Ion chromatography measurements will be performed to evaluate the changes in the organic content in the fluid phase. NMR measurements are proposed to provide detailed insights into the aqueous phase transformations.

### Example 8—Design an Integrated Reaction Network for the Directed Synthesis of H₂ and Ca- and Mg-Carbonates

A scientific objective is to construct a coupled reaction network by achieving kinetic controls over potential reaction-limiting pathways.

The research efforts described in the previous research areas are motivated towards achieving kinetic controls on various rate limiting steps including the dissolution of Ca- and Mg-bearing silicates (described herein), directed synthesis of stable Ca- and Mg-carbonates (described herein), and catalytic interventions to enhance the WGSR and limit the formation of undesired products (described herein). The hypothesis is that significant enhancement in the directed synthesis of H₂ and Ca- and Mg-carbonates can be achieved by (i) using seeding surfaces to aid the formation of stable carbonates, (ii) buffering pH in the range of 7-8 to overcome silica passivation induced controls on the dissolution of Ca and Mg-species, and (iii) through catalytic interventions in the gas and aqueous phase to enhance H₂ synthesis and limit the formation of undesired Mg- and Ca-bearing byproducts. The outcome of these investigations is the enhancement in the kinetics and yields of H₂ and Ca- and Mg-carbonates using scientifically informed approaches to accelerate every reaction of interest. While there is interest in using Fe transformations in olivine for H₂ production (Miller et al., “Low Temperature Hydrogen Production During Experimental Hydration of Partially-Serpentinized Dunite,” Geochimica et Cosmochimica Acta 209:161-183 (2017), which is hereby incorporated by reference in its entirety), those studies are beyond the scope of the proposed effort.

The development of a multiphase reaction environment with controls on gas and slurry phase reactions is proposed. Catalysts identified to accelerate the WGSR will be used in the gas phase. Aqueous phase environments will be developed to maintain pH in the range of 7-8 in the presence of an active heterogenous catalyst to limit formate formation. High surface area seeding surfaces of calcite or magnesite will be used for the targeted synthesis of stable carbonate phases. Laboratory-scale experiments will provide an initial basis for evaluating the enhancement in reactivities achieved. Structural and microstructural changes in the solids arising from the targeted integration of the reactions of interest will be evaluated using in-operando USAXS/SAXS/WAXS, total scattering, and X-Ray Microtomography measurements. The reaction environments will be adapted to include the catalyst bed in the gas phase. This approach will allow for the development of structure-reactivity relationships starting with Ca- and Mg-silicates as the precursors in “realistic” environments.

### Example 9—Synthesis of MgO and Mg₂SiO₄

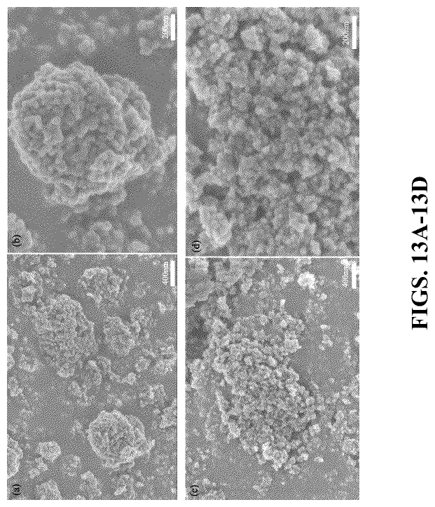

Synthesis of MgO and Mg₂SiO₄. To synthesize MgO nanoparticles, 26.69 g of magnesium acetate was first dissolved in 75 ml of absolute ethanol. The pH of the solution is adjusted to 5 by using 1 M oxalic acid. The solution is stirred at room temperature until a thick white gel is formed. The gel is placed at room temperature overnight and dried at 100° C. for 24 hours. The dried sample is ground with mortar and pestle to produce a powder precursor. The precursor is annealed at 950° C. for 4 hours. Mastuli et al., “Growth Mechanisms of MgO Nanocrystals via a Sol-Gel Synthesis Using Different Complexing Agents,” Nanoscale Research Letters 9:1-9 (2014), which is hereby incorporated by reference in its entirety. FIGS. 13A and 13B represent SEM images of MgO nanoparticles.

To synthesize Mg₂SiO₄ nanoparticles, 4.25 g of tetraethyl orthosilicate (TEOS) are dissolved in 150 ml of 1 M HNO₃. 10.25 g of magnesium nitrate hexahydrate are added to the solution and stirred for 2 hours under room temperature. The stirred solution is dried at 65° C. for 24 hours to produce a highly viscous gel. The gel is calcined at 800° C. for 30 minutes in air at a heating rate of 10° C./min. Sanosh et al., “Sol-Gel Synthesis of Forsterite Nanopowders With Narrow Particle Size Distribution,” Journal of Alloys and Compounds 495:113-115 (2010), which is hereby incorporated by reference in its entirety.

### Example 10—Effectiveness of MgO and Mg₂SiO₄ in Aiding Carbon Mineralization Behavior

The series of reactions that demonstrate the thermodynamic feasibility of the integrated WGSR are shown below.

$$2 CO + 2 {H}_{2} O = 2 {CO}_{2} + 2 {H}_{2} ( ΔH = - 82.4 kJ / mol ) \qquad ( 1 )$$

$${Mg}_{2} {SiO}_{4} + 2 {H}_{2} O = 2 {Mg ( OH )}_{2} + {SiO}_{2} ( ΔH = - 99.7 kJ / mol ) \qquad ( 2 )$$

$$2 {Mg ( OH )}_{2} = 2 MgO + 2 {H}_{2} O ( ΔH = 162.4 kJ / mol ) \qquad ( 3 )$$

$$2 MgO + 2 {CO}_{2} = 2 {MgCO}_{3} ( ΔH = - 235.6 kJ / mol ) \qquad ( 4 )$$

$${Mg}_{2} {SiO}_{4} + 2 CO + 2 {H}_{2} O = 2 {MgCO}_{3} + {SiO}_{2} + 2 {H}_{2} ( ΔH = - 255.3 kJ / mol ) \qquad ( 5 )$$

The experiments to determine the extents of carbonate formation were performed at 200° C., pCO₂ of 200 atm, stirring rates of 300 rpm and solid to fluid ratios of 3:17. The extents of carbonate formation were determined from the following relationship where TGA represents the weight loss and R_{CO2} is the stoichiometric mass of the unreacted material that can store a unit of CO₂ as carbonate:

$${Y}_{CO 2} = {R}_{CO 2} \times ( \frac{TGA}{100 - TGA} ) \times 100 \% .$$

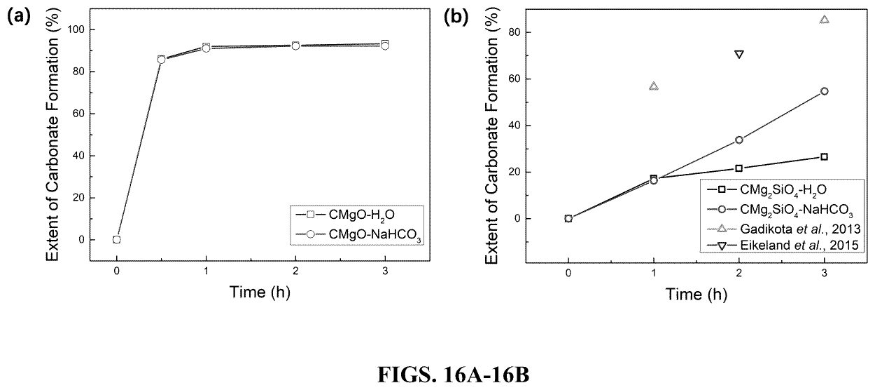

The carbonation kinetics of MgO-based samples and Mg₂SiO₄-based samples are shown in FIGS. 16A-16D. Within 30 minutes of the reaction, the extents of carbonate formation were 86.073% and 85.645% for the CMgO—H₂O sample (reacted in water) and CMgO—NaHCO₃ sample (reacted in 1.0 M NaHCO₃), respectively. For a reaction time of 3 hours, the extents of carbonate formation were 94.21% for CMgO—H₂O sample (reacted in water) and 97.27% for CMgO—NaHCO₃ sample (reacted in 1.0 M NaHCO₃), respectively. These data suggest that the chemical transformations are fast in the first 30 minutes and by 3 hours, nearly all the MgO was converted to MgCO₃ in these two samples. Furthermore, changing the aqueous phase from DI-water to 1M NaHCO₃ solution does not have a significant influence on the kinetics of MgO conversion to MgCO₃ (FIG. 16A).

The influence of NaHCO₃ on the conversion of Mg₂SiO₄ to MgCO₃ was more significant. The extents of carbonate formation in Mg₂SiO₄ samples in DI water and 1.0 M NaHCO₃ were 26.6% for DI water and 54.7% for 1M sodium bicarbonate solution, respectively, for a reaction time of 3 hours (FIG. 16B). The relatively high extent of carbonation of the CMg₂SiO₄—NaHCO₃ sample results from the influence of NaHCO₃ as a pH buffer and carbon carrier, which enhances magnesite precipitation. The extent of carbonate formation of 54.7% is lower than the conversion of 85.3% reported by Gadikota and co-workers (see, e.g., Gadikota et al., “Enhanced Water-Gas-Shift Reaction and in-situ Carbon Fixation in the Presence of Mg(OH)₂ Slurry in a High Pressure Aqueous System,” In The 12th International Conference on Gas-Liquid and Gas-Liquid-Solid Reactor Engineering GLS 12 (2015); Gadikota et al., “Chemical and Morphological Changes During Olivine Carbonation for CO₂ Storage in the Presence of NaCl and NaHCO₃,” Physical Chemistry Chemical Physics 16:4679-4693 (2014); Gadikota et al., “Microstructural and Structural Characterization of Materials for CO₂ Storage Using Multi-Scale Scattering Methods In Materials and Processes for CO₂ Capture, Conversion, and Sequestration,” Wiley Books Ch. 7:296-318, eds. Lan, L.; Wong-Ng, K., Huang, K., Cook, L. P. (2018); Gadikota et al., “Experimental Design and Data Analysis for Accurate Estimation of Reaction Kinetics and Conversion for Carbon Mineralization,” Industrial Engineering Chemistry Research 53:6664-6676 (2014); Gadikota et al., “In Situ Angstrom-to-Micrometer Characterization of the Structural and Microstructural Changes in Kaolinite on Heating Using Ultrasmall-Angle, Small-Angle, and Wide-Angle X-ray Scattering (USAXS/SAXS/WAXS),” Industrial Engineering Chemistry Research 56 (2017); Liu, Meishen and Gadikota, Greeshma “Probing the Influence of Thermally Induced Structural Changes on the Microstructural Evolution in Shale using Multiscale X-ray Scattering Measurements,” Energy and Fuels 32:8193-8201 (2018); Gadikota et al., “Towards Understanding the Microstructural and Structural Changes in Natural Hierarchical Materials for Energy Recovery: In-Operando Multi-Scale X-ray Scattering Characterization of Na- and Ca-montmorillonite on Heating to 1150° C.,” Fuel 196:195-209 (2017); Gadikota, Greeshma “Connecting the Morphological and Crystal Structural Changes During the Conversion of Lithium Hydroxide Monohydrate to Lithium Carbonate Using Multi-Scale X-ray Scattering Measurements,” Minerals 7 (2017); and Gadikota, Greeshma and Park, Ah-Hyung Alissa “Accelerated Carbonation of Ca- and Mg-Bearing Minerals and Industrial Wastes Using CO₂,” In Carbon Dioxide Utilization: Closing the Carbon Cycle 115-137 (2015), all of which are hereby incorporated by reference in their entirety) for particles with a mean size of 21.4 μm and 71% reported by Eikeland and co-workers (Eikeland et al., “Optimized Carbonation of Magnesium Silicate Mineral for CO₂ Storage,” ACS Applied Materials & Interfaces 7:5258-5264 (2015), which is hereby incorporated by reference in its entirety) for a reaction time of 2 hours and particle sizes <10 μm. The significant difference between the reported results is the partial pressure of CO₂. The CO₂ partial pressures used in the this study, Gadikota and co-workers and Eikeland and co-workers (Eikeland et al., “Optimized Carbonation of Magnesium Silicate Mineral for CO₂ Storage,” ACS Applied Materials & Interfaces 7:5258-5264 (2015), which is hereby incorporated by reference in its entirety) were 20 atm, 139 atm and 98.69 atm, respectively. Thus, the hypothesis is that the availability of CO2 is the limiting factor in these reactions.

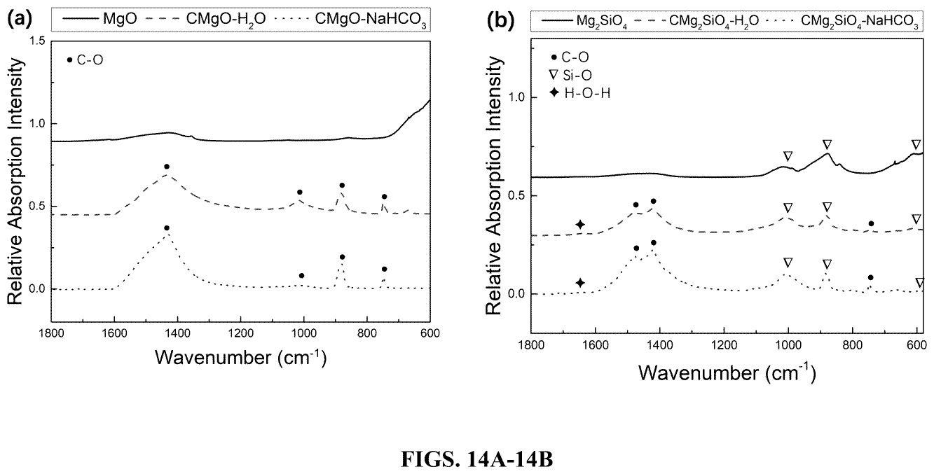

Chemical and Morphological Characteristics of Carbonate-Bearing Materials—The FTIR spectra of the unreacted and carbonated samples are shown in FIGS. 14A-14B. As shown in FIG. 14A, the spectra at approximately 1450 cm⁻¹, 1010 cm⁻¹, 890 cm⁻¹, and 750 cm⁻¹ correspond to the characteristic vibration of CO₃²⁻, and these peaks appeared in both CMgO—H₂O and CMgO—NaHCO₃ samples. Thus, magnesium carbonate is present in both samples. Further, the FTIR analyses of Mg₂SiO₄ samples showed spectra at around 1010 cm⁻¹ and 600 cm⁻¹ which correspond to the bending vibrations of the Si—O bond. The spectra at about 900 cm⁻¹ corresponds to the stretching vibrations of the Si—O bond (FIG. 14B). The absence of CO₃²⁻ vibrations at about 1010 cm⁻¹ and 890 cm⁻¹ is attributed to the overlap with the Si—O bond vibrations in the same position. Moreover, the characteristic CO₃²⁻ peak at about 1450 cm⁻¹ splits in both of the CMg₂SiO₄ samples, which is indicative of existence of bicarbonate peaks. These observations suggest that the bicarbonate species exist in the form of hydromagnesite (Mg₅(CO₃)₄(OH)₂·4H₂O) and the H—O—H vibration at about 1650 cm⁻¹ indicates the presence of hydrates in these samples.

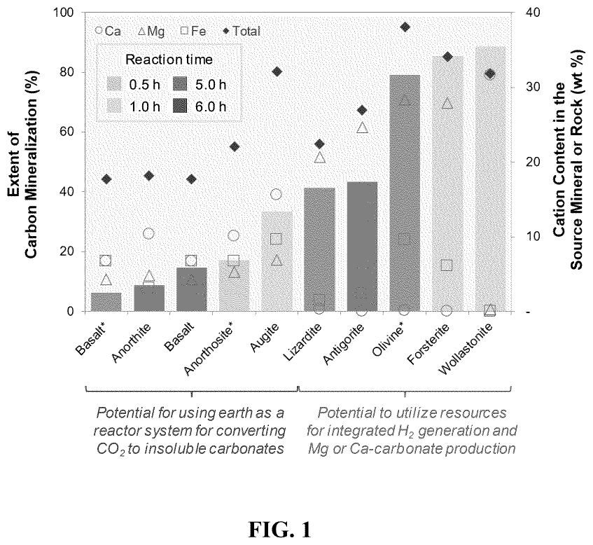

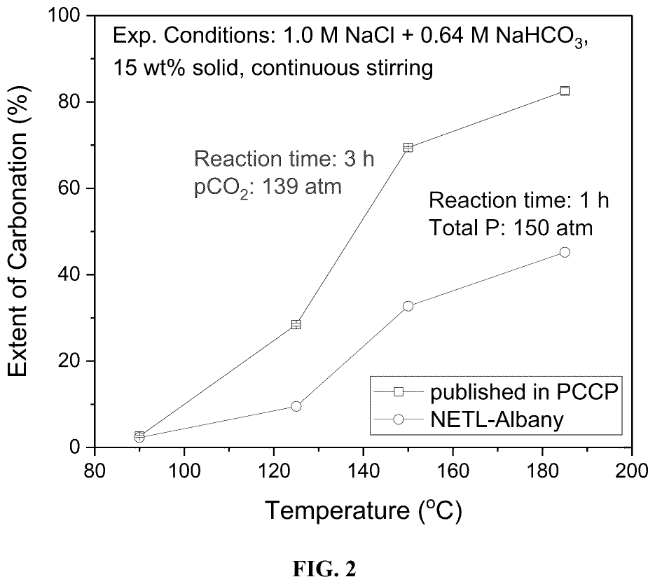

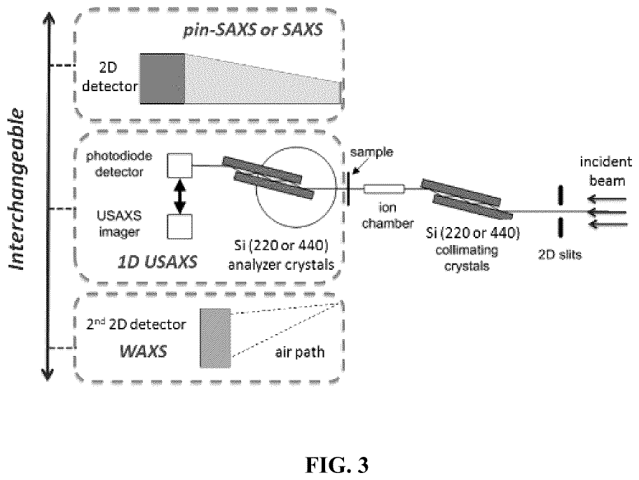

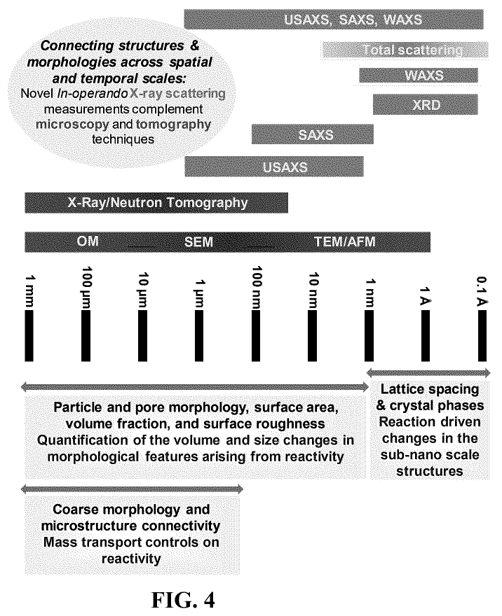

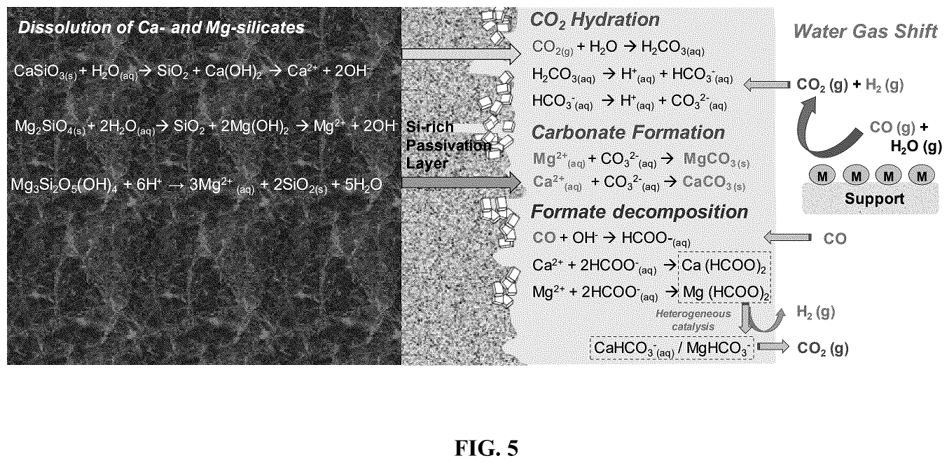

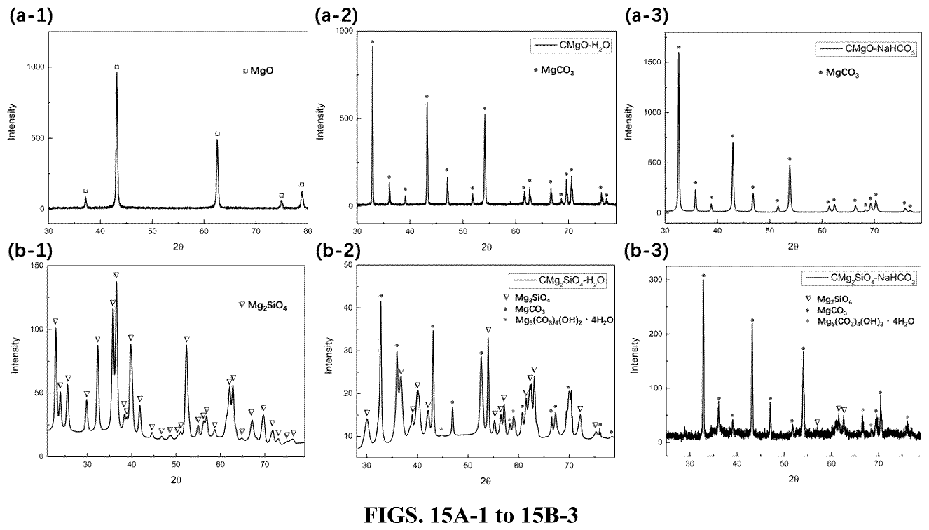

To confirm the phases present, XRD analyses were performed. Analyses of the unreacted samples showed that no crystalline phases other than MgO (FIG. 15A-1) and Mg₂SiO₄ (FIG. 15B-1) were present in the unreacted samples. Magnesite (MgCO₃) was the only phase clearly identified in the reacted MgO samples (FIGS. 15A-2 and 15A-3). On the contrary, magnesite and hydromagnesite phases are co-present in the magnesium silicates reacted in water and NaHCO₃ (FIGS. 15B-2 and 15B-3). These data are consistent with the observations from the FTIR spectra in FIGS. 14A-14B.

In this example, it was demonstrated that MgO and Mg₂SiO₄ have varying reactivities with CO₂ at conditions representative of the water-gas-shift reaction. Nearly complete conversion of MgO to magnesite is noted in 3 hours of reaction time at 200° C. and pCO₂ of 20 atm. In comparison, the extent of Mg₂SiO₄ conversion to magnesite and hydromagnesite was 57% in 1.0 M NaHCO₃. The formation of these carbonate phases was confirmed using FTIR, XRD, and SEM images.

TABLE 4
Notation of the carbonate-bearing materials

| Reactant | DI Water | 1M NaHCO₃ Solution |
|---|---|---|
| MgO | CMgO—H₂O | CMgO—NaHCO₃ |
| Mg₂SiO₄ | CMg₂SiO₄—H₂O | CMg₂SiO₄—NaHCO₃ |

### Example 11—Synthesis and Carbon Mineralization of CaO, Ca(OH)₂ and CaSiO₃

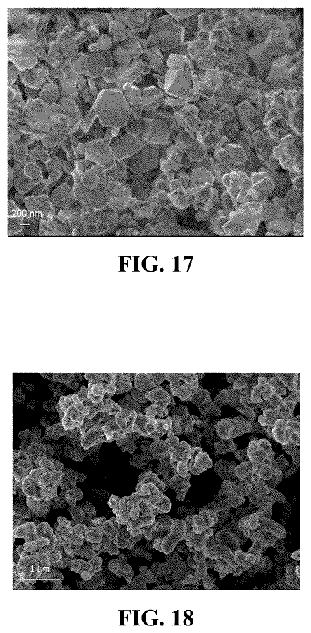

Synthesis of CaO and CaSiO₃. Ca(OH)₂ particles with sizes in the range of 100 nm-400 nm and hexagonal morphology have been synthesized by adding 0.6 M NaOH dropwise to 0.3 M CaCl₂ solution at 90° C. Ca(OH)₂ particles with sizes in the range of 20 nm-300 nm are prepared by adding a surfactant agent, Triton X-100 to the solution of 0.6 M NaOH and 0.3 M CaCl₂ solution at 90° C. and mixed. The resulting suspensions in both cases, are dried in a vacuum oven to obtain the nanoparticles. Taglieri et al., “Synthesis, Textural and Structural Properties of Calcium Hydroxide Nanoparticles in Hydro-Alcoholic Suspension,” Advances in Materials Physics and Chemistry 4:50-59 (2014), which is hereby incorporated by reference in its entirety. FIG. 17 represents SEM image of the morphology of Ca(OH)₂.

CaO nanopowders are prepared by initially mixing 0.5 M Ca(NO₃)₂ and PVP solutions at room temperature. 1 M NaHCO₃ followed by 1 M NaOH is added drop-wise while constantly stirring the mixture. The resulting gel is vigorously mixed and Ca(OH)₂ nanopowders are allowed to precipitate. CaO nanopowders with sizes in the range of 100 nm are obtained on the calcination of the Ca(OH)₂ nanopowders at 350° C. Prabhavathi et al., “Sol-Gel Method of Synthesis of MgO And CaO Nano Particles and their Characterization,” World Journal of Pharmaceutical Research 3:362-370 (2014), which is hereby incorporated by reference in its entirety. FIG. 18 represents SEM image of the morphology of CaO.

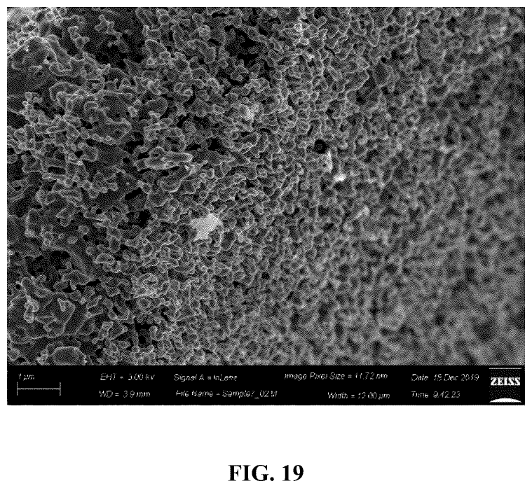

CaSiO₃ powders with particle sizes in the range of 50-60 nm are produced via the sol-gel processing route. Calcium nitrate tetrahydrate (Ca(NO₃)₂·4H₂O) dissolved in deionized water and ethanol bearing tetraethyl orthosilicate (TEOS) are mixed and stirred for 2 hours at room temperature, with the molar ratio of calcium nitrate tetrahydrate to tetraethyl orthosilicate being 1:1. Reagents such as HNO₃, CH₃COOH, H₂O and PEG2000 are used and the resulting green gel is aged at 60° C. to produce a colorless solid. Drying the gel at 90° C. for 24 hours and calcining it at 1000° C. for 1 hour at a heating rate of 5° C. min⁻¹ results in CaSiO₃ powders with particle sizes in the range of 50-60 nm. Wang et al., “Synthesis and Microwave Dielectric Properties of CaSiO₃ Nanopowder by the Sol-Gel Process,” Ceramics International 34:1405-1408 (2008), which is hereby incorporated by reference in its entirety. FIG. 19 represents SEM image of the morphology of CaSiO₃.

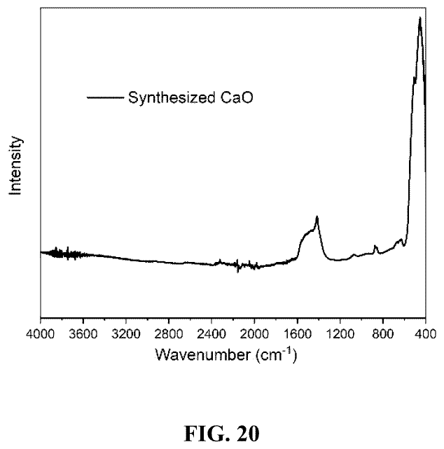

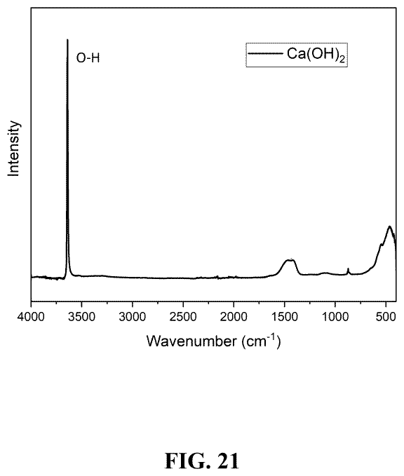

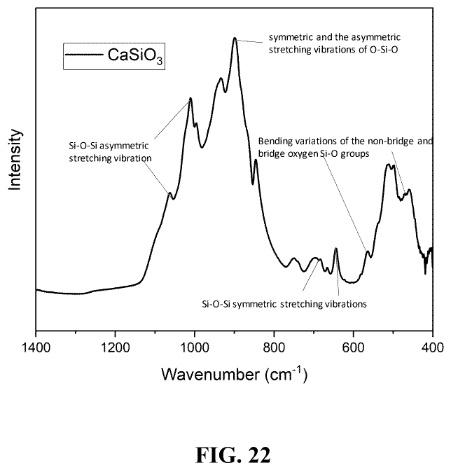

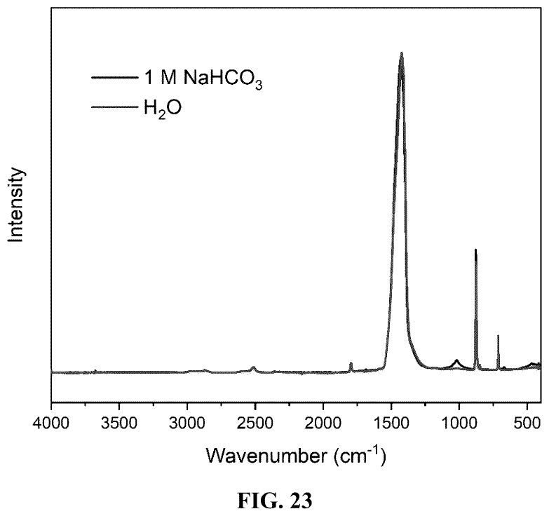

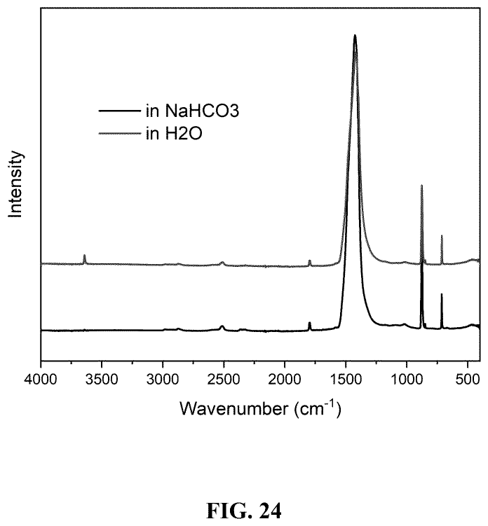

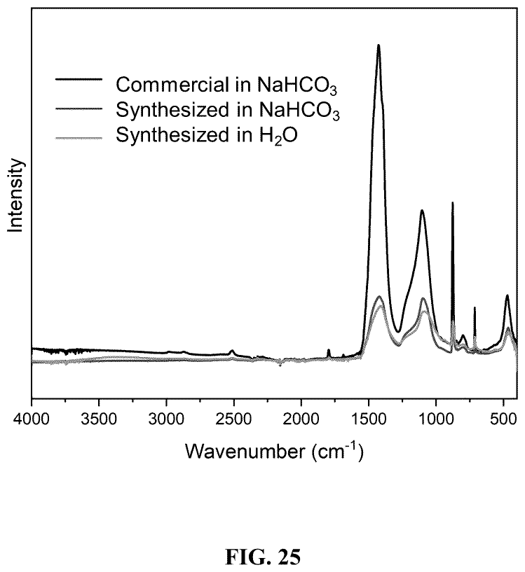

Carbon mineralization of CaO, Ca(OH)₂ and CaSiO₃. Experiments were performed at pCO₂ of 20 bar and a temperature of 200° C. for 3 hours in aqueous environments of deionized water and 1.0 M NaHCO₃ with a slurry composed of 15 wt % solid. The solids are CaO, Ca(OH)₂ and CaSiO₃. The experimental condition of CO₂ partial pressure and temperature were chosen to represent integration with the Water-Gas-Shift (WGS) reaction. FIGS. 20, 21, and 22 represent the ATR FT-IR spectra of synthesized CaO, Ca(OH)₂ and CaSiO₃ nanoparticles. FIGS. 23, 24, and 25 represent the ATR FT-IR spectra of carbonate-bearing CaO, Ca(OH)₂ and CaSiO₃ nanoparticles.

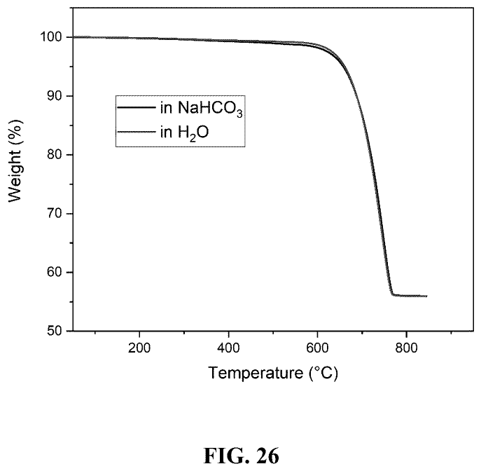

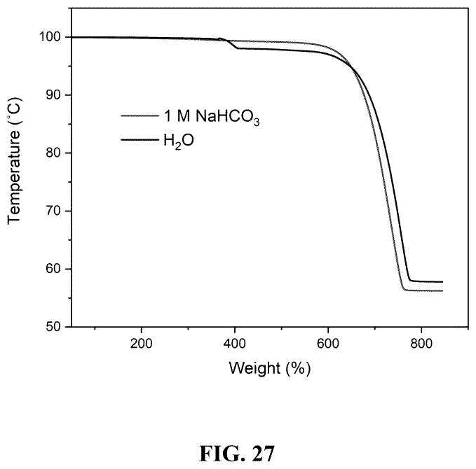

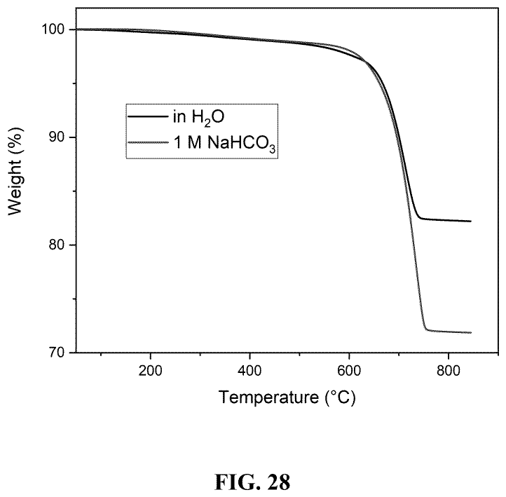

The extents of carbon mineralization starting with CaO in water and 1.0 M NaHCO₃ are 94% and 95%, respectively (as determined from the TGA data shown in FIG. 26). The extents of carbon mineralization starting with Ca(OH)₂ in water and 1.0 M NaHCO₃ are 86% and 94%, respectively (as determined from the TGA data shown in FIG. 27). The extents of carbon mineralization starting with CaSiO₃ in water and 1.0 M NaHCO₃ are 48% and 94%, respectively (as determined from the TGA data shown in FIG. 28).

### Example 12—Evidence of Enhanced H₂ Formation with CO2 Removal

Experiments were performed to demonstrate the feasibility of enhanced H₂ formation and CO₂ removal by integration with an alkaline sorbent.

Reaction without sorbent: CO+H₂O→CO₂+H₂

Reactions with sorbent:

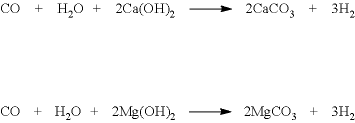 [SMILES: "CO" ; O ; "CO" ; O]

The experimental conditions are 10 atm CO, 200° C., 3 hours, stirring rate of 300 rpm, 17 ml H₂O, 0.15 g of Ni/Al₂O₃ catalyst (in the gas phase), 3 g Ca(OH)₂. The reaction time is 3 hours. The gases of interest, H₂ and CO₂ are detected using gas chromatography. The table below represents the intensities of the gases determined using gas chromatography. Higher intensities directly correspond to higher gas concentrations.

Table 5 shows intensities of gases determined after 3 hours of reaction time in the water gas shift reaction with and without calcium hydroxide.

TABLE 5
Gas Intensity After 3 Hour of Reaction Time in WGSR.

| | Water Gas Shift | Enhanced Water Gas |
|---|---|---|
| | Reaction - | Shift Reaction - |
| | No Ca(OH)₂ in | with Ca(OH)₂ in |
| | deionized water | deionized water |
| Hydrogen | 7900 | 25573.5 |
| Carbon dioxide | 1882 | 1242.5 |

Higher intensity of H₂ and lower intensity of CO₂ is noted in the enhanced water gas shift reaction with Ca(OH)₂ as the sorbent.

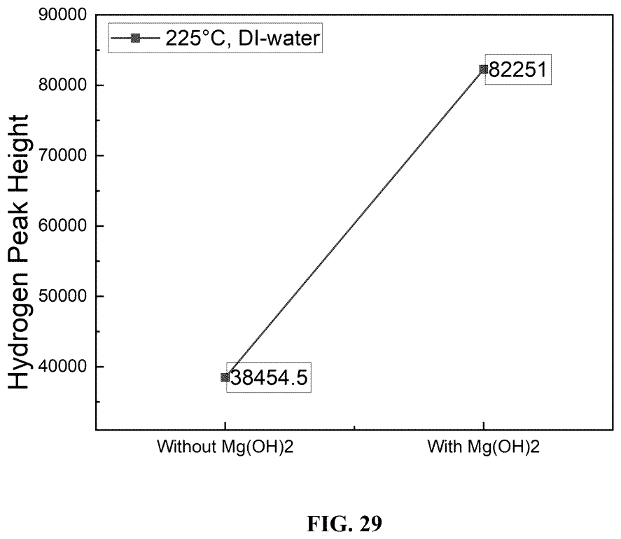

A significant enhancement in the H₂ yield was noted when Mg(OH)₂ was used as the sorbent. These results are noted in FIG. 29. The experimental conditions are 10 atm CO, 225° C., 3 hours, stirring rate of 300 rpm, 17 ml H₂O, 0.15 g of Ni/Al₂O₃ catalyst (in the gas phase), 3 g Mg(OH)₂.

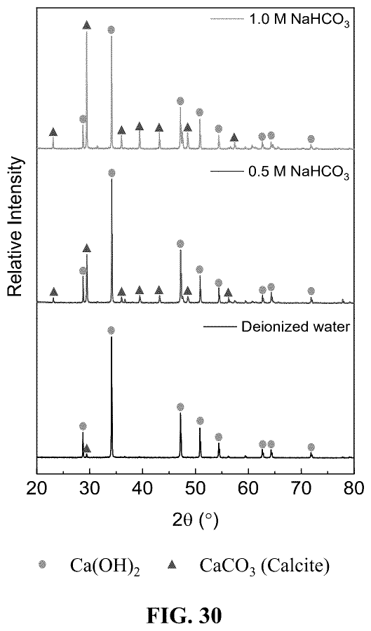

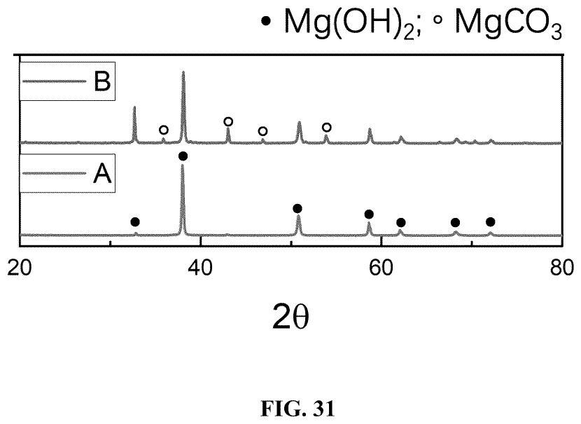

Calcium carbonate formation is evident from FIG. 30. MgCO₃ formation is evident in FIG. 31.

### Example 13—Thermodynamic Basis for Enhanced Hydrogen Production with Carbon Mineralization Integrated with the Water Gas Shift Reaction

Calcium Based Materials for Enhanced Water Gas Shift Reaction Motivation—Water gas shift reaction (WGSR) is the conversion of monoxide and steam to form carbon dioxide and hydrogen. Thermodynamically, it is a reversible and exothermic reaction, which indicates that temperature can have an influence on the conversion process of this reaction. According to Le Chatelier's principle, as temperature increases, the forward exothermic reaction is inhibited and this results in a lower conversion extent. Further, changes in the chemical concentrations shift the reaction towards the side which can reduce this change. The novelty of this approach lies in actively removing CO₂ to produce solid carbonates which pushes the thermodynamic equilibrium towards higher hydrogen (H₂) yields. Thus, calcium and magnesium-based oxides, hydroxides and silicates can be used to actively remove CO₂ co-produced with H₂ to produce calcium or magnesium carbonates. The combined hydrogen generation and CO₂ removal via carbonate formation is known as the enhanced water gas shift reaction (EWGSR) system. Here, the thermodynamic mechanisms of the pure WGSR and enhanced WGSR are calculated and compared. This is an accessible approach to evaluate the relationship of conversion extent and temperature and determine the enhancement effect of the calcium-based materials in these reactions.

Thermodynamic study importance on reaction and its relationship with this study—The main goal in this study is to enhance hydrogen (H₂) production in water gas shift reaction process under certain conditions to move the reaction towards H₂ generation in the forward reaction. According to the La Chatelier's principle, one accessible approach to enhance the hydrogen (H₂) yield is to remove the by product, carbon dioxide (CO₂) during the reaction process. Thus, calcium-based materials like calcium oxide, calcium hydroxide and calcium silicate are used in these processes to achieve this goal based on the carbonation reactions. However, these reactions are operated at rather different optimal temperatures compared with that of water gas shift reactions. Thus, a thorough thermodynamic model is essential for determining the best operating temperature conditions for the combined reactions.

Equilibrium constant (K_{eq}) calculation based on reaction equation—Generally, reactions can be expressed as following equation:

$$aA + bB + cC + dD \qquad ( 1 )$$

where A and B are reactants and C and D are products. In addition, a, b, c, d are coefficients of the corresponding materials.

Equilibrium constant K_{eq} expressed as amounts of products divided by amounts of reactants, in which each amount is raised to the power of its coefficient:

$${K}_{eq} = \frac{{[ C ]}^{c} \times {[ D ]}^{d}}{{[ A ]}^{a} \times {[ B ]}^{b}} \qquad ( 2 )$$

where [n] means the concentration of corresponding material n. It should be noted that solid materials concentration is always assumed to be 1 and can be neglected in calculation process. The equilibrium constant is always a function of temperature, known as K_{eq}=ƒ(T). This relationship helps link extent of conversion (X) and temperature (T).

Water-gas shift reaction (WGSR)—Here, calculations of WGSR are represented with the addition of the Ca- and Mg-bearing oxides, hydroxides, and silicates. The reaction below represents the WGSR.

$$CO ( g ) + {H}_{2} O ( g ) = {CO}_{2} ( g ) + {H}_{2} ( g ) \qquad ( 3 )$$

Assuming that the initial partial pressure of CO and H₂O is the same, and the conversion extent at equilibrium is X, the following information is obtained:

| | CO | H₂O | CO₂ | H₂ |
|---|---|---|---|---|
| Initial | 1 | 1 | 0 | 0 |
| Conversion | X | X | X | X |
| final | 1 − X | 1 − X | X | X |

At equilibrium, the K_{eq} expression is calculated as equation (4) and X is expressed in K_{eq} by equation (5):

$${K}_{eq} = \frac{{X}^{2}}{{( 1 - X )}^{2}} \qquad ( 4 )$$

$$X = \frac{\sqrt{{K}_{eq}}}{1 + \sqrt{{K}_{eq}}} \qquad ( 5 )$$

According to previous literatures, K_{eq} of WGSR can be expressed by empirical equations (Moe, J. M., “Design of Water-Gas Shift Reactors,” Chem. Eng. Prog. 58:3 (1962) and Callaghan, C. A., “Kinetics and Catalysis of the Water-Gas-Shift Reaction: A Microkinetic and Graph Theoretic Approach,” Dep. Chem. Eng. Worcester Polytechnic Institute, Dissertation (2006), both of which are hereby incorporated by reference in their entirety):

$${K}_{eq} = exp ( \frac{4577.8}{T} - 4.33 ) for T less than 500 °C . \qquad ( 6 )$$

$${K}_{eq} = {10}^{- 2.4198 + 0.0003855 \times T + \frac{2180.6}{T}} for T range 600 - 2000 K \qquad ( 7 )$$

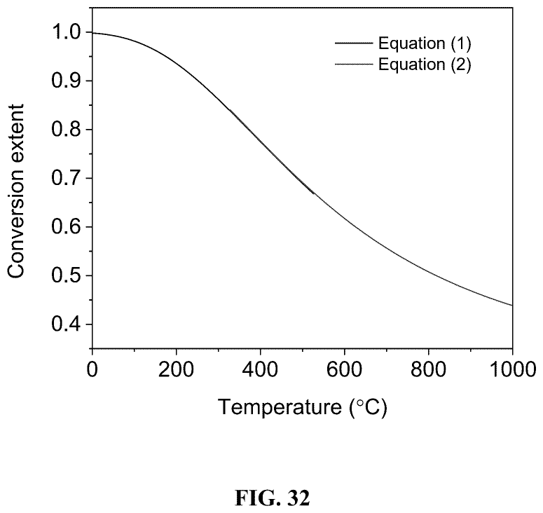

Thus, the relation of X and T can be summarized in FIG. 32.

Enhanced WGSR with Calcium Oxide (CaO)—Carbonation of calcium oxide can be expressed as equation (8):

$$CaO ( s ) + {CO}_{2} ( g ) = {CaCO}_{3} ( s ) \qquad ( 8 )$$

Equilibrium constant of equation (8) can be calculated by taking the reciprocal of equilibrium constant of corresponding calcination reaction:

$${CaCO}_{3} ( s ) = CaO ( s ) + {CO}_{2} ( g ) \qquad ( 9 )$$

$${K}_{eq} = 4.137 \times {10}^{12} \times exp ( - \frac{20474}{T} ) ,$$

obtained from thermochemical data (Barin, I., THERMOCHEMICAL DATA OF PURE SUBSTANCES (Weinheim: VCH, 1989), which is hereby incorporated by reference in its entirety).

Thus,

$${K}_{eq}^{′}$$

of equation (8) equals

$$\frac{1}{{K}_{eq}}$$

of equation (9).
Combining the carbonate formation reaction with water gas shift reaction, the following is produced:

$$CaO ( s ) + CO ( g ) + {H}_{2} O ( g ) = {CaCO}_{3} ( s ) + {H}_{2} ( g ) \qquad ( 10 )$$

Equilibrium constant K equals

$${K}_{e q}^{′} ( 6 ) \times {K}_{e q} ( 1 ) = \frac{{K}_{e q} ( 1 )}{{K}_{e q} ( 7 )} .$$

Assuming that (i) the initial partial pressure of CO and H₂O is the same, (ii) there is sufficient CaO for reaction, and (iii) the conversion extent at equilibrium is X, the following relationships are obtained:

| | CaO | CO | H₂O | CaCO₃ | H₂ |
|---|---|---|---|---|---|
| Initial | — | 1 | 1 | 0 | 0 |
| Conversion | — | X | X | X | X |
| Final | — | 1 − X | 1 − X | X | X |

$${K}_{e q} = \frac{X}{{( 1 - X )}^{2}} \qquad ( 11 )$$

$$X = \frac{2 \times {K}_{e q} + 1 - \sqrt{( 4 \times {K}_{e q} + 1 )}}{2 \times {K}_{e q}} \qquad ( 12 )$$

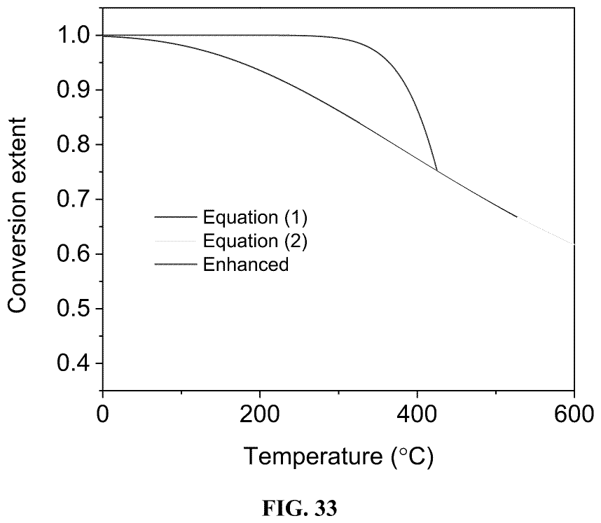

Thus, relationship with conversion and temperature can be summarized in FIG. 33.

Enhanced WGSR with Calcium hydroxide (Ca(OH)₂)—Carbonation of calcium hydroxide at high temperature can be expressed as equation (13):

$${Ca ( OH )}_{2} ( s ) + {CO}_{2} ( g ) = {CaCO}_{3} ( s ) + {H}_{2} O ( g ) \qquad ( 13 )$$

Equation (11) can be considered as the summation of two equations: equation (8) and equation (14):

$${Ca ( OH )}_{2} ( s ) = CaO ( s ) + {H}_{2} O ( g ) \qquad ( 14 )$$

According to previous literature (Barin, I., THERMOCHEMICAL DATA OF PURE SUBSTANCES (Weinheim: VCH, 1989), which is hereby incorporated by reference in its entirety), K_{eq} of this equation equals

$$2.3 \times 1 {0}^{8} \times exp ( - \frac{11607}{T} ) .$$

Thus, K_{eq}(13)=K_{eq}(8)×K_{eq}(14)
Combining with water gas shift reaction, the following results:

$$C {a ( O H )}_{2} ( s ) + CO ( g ) = {CaCO}_{3} ( s ) + {H}_{2} ( g ) \qquad ( 15 )$$

$${K}_{e q} ( 15 ) = {K}_{e q} ( 13 ) \times {K}_{e q} ( 3 ) = {K}_{e q} ( 8 ) \times {K}_{e q} ( 14 ) \times {K}_{e q} ( 31 ) = \frac{{K}_{e q} ( 14 ) \times {K}_{e q} ( 3 )}{{K}_{e q} ( 9 )}$$

| | Ca(OH)₂ | CO | CaCO₃ | H₂ |
|---|---|---|---|---|
| Initial | — | 1 | — | 0 |
| Conversion | — | X | — | X |
| Final | — | 1 − X | — | X |

$${K}_{e q} = \frac{X}{( 1 - X )} \qquad ( 16 )$$

$$X = \frac{{K}_{e q}}{1 + {K}_{e q}} \qquad ( 17 )$$

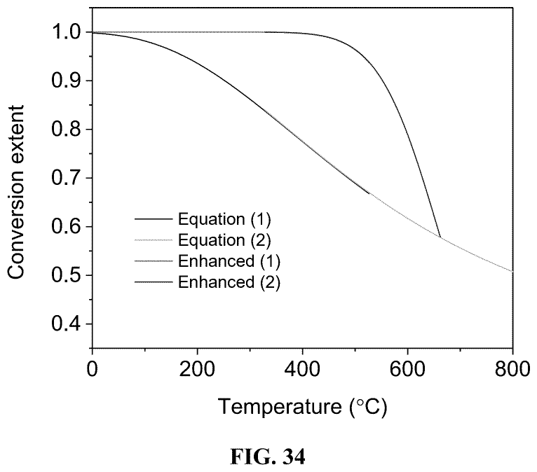

Conversion extent X and its relation with temperature can be summarized in FIG. 34.

Enhanced WGSR with calcium silicate (CaSiO₃)—Carbonation of calcium silicate can be expressed as equation (18):

$${CaSiO}_{3} ( s ) + {CO}_{2} ( g ) = {CaCO}_{3} ( s ) + {SiO}_{2} ( s ) \qquad ( 18 )$$

Reverse reaction of calcite-quartz-wollastonite (CQW) equilibrium is (Lodders, K. & Fegley Bruce, J., CHEMISTRY OF THE SOLAR SYSTEM (The Royal Society of Chemistry, 2011), which is hereby incorporated by reference in its entirety):

$${CaCO}_{3} ( s ) + {SiO}_{2} ( s ) = {CaSiO}_{3} ( s ) + {CO}_{2} ( g ) \qquad ( 19 )$$

$${K}_{e q} = {P}_{C {O}_{2}} ; {P}_{C {O}_{2}} ( bar ) = {10}^{( 7 \text{.97} - \frac{4456}{T} )}$$

K_{eq} of reaction (18) is the reciprocal of K_{eq} of reaction (19)
Combining with the WGSR, produces:

$${CaSiO}_{3} ( s ) + CO ( g ) + {H}_{2} O ( g ) = {CaCO}_{3} ( s ) + {SiO}_{2} ( s ) + {H}_{2} ( g ) {K}_{e q} ( 18 ) = {K}_{e q} ( 16 ) \times {K}_{e q} ( 1 ) = \frac{{K}_{e q} ( 1 )}{{K}_{eq} ( 17 )} \qquad ( 20 )$$

| | CaSiO₃ | CO | H₂O | CaCO₃ | SiO₂ | H₂ |
|---|---|---|---|---|---|---|
| Initial | — | 1 | 1 | — | — | 0 |
| Conversion | — | X | X | — | — | X |
| Final | — | 1 − X | 1 − X | — | — | X |

$${K}_{e q} = \frac{X}{{( 1 - X )}^{2}} \qquad ( 21 )$$

$$X = \frac{2 \times {K}_{e q} + 1 - \sqrt{( 4 \times {K}_{e q} + 1 )}}{2 \times {K}_{e q}} \qquad ( 22 )$$

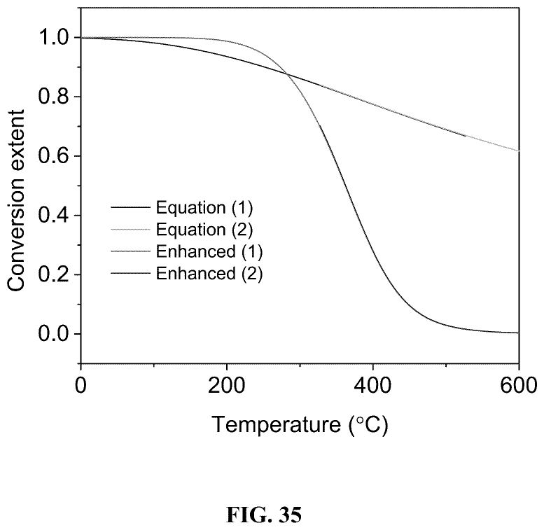

Relation of conversion extent and temperature is summarized in FIG. 35.

Based on the thermodynamic analyses of the Enhanced WGSR in the presence of CaO, Ca(OH)₂, and CaSiO₃, a significant enhancement in H₂ generation is predicted. While CaO and Ca(OH)₂ provide a significant enhancement and their reaction mechanisms are easier to follow, the predicted enhancement with CaSiO₃ can be higher if effective strategies to remove the silica passivating layers can be applied. These thermodynamic calculations provide the initial basis for enhancing WGSR using alkaline sources.

Magnesium Based Materials for Enhanced Water Gas Shift Reaction—To mimic the impact of the carbonation process to the WGSR, the thermodynamic models of the WGSR with and without the enhancement of magnesium-based carbonation process are produced. The thermodynamic model of WGSR is generated with identical initial partial pressure of CO and H₂O, which is assumed as 10 bar. At equilibrium state, the equilibrium constant K_{eq} can be expressed as:

$${K}_{e q} = \frac{{P}_{{H}_{2}} \times {P}_{{CO}_{2}}}{{P}_{CO} \times {P}_{{H}_{2} O}} = \frac{{X}^{2}}{{( 1 - X )}^{2}} \qquad [ 1 ]$$

Where X stands for the conversion rate of the reaction. Rearrange equation [1], there is:

$${K}_{WGSR} = \frac{\sqrt{{K}_{e q}}}{1 + \sqrt{{K}_{e q}}} \qquad [ 2 ]$$

On the other hand, the equilibrium constant K_{eq} is temperature sensitive, and according to Callaghan's research (Callaghan, C. A., “Kinetics and Catalysis of the Water-Gas-Shift Reaction: A Microkinetic and Graph Theoretic Approach,” Dep. Chem. Eng. Worcester Polytechnic Institute, Dissertation (2006), which is hereby incorporated by reference in its entirety), the relationship between the equilibrium constant K_{eq} and temperature T can be expressed as equation [3]:

$$log ( {K}_{eq} ) = - 2.4198 + 0.0003 \; 855 T + 218 0.6 / T \qquad [ 3 ]$$

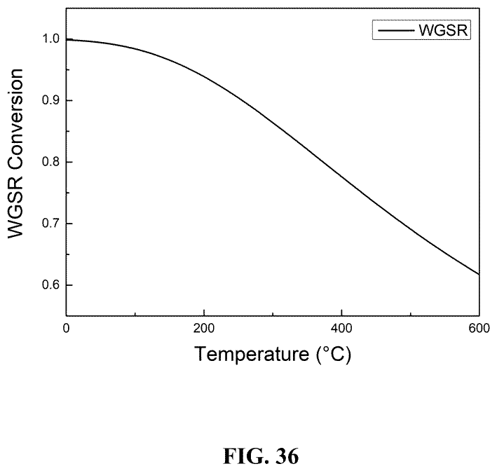

Therefore, combine equation [2] and [3], the conversion rates of WGSR at different temperature are gained, which is shown in FIG. 36.

The addition of carbon sequestration materials like MgO or Mg₂SiO₄ will make the system more complicated. For the WGSR system enhanced by MgO carbonation, the reaction process is:

$$CO ( g ) + {H}_{2} O ( g ) = C {O}_{2} ( g ) + {H}_{2} ( g ) \qquad [ 4 ]$$

$$MgO ( s ) + {CO}_{2} ( g ) = {MgCO}_{3} ( s ) \qquad [ 5 ]$$

$$MgO ( s ) + CO ( g ) + {H}_{2} O ( g ) = {MgCO}_{3} ( s ) + {H}_{2} ( g ) \qquad [ 6 ]$$

For the carbonation process, CO₂ is the only gaseous phase in this reaction, so the equilibrium constant can be expressed by the partial pressure of CO₂ in the system:

$${K}_{c , eq} = \frac{1}{{P}_{{CO}_{2}}} \qquad [ 7 ]$$

Combined with the WGSR, the total reaction function of the system is shown as equation [6], and the equilibrium constant of the total reaction K_{eq} is:

$${K}_{eq} = \frac{{P}_{{H}_{2}}}{{P}_{CO} \times {P}_{{H}_{2} O}} = \frac{X}{{( 1 - X )}^{2}} \qquad [ 8 ]$$

Where X is the conversion rate of the system. Rearrange equation [8], there is:

$${X}_{WGSR} = \frac{2 K + 1 - \sqrt{4 K + 1}}{2 K} \qquad [ 9 ]$$

On the other hand, the equilibrium constant of the total reaction can be also expressed by the product of the equilibrium constants of the two separate reactions:

$${K}_{eq} = {K}_{w , eq} \times {K}_{c , eq} \qquad [ 10 ]$$

Where K_{w,eq} is the equilibrium constant of WGSR and can be decided by temperature T according to equation [3], and K_{c,eq} is the equilibrium constant of MgO carbonation, which can also be expressed by temperature T according to Zevenhoven's research (Zevenhoven et al., “Heat Optimisation of a Staged Gas-Solid Mineral Carbonation Process for Long-Term CO2 Storage,” Energy 33:362-370 (2008), which is hereby incorporated by reference in its entirety):

$$ln ( {K}_{c , eq} ) = - 20.624 + 13 \; 789 / T \qquad [ 11 ]$$

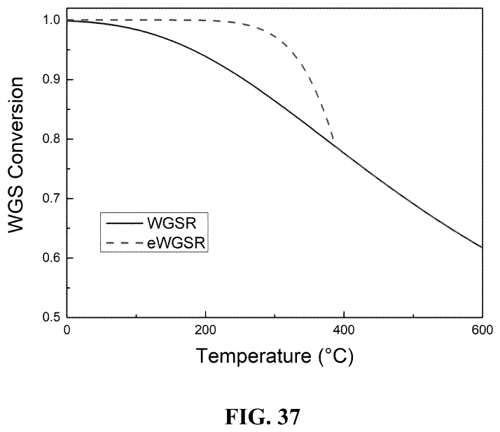

Therefore, by substituting equation [3] and equation [11] into equation [10], the conversion rates of the enhanced WGSR are gained under different temperature, which is shown as FIG. 37.

Further, if Mg₂SiO₄ is selected as carbon sequester to enhance WGSR, the reaction process will be:

$$2 CO ( g ) + 2 {H}_{2} O ( g ) = 2 {CO}_{2} ( g ) + 2 {H}_{2} ( g ) \qquad [ 12 ]$$

$${Mg}_{2} {SiO}_{4} ( s ) + 2 {H}_{2} O ( g ) = 2 {Mg ( OH )}_{2} ( s ) + {SiO}_{2} ( s ) \qquad [ 13 ]$$

$$2 {Mg ( OH )}_{2} ( s ) = 2 MgO ( s ) + 2 {H}_{2} O ( g ) \qquad [ 14 ]$$

$$2 MgO ( s ) + 2 {CO}_{2} ( g ) = 2 {MgCO}_{3} ( s ) \qquad [ 15 ]$$

$${Mg}_{2} {SiO}_{4} ( s ) + 2 CO ( g ) + 2 {H}_{2} O ( g ) = 2 {MgCO}_{3} ( s ) + {SiO}_{2} ( s ) + 2 {H}_{2} ( g ) \qquad [ 16 ]$$

According to the total reaction function, the equilibrium constant K_{eq} is determined by the partial pressure of CO, H₂O, and H₂. At equilibrium state, the total equilibrium constant can be noted as:

$${K}_{eq} = \frac{{P}_{{H}_{2}}^{2}}{{P}_{CO}^{2} \times {P}_{{H}_{2} O}^{2}} = \frac{{X}^{2}}{{( 1 - X )}^{4}} \qquad [ 17 ]$$

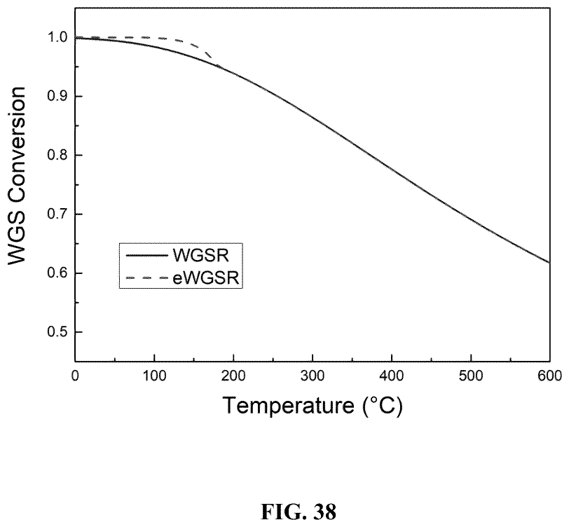

Therefore, with the equilibrium constants of the total reaction at different temperature provided by the database of ChemReaX, the conversion rates of the WGSR enhanced by the Mg₂SiO₄ carbonation are gained, which is shown as FIG. 38.

### Example 14—Evidence of CO₂ Removal Through Calcium Carbonate Formation after the Water Gas Shift Reaction

Continuously rising CO₂ concentration in atmosphere has become the most concerned environmental problem currently. Thus, it is essential to find available solutions to alleviate this problem. Carbon capture and storage (CCS) strategy was applied in recent years and it has made some progress until now. Among them, mineral carbonation has been considered as an effective method to solve this problem due to the high adsorption capacity and the stable carbonate products formed. Calcium-based materials are considered as a most promising type of materials for mineral carbonation because of its higher reactivity than magnesium-based materials and the abundant resources in natural environment. These advantages indicate that calcium-cased materials are worth investigating on their CO₂ capture effect. In this example, calcium hydroxide and calcium silicate powders were applied as examples to find their effect in capturing CO₂ gas under designed conditions. Thermogravimetric analysis (TGA) was performed to calculate their carbonation extent. Other characterization methods such as Fourier Transformed Infrared Spectroscopy (FT-IR), X-ray Diffraction (XRD), and Scanning Electron Microscopy (SEM) were also applied to determine the chemical structure of the initial samples and their reacted products as well as the morphological changes between the initial and final materials. The results suggested that both calcium hydroxide and calcium silicate can achieve a high carbonation extent after 3 hours reaction. In addition, calcite was the only type of calcium carbonates formed after mineral carbonation in both cases. Besides, kinetics performance of calcium hydroxide and calcium silicate materials was studied based on reaction extent values of different reaction times. It was found that calcium hydroxide possesses a much higher reaction rate than calcium silicate and this is in agreement with previous studies. This research can provide accessibilities for applying calcium hydroxide and calcium silicate materials in CO₂ capture process. These materials may be further used in other industrial procedures such as water gas shift (WGS) reaction process to enhance the H₂ production.

In this example, calcium hydroxide and calcium silicate powders were utilized in carbonation experiments and their effects in capturing CO₂ were further investigated in pure CO₂ gas condition. Specific experiment parameters were selected to optimize the experiment conditions. Thermogravimetric analysis (TGA) experiments were conducted to determine their reaction extent. Other characterization methods such as Fourier Transformed Infrared (FT-IR) spectroscopy, X-ray Diffraction (XRD) analysis and Scanning Electron Microscopy (SEM) were performed to identify the chemical bonds, crystalline phases and morphological structures of the original powders and their reacted products. Moreover, sodium bicarbonate solution was prepared and applied in the experiments as contrast to pure de-ionized water to examine the NaHCO₃ effect in controlling the extent of carbonate formation. In addition, kinetics performance of calcium hydroxide and calcium silicate materials were investigated based on different values of several carbonation experiments under the same conditions but different reaction times. All the studies can provide a better understanding of carbonation process of calcium-based materials and make mineral carbonation better applied in other industrial processes such as waste-gas-shift (WGS) reaction.

Materials—The starting materials were Calcium chloride dihydrate (CaCl₂·2H₂O, Sigma-Aldrich, 99%), Sodium hydroxide (NaOH, Fisher Chemical, Certified ACS), Triton X-100 (Sigma-Aldrich, laboratory grade), Calcium hydroxide (Ca(OH)₂, Fisher Chemical, Certified Powder), Calcium silicate (CaSiO₃, Alfa Aesar, meta, Reagent Grade, typically <20 Micron Powder), Sodium bicarbonate (NaHCO₃, Ward's science, Reagent Grade), CO₂ gas (Airgas, 99.8% purity). The water used in all experiments were de-ionized water (DI water) or Milli-Q water. All the chemical reagents were purchased commercially and used without further purification.

Synthesis route of materials—In this example, both commercial and synthesized calcium hydroxide materials were used as samples to investigate the effect. Calcium hydroxide powder was synthesized via a simple lab-scale approach to make comparison with commercial samples (Taglieri et al., “Synthesis, Textural and Structural Properties of Calcium Hydroxide Nanoparticles in Hydro-Alcoholic Suspension,” Adv. Mater. Phys. Chem. 04(03):50-59 (2014), which is hereby incorporated by reference in its entirety).

Calcium hydroxide synthesis: Two different aqueous solutions were prepared, containing approximate 0.3 mol/L CaCl₂·2H₂O and 0.6 mol/L NaOH respectively, by dissolving 0.03 mol CaCl₂·2H₂O and 0.06 mol NaOH in 100 ml de-ionized water. 2.0 ml Triton X-100 was added to the above prepared solutions separately and the NaOH solution was added into CaCl₂ solution at 90° C. to obtain a suspension of Ca(OH)₂. The reaction happening is shown in equation (3). After stirring the mixed solution for 15 minutes at 90° C., vacuum filtration was performed to collect the products and several de-ionized water washings were conducted to remove the salt and surfactant residues. After that, the precipitate was dried in vacuum oven for several hours for further experiments and analysis.

$${CaCl}_{2} + 2 NaOH = {Ca ( OH )}_{2} + 2 NaCl \qquad ( 3 )$$

Experiment setup—A series of carbonation experiments were performed on the calcium hydroxide and calcium silicate powders to investigate their carbonation behaviors and the compositional changes after reaction process. Specifically, temperature of 200° C. (±5° C.), initial 20 atm (±1 atm) pressure CO₂, 15% (±0.5%) solid weight solution and 300 rpm (5 rpm) stirring rate were chosen as the starting experiment parameters. Reaction time of 3 hours was selected to determine their reaction effect and experiments of other reaction times were conducted as contrast to investigate their kinetics performance. All the experiments parameters are summarized in Table 6. Pure de-ionized water and sodium bicarbonate solution were used as liquid solution in these experiments to examine NaHCO₃ effect in controlling the extent of carbonate formation.

TABLE 6
Parameters of all carbonation experiments of calcium hydroxide and calcium silicate materials
like temperature, gas pressure, stirring rate, solid weight ratio, and reaction time.

| | | | | | Solid | | |
|---|---|---|---|---|---|---|---|
| | | | Initial | Actual | weight | Stirring | |
| Materials | Type | Temperature | Pressure | Pressure | ratio | rate | Reaction time |
| Calcium | Synthesized | 200° C. | 20 atm | ≈34 atm | 15 wt. % | 300 rpm | 30 minutes/1 hour/ |
| hydroxide | Commercial | (±5° C.) | CO₂ | CO₂ | (±0.5%) | (±5 rpm) | 2 hours/3 hours |
| Calcium | Commercial | | (±1 atm) | | | | |
| silicate | | | | | | | |

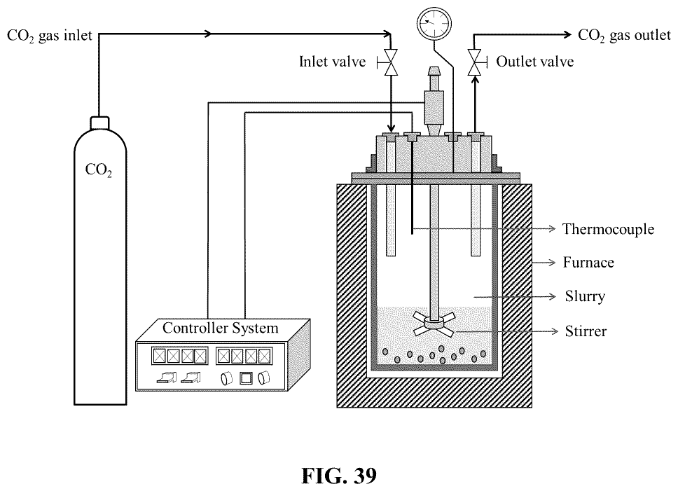

All carbonation experiments were conducted in a stainless-steel batch reactor (Micro Bench Top Reactor, Parr Instrument Company), and the schematic representation of the reactor is shown in FIG. 39. For calcium hydroxide experiments (both commercial and synthesized one), first, some proper amounts of powders were put into the reactor as well as calculated specific volume of solution to make a slurry system. Complete stirring is not that essential in Ca(OH)₂ reaction process due to its high reactivity with CO₂. Gas inlet and gas outlet were left open and CO₂ gas were purged for one or two minutes (more time at some experiments) at first to remove the air inside the reactor. After this short time purge, the partial pressure of gas impurity inside the reactor is considered to be negligible compared with initial CO₂ partial pressure (20 atm). Secondly, gas outlet was shut down and the gas inlet was also closed when the pressure gauge reached 20 atm. Next, check the pressure value of the reactor and examine if the reactor leaks at high pressure. After the leakage check, controller system was adjusted to heat the reactor system to 200° C., then the magnetic stirrer was started, which is the starting point of reaction. As the temperature increased, pressure inside the reactor increased as well to the final value around 500 psi (≈34 atm). This value is deviated from the theoretical pressure value (475 psi, calculated based on ideal gas equation PV=nRT) by around 5%, which is in a reasonable error range due to the differences between ideal gas and real gas. During the reaction, the pressure remained in the range of 475-500 psi, indicating an excess CO₂ gas condition. After specific reaction time (for example, 3 hours), heating system and stirring were turned off. The reactor was left to cool down to appropriate temperature to handle. Gas inside the reactor was released out to prevent further reaction in short-period experiments (30 minutes, and 1 hour, etc). For long-period experiments, further carbonation process was neglected because of the following reason: reaction effect in cool-down period is relatively little compared with the reaction time when the heating system and stirring were also turned off at that time. In addition, at cool-down time, the samples inside the materials have gone through carbonated process for such a long period and most of them have become carbonates. Thus, it is reasonable to assume that further carbonation was limited. Finally, vacuum filtration was performed to the experiment products and several de-ionized water washings were conducted to remove the potential contaminants and residues. Then the powders were dried in a vacuum oven for several hours to remove the water content for further analysis. For calcium silicate experiments, more calcium silicate samples were placed into the reactor at the beginning (around 3 g) together with about 17 ml solution to remain the 15% solid weight ratio. This change was meant to create a better and complete stirring environment during the reaction process due to the much slower reaction kinetics of calcium silicate reacted with CO₂ compared with calcium hydroxide.

In addition, water was used in the carbonation experiments to form a gas-liquid-solid reaction system. NaHCO₃ solution was prepared as well by dissolving sodium bicarbonate powders directly into de-ionized water, of which the resulting concentration is around 1.0 M, and it was also applied in the carbonation experiments to examine the effect of NaHCO₃ in carbonation process. With H₂O addition, the carbonation reactions (for example, CaSiO₃) will proceed in several steps, illustrated by equation (4)-(6) (Huijgen et al., “Mechanisms of Aqueous Wollastonite Carbonation as a Possible CO₂ Sequestration Process,” Chem. Eng. Sci. 61(13):4242-4251 (2006), which is hereby incorporated by reference in its entirety):

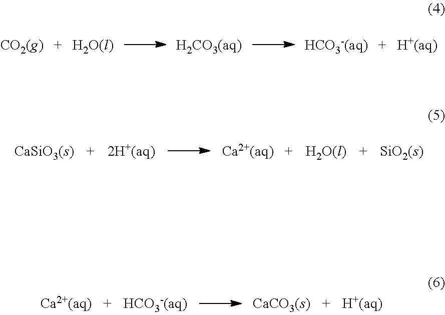

Characterization methods—The thermal decomposition behavior of the powders and the carbonation extent of their products were examined by a Thermo Gravimetric analyzer (Discovery SDT 650, TA instrument) based on the weight loss during the temperature increase. Proper heating rate like 5° C./min or 10° C./min as well as final temperature (≥850° C.) were set to fully decompose the powder and the N₂ flow rate was also set properly. Fourier transform infrared spectroscopy (FT-IR, Nicolet™ iS50 FTIR Spectrometer, Thermo Scientific) measurements were performed to determine the chemical bonds or functional groups of the powder. The crystalline phases of the powders and their reaction products were determined through X-ray diffraction (XRD) analysis by X-ray diffractometer (Bruker D8 Advance ECO powder diffractometer) with Cu Kα radiation (40 kV, 25 mA) source; the samples were scanned over the 20 range from 200 up to 80°. The morphology of the samples before and after reaction and their particle sizes were supported by the Scanning electron microscopy (SEM, LEO 1550 FESEM). The operating voltage was set appropriately to obtain the best images.

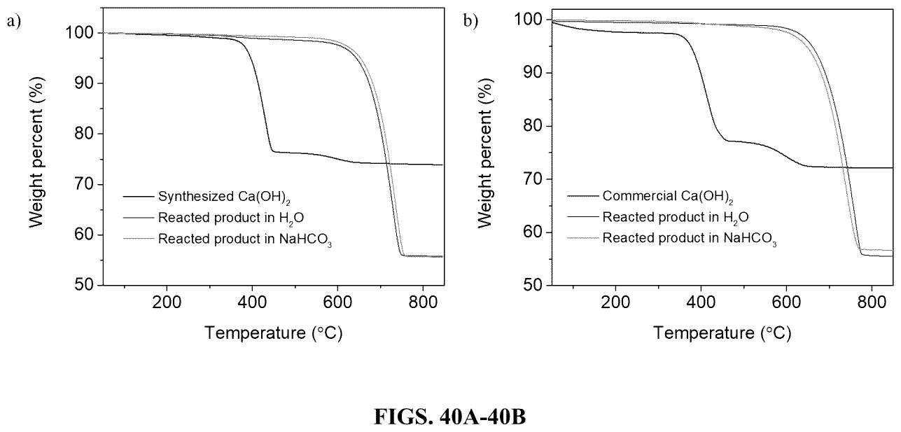

Thermal behavior of initial samples and reacted products—The thermogravimetric analysis (TGA) data of synthesized calcium hydroxide powder and commercial calcium hydroxide powder as well as their carbonated products after the 3-hour reactions are summarized in FIGS. 40A-40B. In synthesized calcium hydroxide case (FIG. 40A), there is an obvious weight loss occurring around 400° C. existed in the black curve, and the weight loss percentage is around 24%, which matches the theoretical weight loss of calcium hydroxide. No obvious weight loss occurs around 700° C.-750° C. means that there is little calcium carbonate included in the initial synthesized calcium hydroxide powders. After carbonation process, similar TGA curves appear for both pure water and NaHCO₃ products. Only one large weight loss region occurs around 600° C.-750° C. and after 800° C., the curves become horizontal again, indicating the complete decomposition. This weight loss is attributed to the decomposition of calcium carbonate into calcium oxide. Original weight loss around 400° C. disappears, which is the evidence of little calcium hydroxide left in the reacted products. No other decomposition of possible impurities appears in the curves as well. In FIG. 40B, commercial calcium hydroxide case, the results are relatively the same as synthesized one (FIG. 40B). Both synthesized and commercial calcium hydroxide exhibit high conversion extent after 3-hour carbonation experiments.

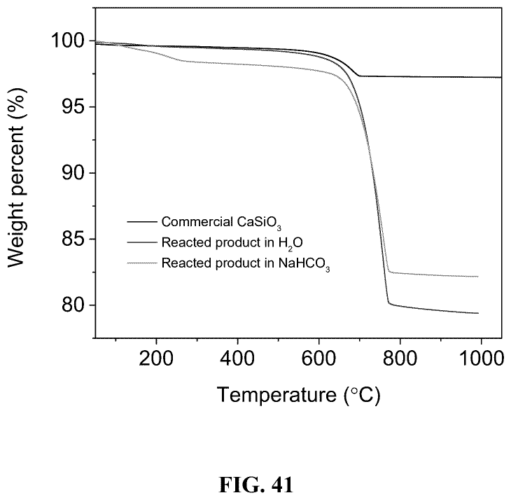

Thermogravimetric analysis (TGA) data of commercial calcium silicate powders are listed in FIG. 41. A small weight loss, around 2 percent, is observed at 650° C.-750° C. during the heat up to even 1000° C. of the initial calcium silicate powders, which is expected from calcium silicate chemical formula (CaSiO₃). This weight loss may come from the impurities like calcium carbonate. However, since the impurities content is rather low in the commercial calcium silicate samples (also shown in the FT-IR pattern and XRD pattern), this small weight loss is not included in the carbonation extent calculation afterwards. After carbonation process, similar decomposition of calcium carbonate appears around 600° C.-750° C. and the curves become stable again after 800° C. Weight losses observed around 200° C. in some cases could be attributed to potential hydrated carbonates formation.

These data confirm the synthesis of calcium hydroxide powders and show that the calcium carbonate powders form in both calcium hydroxide and calcium silicate cases. Also, it provides the foundation of carbonation extent calculation as described below.

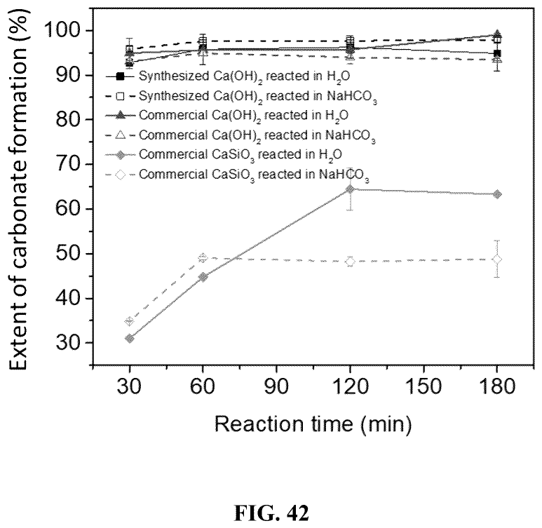

Extent of carbonate formation and its kinetics analysis—The extent of mineral carbonation of both calcium hydroxide and calcium silicate powders under de-ionized water condition and NaHCO₃ condition after 3 h reaction time are shown in FIG. 42. Each reacted sample was tested by TGA for at least two times to calculate the average to find a more accurate value. As noted herein, impurities in the commercial materials are regarded as negligible and are not taken into account in this calculation process. As illustrated in FIGS. 40A-40B and 41, the most obvious weight loss region in carbonated products is around 700° C.-750° C., which is attributed to the decomposition of calcium carbonate. The decomposition begins at around 600° C. and ends after 800° C., thus, the weight loss between 550° C. and 840° C. was selected as the released CO₂ weight for complete decomposition value. It is found that the decomposition of calcium hydroxide occurs in the temperature range of 390° C.-500° C. (Khachani et al., “Non-Isothermal Kinetic and Thermodynamic Studies of the Dehydroxylation Process of Synthetic Calcium Hydroxide Ca(OH)₂,” J. Mater. Environ. Sci. 5(2):615-624 (2014), which is hereby incorporated by reference in its entirety), which has little influence in the selected range. In addition, some weight losses before 250° C. were observed in some cases, and these were attributed to the H₂O, volatiles, and potential hydrated carbonate products. Consequently, the weight at 250° C. was chosen as the base dry weight (weight without water and volatile inside). Thus, the CO₂ weight loss in TGA is calculated as below,

$$TGA = \frac{Weight ( 550 °C . ) - Weight ( 840 °C . )}{Weight ( 250 °C )} \qquad ( 6 )$$

For Ca(OH)₂ samples, the carbonation reaction appears as following:

$${Ca ( OH )}_{2} + {CO}_{2} = {CaCO}_{3} + {H}_{2} O \qquad ( 7 )$$

The water will disappear after drying the carbonation products. Thus, the carbonation extent is calculated as follows:

$$Extent = \frac{{W}_{{Ca ( OH )}_{2}} \times TGA}{{W}_{{CO}_{2}} - ( {W}_{{CO}_{2}} - {W}_{{H}_{2} O} ) \times TGA} \times 100 \% \qquad ( 8 )$$

However, things are rather different in calcium silicate carbonation case. In calcium silicate carbonation process, SiO₂ appears as the product instead of H₂O, indicating that no weight loss during the drying process:

$${CaSiO}_{3} + {CO}_{2} = {CaCO}_{3} + {SiO}_{2} \qquad ( 9 )$$

Thus, the carbonation extent is calculated as equation (10):

$$Extent = \frac{{W}_{{CaSiO}_{3}} \times TGA}{{W}_{{CO}_{2}} \times ( 1 - TGA )} \times 100 \% \qquad ( 10 )$$

In FIG. 42, it is clearly shown that Ca(OH)₂ samples, both synthesized and commercial, exhibit a much higher carbonation extent after 3 hours (almost or even more than 95%) in both H₂O and NaHCO₃ condition than the calcium silicate samples, indicating that Ca(OH)₂ powders have higher reactivity with carbon dioxide, which is consistent with previous studies.

In addition, from the comparison of different reaction time for Ca(OH)₂ reactions, either commercial or synthesized, the carbonation extent is rather high (more than 90%) even after only 30-minute reactions. This behavior indicates a rather fast reaction kinetics of Ca(OH)₂ reacted with CO₂ gas with water addition. The effect of NaHCO₃ addition is not obvious in the commercial Ca(OH)₂ cases, which is partly attributed to the non-uniform distribution of the final products and partly due to the already existed high extent even in pure de-ionized water. It is also shown that synthesized calcium hydroxide possesses a higher extent of carbonate formation than the commercial one and the difference is relatively small. This phenomenon is attributed to the differences in particle sizes (more important and illustrated below) or the different weight of initial solid samples in the experiments (less essential due to the same solid weight percent, the high reactivity and the excess CO₂ gas condition).

For calcium silicate, the reaction kinetics is relatively slower compared with that of calcium hydroxide, as shown by the green curve in FIG. 42. It is observed that the extent value continues to grow as the reaction time increases at the beginning. And the carbonation extent stops increasing after reaction for 2 hours, both in H₂O and NaHCO₃ cases. After the final 3-hour reaction, the carbonation extent of commercial CaSiO₃ can reach more than 60% in the pure water condition. On the contrast, the carbonation extent goes to around 30% even only reacted for 30 minutes. This indicates the kinetics mechanism of calcium silicate reacted with CO₂: a first fast kinetics regime followed by a much slower one.

In previous studies, it is suggested that NaHCO₃ added in the de-ionized water can improve the carbonation extent of calcium-based materials. The NaHCO₃ effect on the mineral carbonation has been studied before and is summarized as two points (Gadikota et al., “Chemical and Morphological Changes During Olivine Carbonation for CO₂ Storage in the Presence of NaCl and NaHCO₃,” Phys. Chem. Chem. Phys. 16(10):4679-4693 (2014), which is hereby incorporated by reference in its entirety): 1) NaHCO₃ provides enough bicarbonate ions at initial stage, so that a possible rate-limiting CO₂ dissolving step can be avoided, resulting in an enough amount of carbonate ions for calcium carbonate precipitation; 2) NaHCO₃ acts as a pH buffer material in the solution, making a pH-neutral condition appropriate for both CO₂ dissolution and calcium carbonate precipitation. However, in some cases in this example, the carbonation extent in NaHCO₃ is lower than that in pure water cases, especially in commercial calcium silicate cases. In that case, when reaction time is 30 minutes or 1 hour, NaHCO₃ shows a positive influence on the extent of carbonate formation or the kinetics. As the reaction time increases, the carbonation extent gets much lower in NaHCO₃ cases. This behavior is attributed to the low calcium ions (Ca²⁺) concentration in the initial sodium bicarbonate solutions, further leading to a low carbonation extent. As reported in the previous literatures, in the aqueous mineral carbonation processes, silicate dissolution step has been generally considered to be the rate-limiting step (Snæbjörnsdóttir et al., “Carbon Dioxide Storage Through Mineral Carbonation,” Nat. Rev. Earth Environ. 1:90-102 (2020); Sanna et al., “A Review of Mineral Carbonation Technologies to Sequester CO₂,” Chem. Soc. Rev. 43(23):8049-8080 (2014); and Park et al., “CO₂ Mineral Sequestration: Physically Activated Dissolution of Serpentine and pH Swing Process,” Chem. Eng. Sci. 59(22-23):5241-5247 (2004), all of which are hereby incorporated by reference in their entirety). Obviously, pH values of aqueous solutions have an influence on the dissolution behavior of samples. Accordingly, in a low-pH solution, more H⁺ ions are present, resulting in the reactions with calcium silicate materials and release of more calcium ions (Ca²⁺) into the solution. This behavior is also illustrated as equation (5) in this example. In this study, the initial de-ionized water has a pH value of around 5.5, while it increases up to 9.30 after calcium silicate addition. On the contrast, the pH value of 1 M sodium bicarbonate solution is somewhat unchanged, remaining about 7.8-7.9 in both cases. The larger difference of pH value in de-ionized water indicates a consumption of H⁺ ions in the solution, leading to a release of Ca²⁺0 ions. This may lead to a high calcium ions concentration in pure de-ionized water. While in the NaHCO₃ case, the initial pH is higher and not proper for the dissolution step. This may explain the low carbonation extent in NaHCO₃ compared with pure de-ionized water condition after a long reaction time, because there is a limit of Ca²⁺0 ions in the NaHCO₃ cases compared with that in de-ionized water. However, the improvement of NaHCO₃ addition could be observed based on the values of short-time reactions.

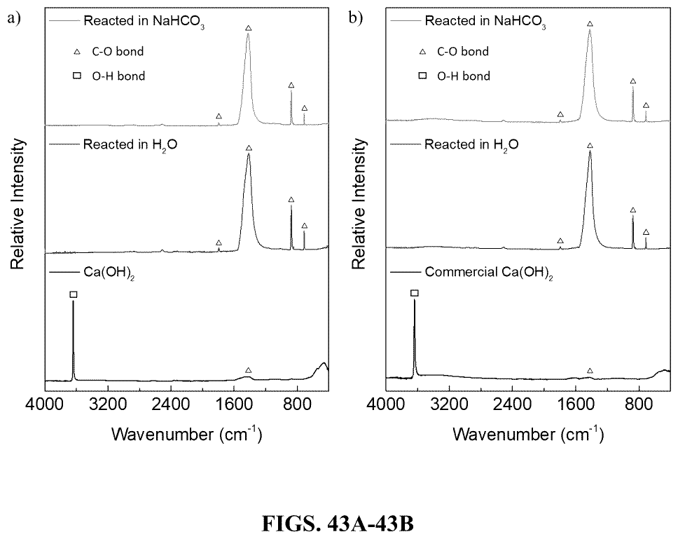

Chemical bond analysis of initial samples and reacted products—FT-IR analysis results of calcium hydroxide are illustrated in FIGS. 43A-43B. In FIG. 43A, the intensity peak corresponding to the O—H bond is obviously shown at around 3640 cm⁻¹ in the unreacted calcium hydroxide samples (Galvin-Ruiz et al., “Characterization of Calcium Carbonate, Calcium Oxide, and Calcium Hydroxide as Starting Point to the Improvement of Lime for Their Use in Construction,” J. Mater. Civ. Eng. 21:625-708 (2009), which is hereby incorporated by reference in its entirety), indicating a clear evidence of the Ca(OH)₂ existence. The peaks at around 1420 cm⁻¹ can be attributed to C—O bond. After carbonation process, strong peaks at around 1420 cm⁻¹, 870 cm⁻¹ and 710 cm⁻¹ appear in the FT-IR results of both products reacted in H₂O and NaHCO₃ and these peaks correspond to the different vibration modes of carbonate ions in calcium carbonate products, which are ν₃ asymmetric CO₃ band, ν₂ asymmetric CO₃ band and ν₄ symmetric CO₃ band, respectively (Andersen et al., “ChemInform Abstract: Infrared Spectra of Amorphous and Crystalline Calcium Carbonate.,” ChemInform 23(9) (2010), which is hereby incorporated by reference in its entirety). A small peak around 1800 cm⁻¹ represents the ν₁+ν₄ symmetric CO₃ vibration mode (Rodriguez-Blanco et al., “The Kinetics and Mechanisms of Amorphous Calcium Carbonate (ACC) Crystallization to Calcite, Via Vaterite,” Nanoscale 3(1):265-271 (2011), which is hereby incorporated by reference in its entirety). No clear peaks representing the O—H bond appear around 3600 cm⁻¹ indicating that little Ca(OH)₂ exists in the carbonation products, and this can be explained by the complete carbonation process or the relatively less amount of Ca(OH)₂ compared with the calcium carbonate. In FIG. 43B, similar results are observed in the original commercial powders and reacted products. As illustrated above, these behaviors obviously prove the calcium hydroxide depletion and calcium carbonate formation after reacting with CO₂ gas.

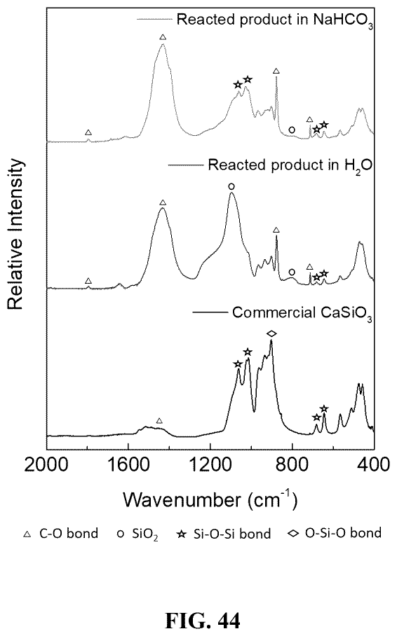

Commercial calcium silicate samples show a rather complex FT-IR result, as illustrated in FIG. 44. The highest peak at around 900 cm⁻¹ corresponds to O—Si—O bond in calcium silicate structure (Ding et al., “CO₂ Mineral Sequestration by Wollastonite Carbonation,” Phys. Chem. Miner. 41(7):489-496 (2014), which is hereby incorporated by reference in its entirety). Si—O—Si bond could possibly be interpreted to small peaks around 645 cm⁻¹, 684 cm⁻¹ and the much clearer peaks around 1010 cm⁻¹ and 1060 cm⁻¹ (Ding et al., “CO₂ Mineral Sequestration by Wollastonite Carbonation,” Phys. Chem. Miner. 41(7):489-496 (2014), which is hereby incorporated by reference in its entirety). All these results can prove the existence of calcium silicate powders. After both carbonation processes in H₂O and NaHCO₃ solution, the same peaks around 1420 cm⁻¹, 870 cm⁻¹, 710 cm⁻¹ show again, indicating that the carbonation product contains calcium carbonate as well (Andersen et al., “ChemInform Abstract: Infrared Spectra of Amorphous and Crystalline Calcium Carbonate.,” ChemInform 23(9) (2010), which is hereby incorporated by reference in its entirety). The other two obvious peaks here presenting at around 1100 cm⁻¹ and 800 cm⁻¹ are related to the SiO₂ (Galvin-Ruiz et al., “Characterization of Calcium Carbonate, Calcium Oxide, and Calcium Hydroxide as Starting Point to the Improvement of Lime for Their Use in Construction,” J. Mater. Civ. Eng. 21:625-708 (2009), which is hereby incorporated by reference in its entirety), which is also the reaction product in the calcium silicate carbonation case. Here, some peaks of unreacted calcium silicate are observed in FT-IR results in reacted products around specific wavenumber values, especially in NaHCO₃ case. This further indicates the less reaction extent compared with that in pure water.

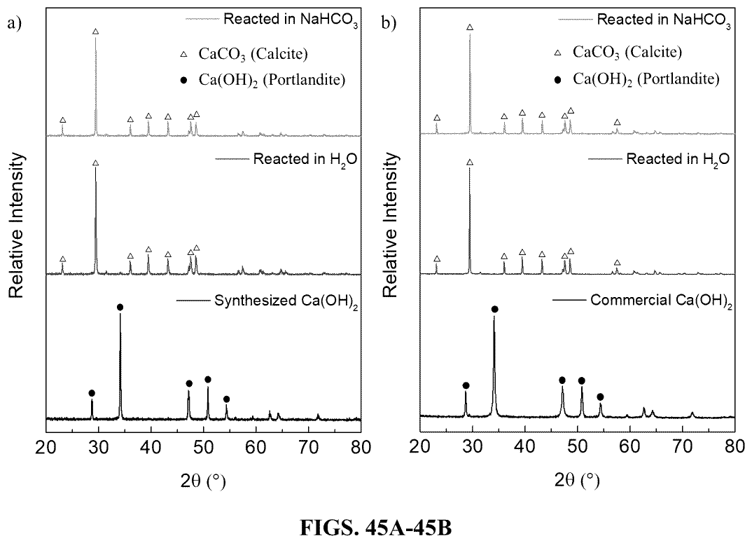

Chemical composition analysis of initial powders and reacted products—FIGS. 45A-45B shows the X-ray diffraction patterns (XRD) of the calcium hydroxide powders and their reacted products. In the original Ca(OH)₂ powder, both synthesized and commercial, all the peaks can be identified to the Ca(OH)₂ crystalline phase (Petch, H. “The Hydrogen Positions in Portlandite, Ca(OH)₂, As Indicated by the Electron Distribution,” Acta Crystallogr. 14(9):950-957 (1961), which is hereby incorporated by reference in its entirety) and no impurity appears in the sample. After carbonation experiments in de-ionized water and NaHCO₃, the main crystalline phase of the products is calcium carbonate in both cases. Calcium carbonate generally has three forms: calcite, aragonite and vaterite. In this example, from the XRD pattern, it can be concluded that calcium carbonate products all belong to calcite (Chessin et al., “Position and Thermal Paramters of Oxygen Atoms in Calcite,” United States (1965), which is hereby incorporated by reference in its entirety) and no other phases exist, which is clearly illustrated in FIGS. 45A-45B pattern. Also, Ca(OH)₂ exists as a rather minor phase in the products after carbonation processes, illustrating that the powder is not fully carbonated to one hundred percent. However, the content is much less than the calcite.

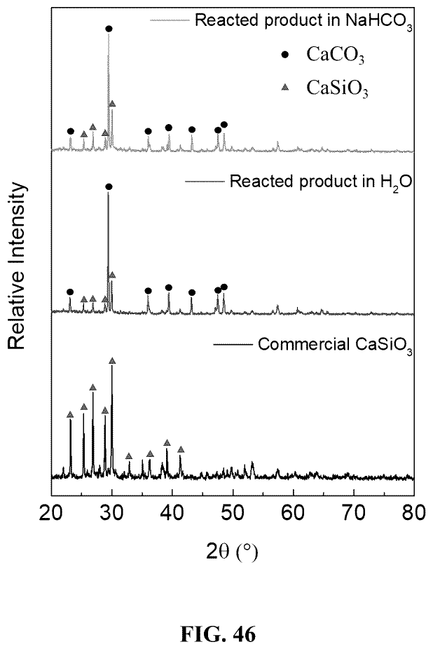

The diffraction pattern of commercial calcium silicate is also illustrated in FIG. 46. As noted herein, some formed products may exist in the hydrated form, however, they are at a relatively small percent which have no clearly shown peaks in XRD pattern. According to the peak identification, it is clearly shown that commercial calcium silicate is mainly composed of wollastonite (CaSiO₃), shown by the marked peaks (Mamedov et al., “The Crystal Structure of Wollastonite,” Doklady Akademii Nauk SSSR 107:463-466 (1956), which is hereby incorporated by reference in its entirety). Other unidentified peaks are attributed to the low-content impurities in the materials. The mainly formed products are calcite (Chessin et al., “Position and Thermal Paramters of Oxygen Atoms in Calcite,” United States (1965), which is hereby incorporated by reference in its entirety) again after these experiments, which is shown by the corresponding peaks in the reacted samples. In addition, some peaks of unreacted CaSiO₃ remain clear in both cases, indicating an uncomplete reaction process, which can be proved from the previous calculated carbonation extent value (45%-65%). Also, there are no clear peaks corresponding to the SiO₂ phase, and this could possibly be explained by the amorphous SiO₂ product formed in the carbonation experiments. Thus, it is clearly shown that in both Ca(OH)₂ and CaSiO₃ carbonation experiment, only calcite phase exists as the formed calcium carbonate product, which is consistent with previous study (Huijgen et al., “Mechanisms of Aqueous Wollastonite Carbonation as a Possible CO₂ Sequestration Process,” Chem. Eng. Sci. 61(13):4242-4251 (2006), which is hereby incorporated by reference in its entirety).

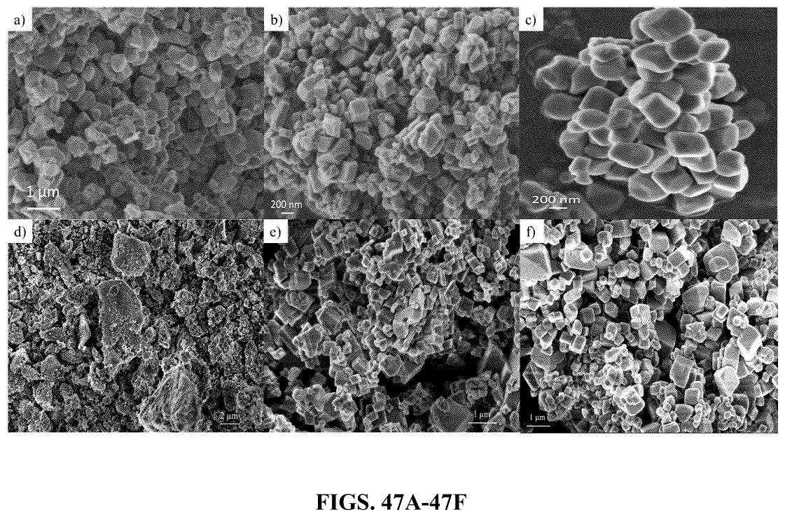

Morphology studies of particles using Scanning Electron Microscopy (SEM)—The particle sizes and morphology of the synthesized and commercial calcium hydroxide materials and their carbonation products are shown in the SEM images in FIG. 47A-47F. It is clearly shown in FIG. 47A that the Ca(OH)₂ powders synthesized in this example have a variety range of particle sizes, with an average size of around 400-500 nm. And their shapes are rather irregular. Possible calcium carbonate particles existing in this image may be attributed to the potential reaction of calcium hydroxide with CO₂ in the atmosphere, due to its high reactivity discussed above. However, more regular cubic-shaped samples are formed in their reacted products shown in FIGS. 47B and 47C. As illustrated in previous X-ray diffraction discussion, the formed products are mainly calcite. It is clearly shown that the calcite formed possesses an average size of about 300-400 nm in both cases, which is a little bit smaller than the original Ca(OH)₂ powders. In the commercial calcium hydroxide cases, the powder also possesses a wide range of particle size from hundreds of nanometers up to several micron meters. The particle shapes are irregular as well (FIG. 47D). In the reacted products, calcium carbonate particles of cubic shape are observed in the SEM images of FIGS. 47E and 47F, which are in the size range of hundreds of nanometers. Thus, it is illustrated that synthesized and commercial calcium hydroxide are relatively similar in particle sizes.

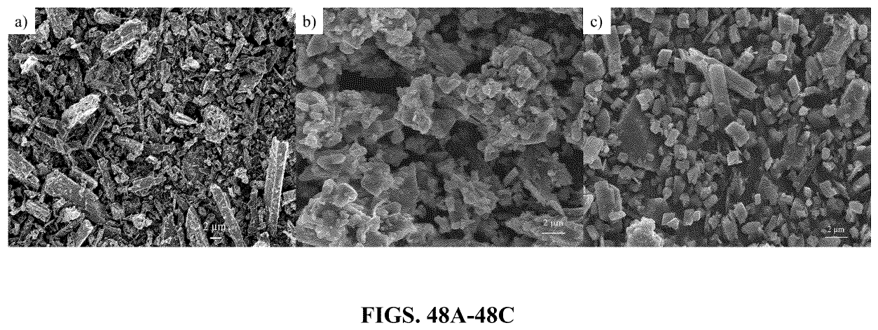

The commercial calcium silicate powders showed a rather different morphology from Ca(OH)₂ powder (FIGS. 48A-48C). FIG. 48A shows that calcium silicate particle has rather irregular shapes and consists of varied range of sizes, generally of several micron meters. Several are even in a strip form. Moreover, significant aggregations are also obvious in the image, resulting in bulk particles. The stacking of smaller particles is clearly shown in the image in FIG. 48A. After carbonation experiments, the reacted products appear to be in the cubic shape again, with sizes in the one to two-micron meters range. In addition, unreacted calcium silicate particles appear as well in both carbonated products in H₂O and NaHCO₃ solution. As illustrated in FIGS. 48B and 48C, unreacted calcium silicate particles either exist as dispersed particles or as laminar plates. The results from these images are exactly matched with those from previous characterization methods and again confirm the carbonation processes happened during the experiments.

Conclusion—This example investigated the effect of calcium hydroxide and calcium silicate samples to capture CO₂ gas. Commercial calcium hydroxide material as well as the commercial calcium silicate powder were investigated. As contrast, calcium hydroxide was also synthesized via a simple lab-scale approach and its effect was investigated. Here, it is shown that both Ca(OH)₂ and calcium silicate powders exhibit the ability to absorb CO₂ gas based on the extent of carbonate formation calculated by the TGA data. The calculated values and corresponding X-ray diffraction patterns also confirm the effect of CO₂ gas capture in these experiments. FT-IR, XRD, and SEM characterization methods all indicate the formation of calcium carbonate during the reaction process. The products are mainly calcite in the cubic shape. Moreover, kinetics analysis was performed based on the data obtained from experiments of varied reaction times. Results show that Ca(OH)₂ has a higher reactivity with CO₂ and it went through carbonation is less than 1 h or even half an hour in optimal condition. However, calcium silicate reacts with CO₂ in a relatively slower speed compared with calcium hydroxide, and this conclusion is supported by the huge difference of carbonation extent between the experiments. All these data illustrates that calcium hydroxide materials are more effective in CO₂ gas capturing, and it provides accessibilities to apply both calcium hydroxide and calcium silicate materials in CO₂ capturing process. Next step in future experiments is to examine these calcium-based materials effect in capturing CO₂ gas in mixed gas conditions instead of pure CO₂ flow, such as water gas shift reactions.

### Example 15—Developing Sustainable Pathways to Harness Energy Resources while Reducing Detrimental Environmental Impacts Using Renewable Feedstocks to Produce H₂

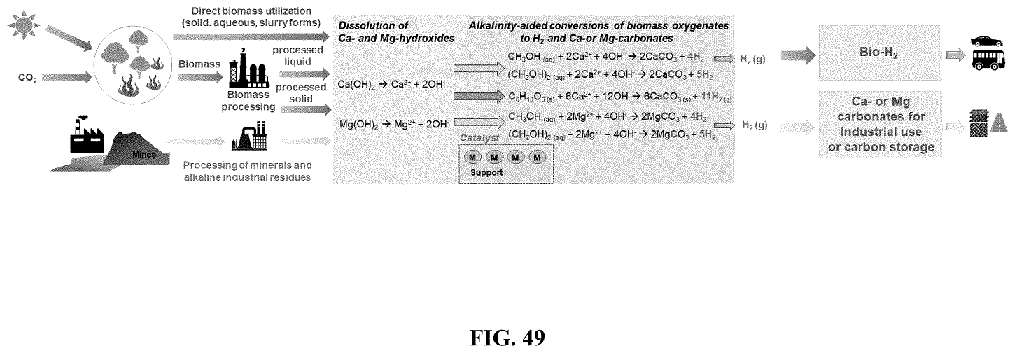

A goal of the present disclosure is to develop sustainable pathways to harness energy resources while reducing detrimental environmental impacts. The transition to a low carbon energy future necessitates the development of novel energy conversions with the inherent removal of greenhouse gas emissions. One less studied but highly promising approach is to produce H₂ from renewable feedstocks such as biomass while removing CO₂ to produce calcium and magnesium carbonates in a single step process. This overall thermodynamically route has several transformative impacts including (i) the potential for negative emissions, (ii) the utilization of renewable carbon-based feedstocks such as solid biomass or aqueous biomass oxygenates feedstocks including food waste, alkaline industrial residues such as steel slag, and abundant natural Ca- and Mg-silicate minerals, and (iii) the generation of calcium or magnesium carbonates as value-added materials. The aim of this disclosure is to develop a mechanistic understanding of the multiphase chemical reactions involved in producing H₂ and Ca- or Mg-carbonates from biomass, and to harness this knowledge to accelerate these conversion pathways. The hypothesis that H₂ and inorganic carbonate generation can be accelerated in an energy efficient manner in a pressurized aqueous slurry process by using catalysts (e.g., Ni/Al₂O₃) to inhibit CH₄ formation and alkaline sorbents (e.g., Ca(OH)₂ or Mg(OH)₂) to enhance H₂ generation and CO₂ removal via carbonate conversion (FIG. 49) will be investigated.

Sourcing Ca(OH)₂ or Mg(OH)₂ from alkaline industrial residues (e.g., coal fly ash) or mining wastes facilitates their utilization. Alternatively, earth abundant naturally occurring minerals (e.g., Ca- and Mg-silicates) can be used to synthesize Ca(OH)₂ and Mg(OH)₂. This approach is an alternative to the conventional approach of sourcing Ca(OH)₂ or Mg(OH)₂ by heating and processing their respective carbonate minerals, which is accompanied by direct CO₂ emissions. Further, the pressurized gas-liquid-solid slurry reaction configurations can use solid biomass or aqueous biomass oxygenates, which allows for the treating off biomass in wide-ranging forms with variable levels of water content. This pathway can be utilized to produce high purity H₂ from oxygenates such as methanol and ethanol, which are gaining attention as hydrogen carriers. Oxygenates produced from algae and via chemical and microbial deconstruction of complex biomass, and solid biomass reactants such as cellulose, glucose, and lignocellulosic biomass will be studied. The research objectives are to (i) develop pathways to enhance H₂ and carbonate formation from solid biomass or biomass-derived oxygenates, (ii) advance mechanistic insights into biomass deconstruction and carbonate formation, and (iii) reconstruct multiphase reaction pathways for enhanced H₂ production with suppressed CO₂ formation.

Decarbonizing the energy supply chain and removing CO₂ from the environment motivate the need for novel, realizable and scalable technologies. Utilizing solid biomass or biomass-derived oxygenates to produce H₂ with inherent carbon removal remains less studied but is a highly promising approach to produce energy carriers such as H₂ and carbonate materials that can be used in filler and construction materials.

Complex and coupled mechanisms belie the simple reactions representing enhanced H₂ generation with CO₂ capture from biomass. From a thermodynamics perspective, biomass deconstruction pathways are typically endothermic, while carbonate formation reactions starting from hydroxides are exothermic. The generalized reaction representing H₂ evolution with in situ CO₂ capture using CaO as the sorbent is: CₓH_{y}O_{z}+xCaO+(2x−z)H₂O→xCaCO₃+(2x−z+0.5y)H₂. The standard heats of this reaction for various oxygenate molecules compiled in Table 7 shows that this coupled reaction pathway is exothermic.

TABLE 7
Exothermic Coupled Reaction Pathway
Standard heats of reaction (kJ/mol)

| | |
|---|---|
| methanol | −92 |
| ethanol | −186 |
| glycerol | −411 |
| butanol | −325 |

To realize this technology at scale, it is important to evaluate the opportunities and challenges with respect to current existing and emerging technologies. The ability to generate multiple useful products such as H₂ and Ca-or Mg-carbonates from biomass with inherent carbon removal in a single step represents potential to realize negative emissions and the feasibility of using multiple low value streams to produce useful products. Accelerating the kinetics of conversion, enhancing selectivity and yield and the ability to incorporate a wide range of feedstocks are essential for realizing the technological potential of this approach at scale.

This integrated H₂ and carbonate co-generation approach from biomass addresses some of the challenges in existing and emerging technologies. For example, water splitting via electrolytic pathways has been proposed to produce H₂. Using renewable wind or nuclear energy for H₂ generation via water electrolysis has a very low greenhouse gas footprint compared to using electricity from fossil fuels. However, the current intermittency of renewable resources is a challenge for scalable synthesis.

In contrast, 95% of H₂ produced in the United States is made by natural gas reforming, which is accompanied by significant CO₂ emissions. Briefly, H₂ is produced via steam methane reforming at 700° C.-1,000° C. as represented by this reaction: CH₄+H₂O(+heat)→CO+3H₂, ΔHᵣ=206 kJ/mol. This is followed by the water-gas-shift reaction to produce CO₂ and H₂ as shown here: CO+H₂O→CO₂+H₂(+heat), ΔHᵣ=−40.6 kJ/mol. A wide range of carbon-based resources including waste plastics, coal and biomass can be utilized via gasification. Regardless, CO₂ capture and storage technologies need to be integrated to reduce the carbon footprint of this approach.

Utilizing biomass as an alternative resource to CH₄ for H₂ production has several advantages. Renewability, the potential for distributed energy generation, and the opportunity to convert heterogeneous residues such as food waste to useful fuels and products are unique to biomass as an energy resource. Further, this integrated approach inhibits CO₂ emissions by forming carbonates. The proposed efforts in this area are timely. The IPCC report recognized that Bioenergy with Carbon Capture and Storage (BECCS) technologies can have a carbon storage potential of 0.5-5 gigatons of CO₂/year. In 2020, the Drax power plant in the UK started operating a BECCS plant where biomass is used in place of coal to generate electricity and the emitted CO₂ is captured and stored. The urgency to develop and deploy novel technologies for carbon removal and clean energy generation is evident from the increasing commitment from governments, companies, and universities to achieve negative emissions in the next 1-2 decades and the 45Q tax credits to incentivize businesses to utilize and store CO₂ by providing a tax credit of $35/ton.

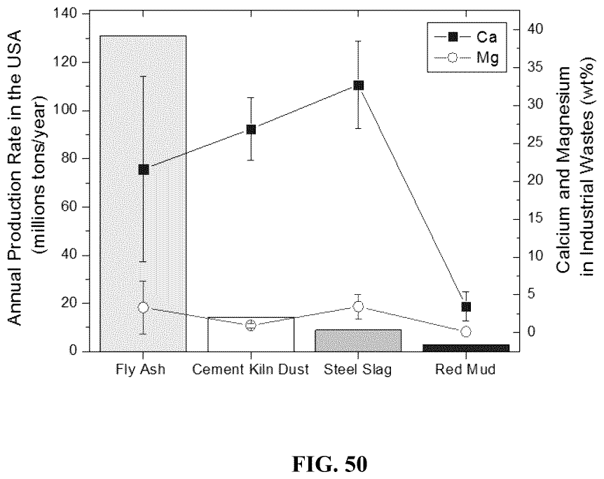

Currently, various BECCS studies are based on integrating CO₂ capture with the geologic storage of CO₂. However for places that lack subsurface resources to store CO₂, alternative technologies need to be developed. This approach of producing H₂ with inherent carbon removal is uniquely suited for such regions. In this context, it is important to consider the availability of Ca- and Mg-bearing alkaline resources for producing carbonates. Estimates suggest that 200-300 Mt of CO₂ can be sequestered annually in alkaline industrial residues such as fly ash and steel slag (FIG. 50) and >10⁴-10⁶ Gt of carbon can be stored in minerals or rocks. Ca- and Mg-oxides, hydroxides, and silicates are dominant in industrial resources and natural minerals. Another emerging societal challenge is the utilization of vast resources of alkaline industrial residues (e.g., coal fly ash, stainless steel slag, cement kiln dust, lime kiln dust, red mud, and mining residues) as an alternative to landfilling these materials. The challenge with utilizing alkaline industrial residues is the heterogeneity in the Ca- and Mg-compositions (FIG. 50).

These materials often contain silicates from which it is challenging to extract Ca and Mg. Instead, more reactive Ca(OH)₂ and Mg(OH)₂ can be synthesized from silicates to facilitate faster reactivity with biomass molecules. The conventional approach to produce Ca(OH)₂ and Mg(OH)₂ is via the calcination of their respective carbonates which results in significant CO₂ emissions. Instead, producing these materials from natural minerals such as silicates and alkaline industrial residues may circumvent the challenge of directly emitting CO₂ when carbonates are used. Thus, new chemical approaches need to be developed to produce Ca(OH)₂ and Mg(OH)₂ from wide ranging feedstocks including alkaline industrial residues and natural minerals.

Scientific background and knowledge gaps—Accelerated production of H₂ from biomass with in-situ CO₂ removal is proposed as an alternative to existing strategies to capture CO₂ after H₂ is generated from biomass treatment processes such as gasification, pyrolysis, or aqueous phase reforming. Briefly, biomass gasification involves reacting biomass in controlled oxygen or steam environments to produce CO, H₂, and CO₂. Low temperature gasification occurs between 600° C.-1000° C., while high temperature gasification occurs above 1000° C. In contrast, pyrolysis occurs at 300-1000° C. without O₂. Pyrolysis of bio-oil and solid biomass (e.g., legume straw and apricot stone, cellulose, xylan, lignin, and pine) yields H₂ along with CO, CO₂, CH₄, C₂H₄, or C₂H₆. Reforming approaches involve the reaction of biomass with steam to produce CO and H₂. Often, reforming reactions are followed by the water-gas-shift reaction to produce CO₂ and H₂. As an alternative to these high temperature pathways which occur above 500° C., aqueous phase reforming of biomass oxygenates such as methanol, ethanol, ethylene glycol, glycerol and sorbitol was proposed. Unlike steam reforming, the aqueous phase reforming reactions are performed in a pressurized N₂ environment of 20-50 bar and 200-300° C. to reduce the energy needs associated with the latent heat of vaporization. Common themes among these diverse approaches is the use of catalysts for selectively cleaving C—C linkages of the biomass molecules to produce H₂.

Role of alkalinity on H₂ evolution from biomass—To produce high purity H₂, membranes, adsorption, or absorption technologies have been developed to separation COₓ and CₓH_{y}. Few studies explored the reactive separation of H₂ using alkaline sorbents such as calcium oxide (CaO) starting from biomass. Combining CaO with biomass pyrolysis enhances H₂ yields by shifting the thermodynamic equilibrium of the water-gas-shift reaction to produce H₂ and enhancing tar cracking and char decomposition. Sorbents such as NaOH or Ca(OH)₂ cleave the C—C linkages in bio-molecules, enhance the activity of earth abundant catalysts such as Ni/Al₂O₃ and capture CO₂ to produce inorganic carbonates, thus accelerating H₂ evolution with in-situ CO₂ capture. Prior studies showed that NaOH is effective in producing a higher yield of H₂ from the by-products of food-based biomass, such as glucose, molasses and rice bran at 330-390° C. Without NaOH, glucose decomposition yielded CO₂, H₂O, char and tar that were unfavorable to H₂ production. Glucose decomposition in NaOH yielded alkylated and hydroxylated carbonyl compounds, which further decomposed to produce H₂ gas. 80% of the gas effluent was H₂ at 450° C. and 340 bar in two hours.

Hydrothermal experiments were performed by mixing solid cellulose with NaOH pellets in stoichiometric molar ratios of 1:12 and cellulose with Ca(OH)₂ or Mg(OH)₂ in stoichiometric molar ratios of 1:6, and 10 wt % Ni/ZrO₂ catalyst in the presence of steam at temperatures in the range of 177° C.-500° C. In the presence of 10 wt % Ni/ZrO₂ catalyst, NaOH, Ca(OH)₂ and Mg(OH)₂ resulted in H₂ yields of 66%, 31.4% and 16.1%, respectively in two hours. In the absence of the catalyst, NaOH, Ca(OH)₂ and Mg(OH)₂ resulted in H₂ yields of 33%, 1.2% and 0.4%, respectively in two hours. NaOH is effective in suppressing CO₂ and CO, followed by Ca(OH)₂ and Mg(OH)₂. This trend is consistent with their differences in alkalinity. Steam is used in these reactions and energy sufficient for the latent heat of vaporization needs to be supplied.

Alternatively, in aqueous phase reforming of glycerol where fluid is maintained in the aqueous phase (at N₂ pressure of 50 atm), CaO favored C—C bond cleavage and resulted in a H₂ yield of 63% in the presence of Pt—Ni supported bimetallic catalyst on multi-walled carbon nanotubes. The experimental conditions were 230° C., an initial N₂ pressure of 30 bar, 15 mL of 10 wt. % glycerol with 100 mg catalyst and 180 mg of CaO and a reaction time of 4 hours. These examples illustrate that alkaline sorbents and catalysts synergistically aid the conversion of solid biomass (e.g., glucose, cellulose, xylan, wheatgrass, starch, rice straw, potato, rice husk) and aqueous biomass oxygenates (e.g., glycerol) to H₂ and carbonates. The key advantage with these pathways is that water that may be present with biomass, as in the case of food waste, can be used to enhance reactivity of biomass. This approach reduces the energy penalty associated with drying biomass for pyrolysis or gasification processes. Further, Ca- and Mg-carbonates have been shown to reduce tar formation in high temperature biomass conversions. Trapping carbon as an inorganic carbonate circumvents carbon precipitation known to reduce catalytic activity. Despite these advances, the hypothesis that maintaining water in the aqueous phase dissolves Ca(OH)₂ or Mg(OH)₂ and enhances reactivity and mass transfer to produce inorganic carbonates and facilitates the breakdown of biomass reactants has not been systematically investigated. The overall energy gains associated with utilizing water in the aqueous phase as opposed to steam need to be evaluated.

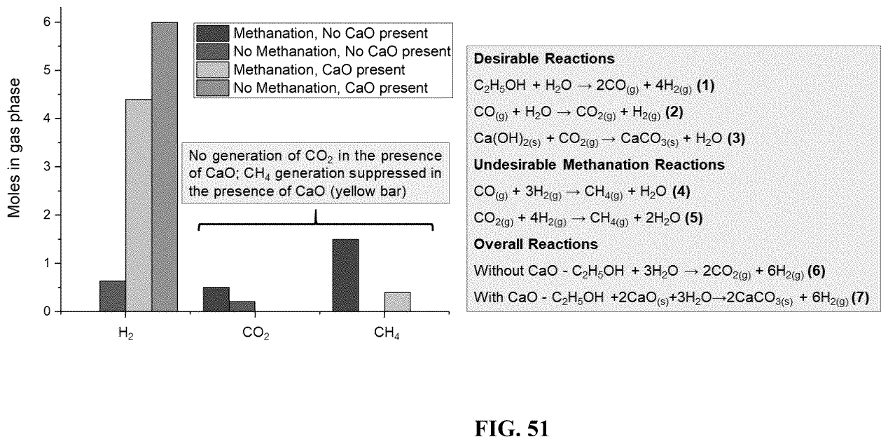

Thermodynamic feasibility of producing H₂ in alkaline sorbent-water-biomass derived oxygenate systems—To evaluate the hypothesis that H₂ generation is enhanced in alkaline sorbent-water-solid biomass or biomass-derived oxygenates, preliminary thermodynamic calculations were performed for ethanol-water and ethanol-water-CaO systems at 500 K (227° C.) and N₂ pressure of 50 bar to maintain water in the aqueous state. Stoichiometric levels of 1 mole of ethanol and 3 moles of water are reacted to produce 6 molecules of H₂ (FIG. 51). Adding two moles of CaO generated two moles of CaCO₃. Methanation reactions are undesired since H₂ is scavenged to produce CH₄, thus lowering the yields of H₂. The influence of methanation reaction on H₂ yields was investigated. The results shown in FIG. 51 demonstrate that stoichiometric conversion of 6 moles of H₂ is achieved when methanation reactions are inhibited and CaO is present (see green bar). Negligible H₂ yields are achieved when methanation reactions occur and no CaO is present (see red bar). Thus, these data suggest that high H₂ yields can be achieved in aqueous environments under pressure by inhibiting methanation reactions and using alkaline sorbents.

Coupling the exothermic conversion of Ca(OH)₂ to CaCO₃ (as represented by this reaction: Ca(OH)₂+CO_{2(g)}→CaCO₃+H₂O; ΔH^{o}=−178.4 kJ/mol) enhances the overall favorability of the biomass oxygenates conversions to H₂. For example, the water gas shift reaction, CO+H₂O→CO₂+H₂ which is an intermediate step in this pathway is endothermic (ΔH^{o}=2.88 kJ/mol) when water is the aqueous phase, and exothermic (ΔH^{o}=−41.2 kJ/mol) when water is in the gas phase. Thus, coupling endothermic reactions with exothermic carbon mineralization reactions enhances the favorability of H₂ and carbonate formation. To enhance H₂ selectivity, there is a need for design strategies to selectively limit methanation reactions and incorporate alkaline sorbents to enhance H₂ generation in solid biomass or biomass-derived oxygenates.

Role of catalytic interfaces on directing H₂ formation—As noted in FIG. 51, methanation reactions can inhibit H₂ formation. One approach to circumvent methanation reactions is by enhancing the cleavage of C—C bonds which facilitate H₂ formation, as opposed to C—O bonds which enhance alkane formation. Selective cleavage of C—C bonds is favored in alkaline or neutral environments. Thus, catalysts and reaction conditions that aid the C—C bond cleavage are needed.

Prior studies demonstrated that Pt catalysts are highly active and selective to H₂ production, followed by Pd. Earth abundant catalysts such as Ni favor C—C bond cleavage but can promote CO methanation and carbon deposition at conditions consistent with aqueous phase reforming. Alternatively, Ni catalyst on ZrO₂ support is effective in enhancing H₂ formation and suppressing COₓ and CₓH_{y} formation when NaOH or Ca(OH)₂ is reacted with solid biomass (e.g., glucose and cellulose). The decomposition of sugars such as glucose and cellulose to H₂ and CO₂ is favored in the presence of OH⁻ ions. In addition to the cleavage of C—C bonds in biomass, Ni catalysts on ZrO₂ or Al₂O₃ supports facilitate the following reactions: CH₄+H₂O→CO+3H₂; CO+H₂O→CO₂+H₂. Despite the promising potential of Ni/Al₂O₃ or Ni/ZrO₂ catalysts to enhance H₂ production in alkaline environments, strategies need to be developed to recover the catalyst and retain its high activity in multiphase reaction environments.

Role of carbonate chemistry on enhancing H₂ formation—The two factors that favor the integration of in-situ CO₂ removal via carbonate formation with enhanced H₂ production from biomass are that faster kinetics of carbonate formation are achieved at higher temperatures and the solubility of Ca- and Mg-carbonates is lowered with increasing temperature. Since these hydrothermal conversions occur at elevated temperatures, the decomposition temperatures of carbonates is an important consideration. Magnesium carbonate (MgCO₃) and calcium carbonate (CaCO₃) decompose at 350° C. and 800° C., respectively. Hydrogen generation pathways such as aqueous phase reforming pathways occur at 200-300° C. and can be integrated with Mg-based sorbents since MgCO₃ does not decompose until 350° C.

In processes that use solid biomass molecules as precursors, temperatures higher than 350° C. may be needed to facilitate deconstruction. The high decomposition temperature of CaCO₃ at 840° C. facilitates integration with a range of H₂ generation approaches including low temperature gasification/steam reforming and aqueous phase reforming which occur at temperatures in the range of 600-1000° C. and 200-300° C. Further, Ca- and Mg-carbonates have very low solubility in water facilitating greater ease of separation. Prior studies demonstrated the effectiveness of strong bases such as NaOH in deconstructing cellulose and capturing CO₂ to produce water soluble Na₂CO3. However, one ton of NaOH costs $921 per ton, while weak bases such as Ca(OH)₂ and Mg(OH)₂ cost $250 per ton and $74 per ton, respectively. CaO and Ca(OH)₂ abundant in alkaline industrial residues such as steel slag and coal fly slag can be utilized.

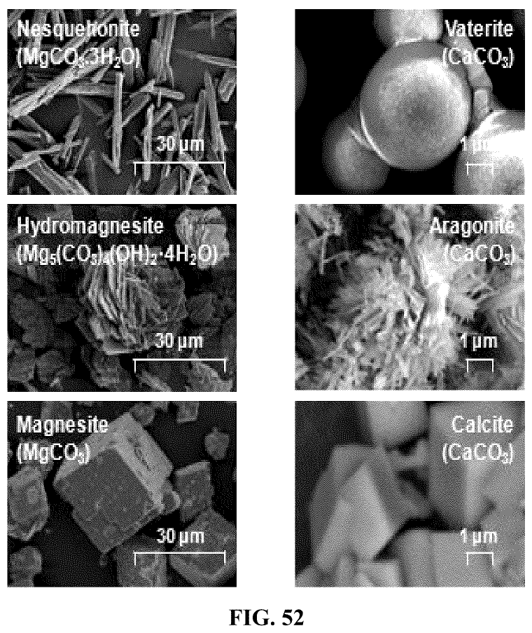

Another consideration is the chemistry and types of phases formed. Metastable hydrated carbonate phases (e.g., hydromagnesite ((Mg(OH)₂)(MgCO₃)₄·4H₂O)) are undesirable since Mg is directed towards forming Mg(OH)₂ as opposed to MgCO₃. Further, hydromagnesite and nesquehonite undergo dissolution and reprecipitation unlike stable MgCO₃ with low solubility. Stable CaCO₃ phases such as calcite and MgCO₃ phases such as magnesite are generally favored above 100° C. FIG. 52 represents the SEM images of various calcium and magnesium carbonate phases.

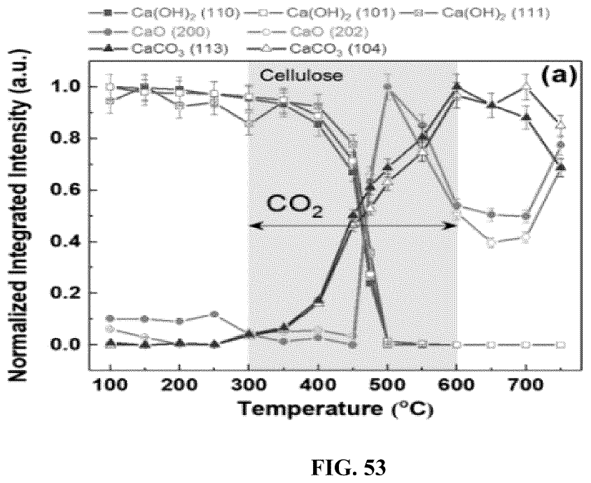

To determine the evolution of the phases formed when solid cellulose and Ca(OH)₂ are co-reacted at stoichiometric ratios (in the absence of steam or water), in-operando Wide Angle X-ray scattering/X-Ray Diffraction studies were performed and the outcomes were reported in ACS Sustainable Chemistry and Engineering. Ca(OH)₂ completely decomposes between 300-600° C. As Ca(OH)₂ decomposes, CaCO₃ and CaO are formed in this temperature range. CaO content decreases around 600° C. where CaCO₃ is the highest. These results are summarized in FIG. 53.

Unlike in the solid-solid interactions of cellulose-Ca(OH)₂ noted here, CaCO₃ formation occurs in aqueous environments at room temperature due to enhanced mass transfer in gas-liquid-solid or liquid-solid environments as opposed to gas-solid environments. In these multiphase chemical systems, it is challenging to infer the rate-limiting mechanisms just by characterizing the end products. In this context, advancements in in-operando characterization approaches can be harnessed to determine if the kinetics of carbonate formation are rate-limiting during the production of H₂ from biomass with integrated CO₂ removal. This information is used to develop mechanistically informed chemical strategies to accelerate H₂ and inorganic carbonate formation.

The aim is to develop a novel and integrated pathway to produce H₂ and CaCO₃ or MgCO₃ using aqueous and solid biomass precursors and Ca(OH)₂ or Mg(OH)₂ in the presence of Ni/Al₂O₃ catalyst. Experiments will be performed at 200-500° C., N₂ pressure of 50 atm, and in a continuously stirred configuration to prevent mass transfer limitations. The hypothesis that alkaline sorbents such as Ca(OH)₂ or Mg(OH)₂ selectively cleave the C—C bonds in biomass to aid H₂ evolution and convert organic carbon into inorganic carbonates, will be investigated. To probe this hypothesis, the following research issues need to be addressed: (1) how to synthesize Ca(OH)₂ and Mg(OH)₂ from alkaline industrial residues and minerals; (2) what are the possible slow and fast reaction steps and how can they be identified; (3) what are the mechanisms underlying these slow and fast steps and do these mechanisms vary over time; (4) how to dynamically characterize and quantify if biomass deconstruction or carbonate formation are the rate-limiting steps; (5) how to harness this information to redesign the reaction configurations to achieve high purity H₂ and Ca- or Mg-carbonates with the efficient reuse of the catalyst; and (6) how to develop process-scale assessments and life cycle analyses to identify energy efficient reaction configurations with H₂ conversions, CO₂ removal efficiencies and catalyst stability.

The following objectives are proposed to address these research questions: (i) develop pathways to enhance H₂ and carbonate formation from solid biomass or biomass-derived oxygenates, (ii) advance mechanistic insights into biomass deconstruction and carbonate formation, and (iii) reconstruct multiphase reaction pathways for enhanced H₂ production with suppressed CO₂ formation.

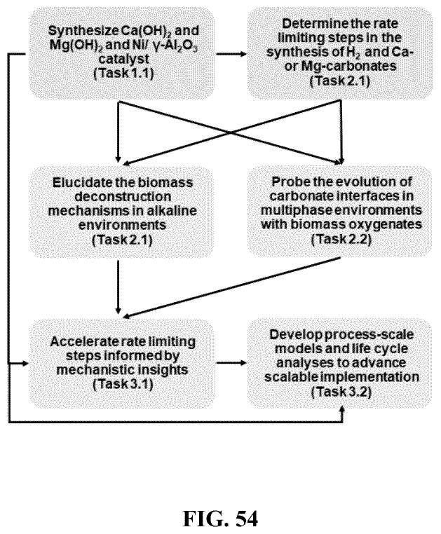

Description of Research Efforts, Approach—The close integration and the flow of information from one task to another is demonstrated by FIG. 54. First, Ca(OH)₂ and Mg(OH)₂ are synthesized from naturally occurring minerals and alkaline industrial residues as inputs and Ni/γ-Al₂O₃ catalyst described above. These materials are then used to determine the rate-limiting step. The outcomes will inform the subset of experimental conditions to probe if biomass deconstruction or carbonate formation are the rate limiting steps in the production of H₂ and inorganic carbonates from solid biomass or biomass-derived oxygenates. The reaction configurations and conditions will be identified to accelerate the rate-limiting step. The energy and mass conversions for the highest conversion scenarios will be used to develop process-scale models and life cycle analyses.

Objective 1. Develop pathways to enhance H₂ and carbonate formation from solid biomass or biomass-derived oxygenates—The building blocks for H₂ and carbonate generation are biomass reactants, water, Ca(OH)₂ or Mg(OH)₂ to capture CO₂, and Ni/Al₂O₃ catalyst to accelerate the reaction. Ni/Al₂O₃ catalyst is chosen since Ni is earth abundant unlike Pt. Ni has high activity for H₂ generation from biomass, and accelerates the conversion of intermediate steps such as CO and H₂O to CO₂ and H₂ in alkaline environments. Magnetic properties of Ni facilitate ease of separation. The synthesis of Ca(OH)₂ and Mg(OH)₂ from alkaline industrial residues and naturally occurring minerals, and Ni/Al₂O₃ catalyst is proposed. A detailed laboratory scale experimental plan to identify the rate limiting step is proposed.

Synthesize Ca- and Mg-hydroxides and Ni/γ-Al₂O₃ catalyst. The hypothesis that high purity Ca(OH)₂ or Mg(OH)₂ can be synthesized from alkaline industrial residues and natural minerals is probed. High purity silica-free Ca(OH)₂ and Mg(OH)₂ will be synthesized from alkaline industrial residues such as coal fly ash and steel slag and naturally occurring minerals such as CaSiO₃. High purity Mg(OH)₂ is synthesized from mine tailings rich in (Mg,Fe)₂SiO₄ and Mg₃Si₂O₅(OH)₄ used to extract Ni and the naturally occurring minerals. This approach harnesses earth abundant silicate minerals or low value alkaline industrial residues to produce useful Ca(OH)₂ or Mg(OH)₂.

Sequential pH adjustments are proposed to synthesize high purity Ca(OH)₂ and Mg(OH)₂. For example, the precipitation of silica at pH 2-3, iron oxide (if iron is present in the silicates) at pH 8-9 and Ca- or Mg-hydroxides at pH 11-12 is achieved through these sequential adjustments. Nitric acid has been conventionally used for pH adjustments. This approach allows for synthesis of high purity Ca- and Mg-hydroxides at low temperature. Alternative routes for producing Mg(OH)₂ by recycling ammonium sulphate salts as the extraction agents with magnesium silicates will be explored. In this extraction route, a solid-solid reaction of ammonium sulfate with magnesium silicate-bearing minerals such as serpentine (Mg₃Si₂O₅(OH)₄) at 400° C.-550° C. extracts Mg into magnesium sulfate (MgSO₄). The gaseous by-products include ammonia, water vapor and sulfur dioxide. Ammonia and water are recovered to produce ammonium hydroxide. Magnesium sulfate and ammonia hydroxide are reacted in the aqueous phase at pH 11-12 and room temperature to produce high purity Mg(OH)₂ and regenerate ammonium sulfate. Iron is precipitated as FeO(OH) at pH 8-9. Hydroxides are used instead of oxides to save the energy costs associated with dehydroxylating hydroxides. Outcome: High purity Ca(OH)₂ and Mg(OH)₂ (>95% pure) are synthesized from earth-abundant silicate minerals and alkaline industrial residues.

Ni/γ-Al₂O₃ catalysts will be synthesized to evaluate the hypothesis that high alkalinity together with magnetically recoverable catalysts enhance H₂ yield and selectivity and are easy to recover post-reaction. These catalysts are prepared by impregnating mesoporous 7-Al₂O₃ with a solution bearing Ni(NO₃)₂·6H₂O. Post impregnation, the samples are evaporated at 353 K, dried at 383 K, and then calcined in air at 723 K for 3 hours. Compositions are adjusted to vary Ni loadings from 5-40 wt % Ni. Outcome: Synthesis of high purity Ni/γ-Al₂O₃ catalyst with minimal defects.

Characterization needs. The purity of the synthesized Ca- and Mg-hydroxides, and Ni/Al₂O₃ is determined from Quantitative X-Ray Diffraction. Ni loading is obtained from X-Ray Photoelectron Spectroscopy (XPS). The compositions of Mg or Ca in the hydroxides, and Ni in the catalyst are determined by dissolving the them in nitric acid to produce aqueous salt solutions that can be tested via Inductively Coupled Plasma—Atomic Emission Spectroscopy (ICP-AES) analyses. BET Pore Size Analysis and Laser Diffraction Particle Size Analysis will be used to discern the particle and pore size fractions of the reacting solids. SEM and TEM imaging will be performed at CCMR.

Determine the rate limiting steps in the synthesis of H₂ and Ca-or Mg-carbonates. The hypotheses that Ca(OH)₂ and Mg(OH)₂ accelerate C—C bond cleavage in biomass and remove CO₂ via carbonate formation will be studied. Thermodynamic analyses of the enhancement in H₂ generated for different biomass feedstocks and alkaline sorbents will be performed using ASPEN (see FIG. 51 as an example). This approach will set the baseline assessment for the highest conversions to be expected from the experiments.

Experiments will be performed in a pressurized N₂ environment to reduce the energy needs of the latent heat of vaporization. The hypothesis that maintaining the fluid in the aqueous phase (at N₂ pressure of 50 atm) in a well-mixed environment aids Ca(OH)₂ or Mg(OH)₂ dissolution and accelerates the breakdown of biomass molecules will be probed. The hypothesis that H₂ conversions and catalyst recoveries differ with the modes of operation will be explored. In mode 1, the biomass of interest, Ca(OH)₂ or Mg(OH)₂, and catalyst will be mixed together in a slurry form. In mode 2, a basket bearing the catalyst will be placed to enhance the ease of catalyst recovery, while ensuring that the fluid phase is in contact with the catalyst. Deconstruction of aqueous biomass oxygenates is expected at 200-300° C. Solid biomass deconstruction occurs at a wider temperature range of 200-500° C.

Initially, all the experiments with solid and aqueous biomass will be performed using Ca(OH)₂ since the decomposition temperature is around 850° C., which is significantly higher compared to 200-500° C., the operating temperatures of the proposed pathway. If the hypothesis that conversions of H₂ and CaCO₃ as high as 70% or above are achieved from aqueous or solid biomass oxygenates at 200-300° C. is proven, then Mg(OH)₂ will be used as an alkaline sorbent since MgCO₃ decomposes at 350° C. If temperatures higher than 300° C. are needed for biomass decomposition, only Ca(OH)₂ will be used as the alkaline sorbent of choice. The experimental conditions are noted in Table 8. The experiments in Table 8 will allow for identification of the limiting conditions as noted in Table 9 and facilitate the tuning of experimental conditions for enhanced H₂ and carbonate generation.

TABLE 8
Experimental conditions of interest.

| | T (° C.). | Catalyst and | Reaction |
|---|---|---|---|
| Biomass reactants and slurry concentrations | P (atm) | hydroxide | time |
| Aqueous: ethanol, methanol, glycerol, ethylene | 200-300° C. | Ni on Al₂O₃ | 1-5 |
| glycol, acetic acid, bio-oil obtained post-pyrolysis; | (aqueous | support | hours |
| oxygenate compositions in water range from 1-50 wt %. | precursors) | (5-40 wt %). | |
| Solid: glucose, cellulose, lignin, and food | 200-500° C. | Ca(OH)₂ or | |
| waste constituents such as starch, rice straw, | (solid | Mg(OH)₂ | |
| and rice husk; solid wt % of 15-80% will be | precursors). | loading | |
| studied in slurry mode, with water constituting | N₂ pressure | (stoichiometric) | |
| the rest of the fluid. | of 50 atm; | | |
| | continuous | | |
| | stirring at | | |
| | 300 rpm | | |

TABLE 9
Relationship between observed measurements and rate limiting steps.
Approximate conversions noted below are with respect to stoichiometric conversions.

| | | | | |
|---|---|---|---|---|
| Observed | High conc. or | Low conc. or mass | Low conc. or mass | High H₂ and CO₂ |
| conditions | mass of | of biomass reactant | of biomass reactant | conversions |
| | biomass | (<20%), low | (<20%), high | (>70%) with low |
| | reactant | conversions of H₂ | conversions of H₂ | conversion of |
| | (>80%), low | and CO₂, Ca- and | and CO (>50%), low | Ca(OH)₂ or |
| | conversions of | Mg-carbonate (<5%) | CO₂ and carbonate | Mg(OH)₂ to |
| | H₂ and CO₂, | high conc of | conversions (<10%) | respective |
| | Ca- and Mg- | alkanes and | | carbonates |
| | carbonate | CO (>25%) | | (<30%) |
| | (<5%) | | | |
| Limiting | Biomass | Acid hydrolysis, C- | Water-gas-shift | Reactivity of |
| step | deconstruction | O cleavage mechanisms are | reaction is limiting | hydroxides with |
| | | dominant. Alkalinity | since CO is not | CO₂ is rate |
| | | is limited and | converted to CO₂. | limiting. |
| | | catalyst loading is | Limited by catalyst | |
| | | insufficient. | loading | |

Experimental setup and characterization. The experiments will be performed in a high temperature and high pressure reactor (Model #4597 HIP-T, Parr Instrument Company, TL,) equipped with multiple ports for introducing gases and recovering gas phase and slurry constituents. The system is continuously mixed to prevent mass transfer limitations. Light gases (e.g., H₂, CO, CO₂, CH₄, C₂H₄ and C₂H₆) are analyzed continuously at sampling times of ˜2.5 minutes using Inficon micro-GC instrument. Post-reaction, the slurry phase is filtered to separate the aqueous and solid constituents. The reactor will be adapted to have a catalyst loading section encased in a porous setup so the fluids can contact the catalyst while the precipitated carbonates can be excluded from contacting the catalyst. This approach ensures the high activity and recovery of the catalyst. Experiments will be performed in isothermal mode and as temperature is continuously ramped. The continuous ramping modes will allow for identification of the temperatures at which highest conversions are achieved. Isothermal mode will allow to test the influence of various parameters such as catalyst loading, reaction time, and sorbent composition.

The liquids are analyzed using an Agilent 7890A Gas Chromatograph and an Agilent 5975C Mass spectrometer (GC-MS) and to determine the kinetics of biomass deconstruction. Detailed analyses are performed on the recovered solid. The carbonate content in the solids is determined using Thermogravimetric Analysis (TGA) by observing the changes in the weight of the sample that correspond to the calcination of the carbonate phases. MALDI analyses on the recovered biomass will be performed to determine the composition of organic constituents. The changes in the crystalline phases and the functional groups in the catalysts and carbonate solids are determined from WAXS/XRD analyses and ATR-FTIR Spectroscopy measurements, respectively. Particle and pore sizes are quantified using Laser Diffraction Particle Size Analysis, and BET Pore Size Analysis, respectively. Morphological features of the reactants and products are determined from SEM/TEM analyses. Outcome: Identification of the rate limiting step based on the criteria described in Table 9.

Objective 2. Advance mechanistic insights into biomass deconstruction and carbonate formation. The aim is to develop the mechanistic basis for the reactivities observed. Accelerating the rate limiting step is possible by identifying the corresponding experimental conditions (see Table 9) and linking these observations to the molecular scale mechanisms. Approaches to delineate the mechanisms of biomass deconstruction and carbonate formation are noted herein, respectively.

Elucidate biomass deconstruction mechanisms in alkaline environments. Several factors such as the alkalinity, temperature, and catalyst activity influence biomass deconstruction. To probe the cause for slow rates, it is hypothesized that CO₂ dissolution in water produces a slightly acidic solution that promotes alkane formation due to acid-catalyzed dehydration reactions, followed by hydrogenation on the metal interface. In contrast, neutral and basic solutions yield high H₂ and low alkane selectivities.

Specifically, the cleavage behavior of C—C bonds which favors H₂ evolution and C—O bonds which aid the formation of acids, alcohols, and alkanes will be investigated. In-situ ATR-FTIR measurements resolved to the order of two minutes will be used to probe changes in functional groups in solids and aqueous constituents in multiphase environments. In solid biomass such as cellulose, the influence of Ca(OH)₂ and Mg(OH)₂ concentrations on possible degradation pathways such as end-wise degradation, alkaline scission and oxidative degradation will be studied. Possible phenomenon such as Ca²⁺ (or Mg²⁺) ions catalyzing benzilic acid rearrangement in cellulose to promote the production of D-glucoisosaccharinic acids will be probed. Adsorption and complexation of oxygenate and gaseous species (e.g., CO) at Ni interfaces during the deconstruction of aqueous and solid biomass precursors will be probed. High pressure and high temperature ATR-FTIR cell is available through CCMR. In-situ analysis of the chemical transformations in the aqueous phase are coupled with real-time gas analysis using in-line micro-gas chromatography (GC) measurements.

To reconstruct a possible reaction pathway, the organic constituents will be characterized after the breakdown of complex biomass molecules (e.g., cellulose) using ¹³C and ¹H NMR measurements and Matrix-Assisted Laser Desorption/Ionization—Time of Flight Mass Spectrometry (MALDI-TOF-MS) at CCMR. ¹³C or ¹H tagged isotope labeled aqueous species methanol, ethanol, glucose, ethylene glycol, water, and solid biomass such glucose and cellulose will be used. To complement these measurements, changes in the surface adsorbate species, associated binding energies, and relative abundance of the species at Ni interfaces as a function of alkalinity and biomass constituents at representative experimental conditions using tender or soft X-rays such as Ambient Pressure-X-Ray Photoelectron Spectroscopy (AP-XPS) will be determined. Information will be extracted that is related to the adsorption of ions and distribution of species bearing C, H, O, and OH species at the catalytic Ni interfaces at representative experimental conditions.

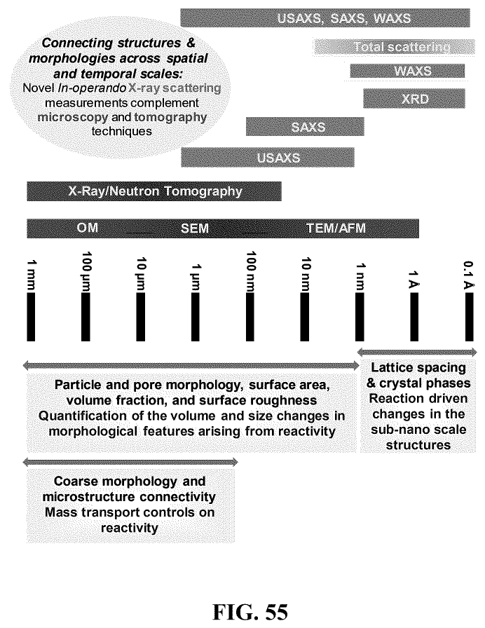

It is also hypothesized that catalyst deactivation could be one of the causes for slow rates of biomass deconstruction. Prior studies suggest that the hydration of γ-Al₂O₃ converts tetrahedral aluminum sites to octahedral ones. The hypothesis that the conversion of γ-Al₂O₃ support to crystalline boehmite reduces the active metal surface area and is a function of the composition of the multiphase chemical environment will be probed. It will simultaneously be determined changes in the structure of γ-Al₂O₃ using WAXS and the surface area and porosity using USAXS/SAXS over multiple cycles. Total Scattering and Pair Distribution Function (PDF) analyses and ²⁷Al Magic Angle Spinning NMR will be used to probe the changes in the coordination structure of Al. The length scales that can be probed using USAXS/SAXS/WAXS and PDF measurements are shown in FIG. 55.

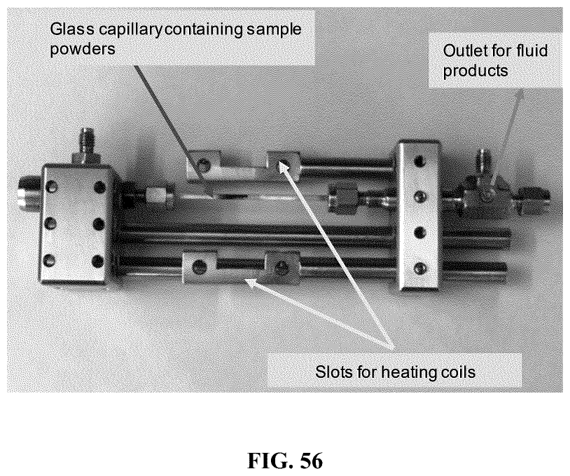

A microreactor cell was adapted and tested for USAXS/SAXS/WAXS for this particular study (FIG. 56). Fluid pressures as high as 80 bar and temperatures as high as 1150° C. can be probed using this experimental setup. Analysis of the scattering data will be performed using IgorPro software with Irena and Nika modules. These combined efforts will indicate the turnover number determined as the number of reactant molecules converted per minute per catalytic site for a given set of reaction conditions. Outcome: Delineate if the limiting step is degradation of the catalyst, cleavage behavior of C—C or C—O bonds, or acidity due to CO₂ dissolution during biomass deconstruction in alkaline environments.

Probe the evolution of carbonate interfaces in multiphase environments with biomass oxygenates. The hypothesis that secondary non-carbonate phases (e.g., Ca-acetate from acetic acid precursor) or metastable, hydrated carbonates formed reduce CO₂ removal efficiency and aid H₂ selectivity will be probed. Further, mass transfer limitations due to particle agglomeration or formation of core-shell structures as a limiting factor will be evaluated. Secondary organic salts (e.g., Ca-acetate) limit reactivity by scavenging Ca that is needed for producing carbonates. Unlike stable phases that lock in CO₂ more effectively as inorganic carbonates, metastable phases redissolve and reprecipitate. Calcite (CaCO₃) and magnesite (MgCO₃) are examples of stable phases. Vaterite (CaCO₃), aragonite (CaCO₃), nesquehonite (MgCO₃·3H₂O) and hydromagnesite ((MgCO₃)₄(Mg(OH)₂)·4H₂O) are non-stable phases. Typically, higher charge density and more stable hydration spheres around Mg²⁺ ions as opposed to Ca²⁺ ions result in (i) the formation of hydrated MgCO₃ phases, unlike with CaCO₃ phases and (ii) calcite (CaCO₃) precipitation rates that are about six orders of magnitude greater compared to magnesite (MgCO₃). In multiphase environments bearing aqueous or solid biomass oxygenates, the evolution in the hydration structure of the Ca²⁺ and Mg²⁺ ions will be determined using Extended X-Ray Absorption Fine Structure (EXAFS) measurements. Specific information of the structure of the solvation shell of the metal can be gleaned from the ion-oxygen and ion-hydrogen distances from the first hydration shell. This approach along with WAXS will be used to determine the structures of metastable hydrated phases and organic salts.

To determine if the particle sizes of hydroxides are limiting the reaction, the onset and evolution of the structures and microstructures of carbonate phases will be determined and compared using total scattering and USAXS/SAXS/WAXS measurements (FIG. 55; FIG. 56 shows the flow-through cell). The evolution in the meso-scale morphology of the carbonates as biomass deconstruction occurs will be probed in a micro-reactor compatible with synchrotron X-ray micro-computed tomography measurements. The morphological features of the precipitates will be used to determined using TEM and SEM images. Outcome: Determine if the formation of hydrated and metastable carbonates vs. stable carbonates influence H₂ yields and overall atomic efficiency, and if organic metal salts (e.g., Ca-acetate) are formed that limit H₂ and carbonate formation.

Objective 3. Reconstruct multiphase reaction pathways for enhanced H₂ production with suppressed CO₂ formation. The aim is to enhance H₂ and carbonate conversion by identifying the rate limiting steps, determining the mechanisms of biomass deconstruction and carbonate formation and using this information to tune the reaction conditions. The mass and energy flows from these experiments will be used in process models and life cycle assessments.

Accelerate the rate-limiting steps informed by mechanistic chemical interactions. Specific experiments will be performed at temperature, solid and fluid compositions, biomass type, catalyst and hydroxide compositions that allow for accelerating the slow steps identified in Table 8. For example, when biomass deconstruction is the rate limiting step, catalyst loading, temperature, and concentration of Ca(OH)₂ or Mg(OH)₂ can be increased based on relative sensitivity of each parameter. To limit the formation of alkanes, alkalinity and catalyst loading can be enhanced to direct the cleavage of C—C bonds as opposed to C—O bonds. Further, solid biomass can be ground to the order of a few micrometers to investigate the influence of particle sizes and high surface area on H₂ and calcium carbonate formation. If carbonate formation is the slow step, carbonate seeding surfaces can be used to circumvent the slow step of carbonate nucleation and growth. Hydroxide particles of smaller sizes and high surface area will also be used to accelerate dissolution behavior.

The experimental configuration is another consideration. While catalysts that are well-dispersed and well-mixed result in a higher conversion, they need to be recovered and treated for reuse after each experiment. Conversely, catalysts that are not mixed with the reactants are easily recoverable but their influence on enhanced H₂ synthesis with in-situ CO₂ capture is less certain. To address this challenge, a mini-catalyst basket will be used to suspend the catalyst in the slurry environments. The effectiveness of this approach in enhancing H₂ conversion with in-situ CO₂ capture as opposed to directly mixing the catalyst will be studied. When catalysts are co-present with carbonates, magnetic separation will be used to separate the catalysts from carbonate particles. The mass and energy flows associated with the reconstructed reaction pathway will be developed. This information will be used to assess the life cycle energy efficiency and carbon footprint of these pathways. Outcome: Develop an integrated reaction network for enhanced H₂ and carbonate formation from biomass by accelerating the rate limiting steps.

Develop process-scale models and life cycle analyses to advance scalable implementation. The aim is to determine the overall energy needs for reaction configurations that correspond to high H₂ yields and selectivity (>95%), carbon removal efficiency and catalyst stability using process scale assessments and life cycle analyses. The kinetic parameters developed in this study will be used to size the equipment using ASPEN Plus software. Appropriate models such as the electrolyte-NRTL property method will be utilized to account for thermodynamic behaviors in multiphase reaction environments. The sensitivity to process variables such as the feed chemistry and composition, temperature, multiphase chemistry, and slurry compositions on the sizes of the process units will be evaluated. Experimental modes with different catalyst placement modes will be modeled. These process models will allow for assessment of the overall energy requirements based on the conversions and kinetics.

Life cycle energy efficiency, carbon footprint, and water use of these pathways starting from biomass sources (e.g., algae for oxygenates, woody biomass, food waste) and alkaline sources (e.g., industrial residues or naturally occurring minerals) will be evaluated using EIO-LCA models. Strategies for deploying this technology for the distributed co-generation of H₂ and carbonates will be evaluated. The influence of the fate of carbonates (e.g., utilization of carbonates in filler, construction and building materials) will be incorporated into the models. Outcome: Identification of energy and carbon efficient routes for producing H₂ and inorganic carbonates from biomass.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A method of producing hydrogen and calcium- or magnesium-bearing carbonates, said method comprising:
providing one or more calcium- or magnesium-bearing compounds;
providing one or more water-soluble oxygenates;
providing two or more catalysts, wherein said two or more catalysts include a first catalyst in the gas phase as a gas phase catalyst and a second catalyst in the liquid phase as a liquid phase catalyst, and wherein the first catalyst is different from the second catalyst;
optionally providing a carbon dioxide source to capture, convert, and store carbon dioxide (CO2); and
reacting said one or more calcium- or magnesium-bearing compounds and said one or more water-soluble oxygenates with said two or more catalysts under reaction conditions to produce hydrogen and calcium- or magnesium-bearing carbonates, wherein said one or more oxygenates act as hydrogen carriers that are reacted to produce hydrogen.

2. The method of claim 1, wherein said one or more calcium- or magnesium-bearing compounds comprise a calcium- or magnesium-bearing silicate, a calcium- or magnesium-bearing hydroxide, or any combination thereof.

3. The method of claim 1, wherein said method comprises one or more reactions of said one or more calcium- or magnesium-bearing compounds and said one or more water-soluble oxygenates selected from:

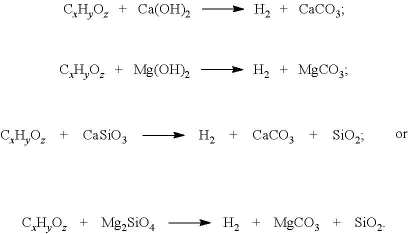

4. The method of claim 1, wherein said one or more water-soluble oxygenates are selected from alcohol, aldehyde, formic acid, glucose and other sugars, glycerol, ether, or mixtures thereof.

5. The method of claim 4, wherein said one or more water-soluble oxygenates comprises alcohol.

6. The method of claim 1, wherein said first catalyst in the gas phase is selected from nickel, copper, platinum, zinc oxide, or alumina; and wherein said second catalyst in the liquid phase is selected from Pt, Cu, Zn on Al₂O₃ support, palladium, or metal carbonyl.

7. The method of claim 1, wherein said first catalyst in the gas phase comprises nickel, and said second catalyst in the liquid phase comprises palladium.

8. The method of claim 1, wherein a concentration of the first catalyst ranges from about 0.5 wt % to about 10.0 wt % and wherein a concentration of the second catalyst ranges from about 0.5 wt % to about 10.0 wt %.

9. The method of claim 1, wherein said calcium-bearing carbonates are selected from the group consisting of calcite, vaterite, and aragonite.

10. The method of claim 1, wherein said magnesium-bearing carbonates are selected from the group consisting of magnesite, hydromagnesite, and hydrated magnesium carbonates.

11. The method of claim 1, wherein said method has a reaction temperature in a range of 50° C.-300° C. and a CO₂ conversion rate of at least 0.9 within the reaction temperature.

12. The method of claim 1, wherein said method has a reaction temperature in a range of about 50° C. to less than 200° C. and a CO₂ conversion rate of at least 0.9 within the reaction temperature.

13. The method of claim 1, wherein the one or more calcium- or magnesium-bearing compounds comprise one or more calcium- or magnesium-bearing silicates configured to react with said one or more water-soluble oxygenates to produce calcium- or magnesium-bearing carbonates and silica.

14. The method of claim 1, wherein the one or more calcium- or magnesium-bearing compounds comprise one or more calcium- or magnesium-bearing silicates and one or more calcium- or magnesium-bearing hydroxides, wherein the one or more calcium- or magnesium-bearing silicates are consumed to produce silica.

15. The method of claim 1, wherein the one or more calcium- or magnesium-bearing compounds are powders or particles.

16. The method of claim 15, wherein the powders or particles have a size of less than 20 microns.

17. The method of claim 1, wherein the calcium- or magnesium-bearing compounds have a pH value of 7-12 in the liquid phase.

18. The method of claim 1, wherein said method is configured to produce:
i) one or more gas phase products selected from H₂, CH₄, CₓH_{y}, or any combinations thereof;
ii) one or more liquid phase products selected from one or more formates, carbonates, bicarbonates, or any combinations thereof; and
iii) one or more solid phase products comprising silica and precipitated carbonates.

19. The method of claim 1, wherein said one or more oxygenates are biomass-derived oxygenates.

20. The method of claim 1, further comprising providing one or more additional gaseous species, vapors, or steams, wherein the one or more additional gaseous species, vapors, or streams comprise syngas, shifted syngas, natural gas, hydrogen, CO, CO₂, water vapor, one or more oxidizing condition gases or streams, or any combinations thereof.
